(19) United States
(12) Patent Application Publication
(10) Pub. No.: US 2022/0344710 A1
(43) Pub. Date: Oct. 27, 2022

(54) INORGANIC SOLID ELECTROLYTE-CONTAINING COMPOSITION, SHEET FOR ALL-SOLID STATE SECONDARY BATTERY, AND ALL-SOLID STATE SECONDARY BATTERY, AND MANUFACTURING METHODS FOR SHEET FOR ALL-SOLID STATE SECONDARY BATTERY AND ALL-SOLID STATE SECONDARY BATTERY

(71) Applicant: FUJIFILM Corporation, Tokyo (JP)

(72) Inventors: Hiroshi ISOJIMA, Kanagawa (JP); Hideyuki SUZUKI, Kanagawa (JP)

(73) Assignee: FUJIFILM Corporation, Tokyo (JP)

(21) Appl. No.: 17/857,144

(22) Filed: Jul. 4, 2022

Related U.S. Application Data
(63) Continuation of application No. PCT/JP2021/000354, filed on Jan. 7, 2021.

(30) Foreign Application Priority Data
Feb. 7, 2020 (JP) 2020-019581
Mar. 25, 2020 (JP) 2020-054261

(51) Int. Cl. H01M 10/0562; H01M 10/0525

(52) U.S. Cl. CPC H01M 10/0562; H01M 10/0525; H01M 2300/0071

(57) ABSTRACT

An inorganic solid electrolyte-containing composition is an inorganic solid electrolyte-containing composition for an all-solid state secondary battery, containing an inorganic solid electrolyte, a polymer binder, a metal element-containing compound, and a dispersion medium, in which the metal element-containing compound is a compound that is capable of supplying, as an ion, a metal element constituting a molecule to a polymer that forms the polymer binder, and the polymer binder is dissolved in the dispersion medium, where the metal element-containing compound is present in a solid state.

### CROSS-REFERENCE TO RELATED APPLICATIONS

This application is a Continuation of PCT International Application No. PCT/JP2021/000354 filed on Jan. 7, 2021, which claims priority under 35 U.S.C § 119(a) to Japanese Patent Application No. 2020-019581 filed on Feb. 7, 2020 and Japanese Patent Application No. 2020-054261 filed on Mar. 25, 2020. Each of the above application(s) is hereby expressly incorporated by reference, in its entirety, into the present application.

### BACKGROUND OF THE INVENTION

### 1. Field of the Invention

The present invention relates to an inorganic solid electrolyte-containing composition, a sheet for an all-solid state secondary battery, and an all-solid state secondary battery, and manufacturing methods for a sheet for an all-solid state secondary battery and an all-solid state secondary battery.

### 2. Description of the Related Art

A secondary battery is a storage battery including a negative electrode, a positive electrode, and an electrolyte sandwiched between the negative electrode and the positive electrode, and it enables charging and discharging by the reciprocal migration of specific metal ions such as lithium ions between both electrodes.

As such a secondary battery, a non-aqueous electrolyte secondary battery using an organic electrolytic solution is used in a wide range of use applications. However, for the purpose of further improving the battery performance, various studies have been carried out for electrolytic solution compositions and the like that are used in the manufacture of the non-aqueous electrolyte secondary battery. For example, JP2015-005526A discloses a composition for an electric storage device, which contains a blocking preventing agent such as a fatty acid amide, a fatty acid ester, or a fatty acid metal salt, a binder particle, and an aqueous medium, and where the ratio of the content of the binder particle to the content of the blocking preventing agent is more than 1 and less than 4,000. Further, JP2013-209355A discloses an electrolytic solution composition containing an organic solvent and, as an electrolyte of a lithium ion secondary battery, a complex of a carboxylic acid lithium salt and boron trifluoride, which is obtained by reacting a carboxylic acid lithium salt with boron trifluoride and/or a boron trifluoride complex.

However, in the non-aqueous electrolyte secondary battery using an organic electrolytic solution, liquid leakage easily occurs, and a short circuit easily occurs in the inside of the battery due to overcharging or overdischarging. As a result, there is a demand for additional improvement in safety and reliability.

Under these circumstances, an all-solid state secondary battery in which an inorganic solid electrolyte is used instead of the organic electrolytic solution has attracted attention. In this all-solid state secondary battery, a negative electrode, an electrolyte, and a positive electrode are all solid, and the safety or reliability of batteries including an organic electrolytic solution can be significantly improved. In addition, the service lives can also be extended. Further, an all-solid state secondary battery may have a structure in which electrodes and an electrolyte are directly disposed in series. Therefore, the energy density can be further increased as compared to a non-aqueous electrolyte secondary battery in which an organic electrolytic solution is used, and the application to an electric vehicle or a large-sized storage battery is expected.

In such an all-solid state secondary battery, constitutional layers (a solid electrolyte layer, a negative electrode active material layer, a positive electrode active material layer, and the like) are formed from compositions containing an electrolyte, an active material, and the like. For example, JP2013-209355A also discloses a composition for a solid electrolyte, containing an organic solvent, a complex of a carboxylic acid lithium salt and boron trifluoride, as an electrolyte, and a matrix polymer.

By the way, as substances that form constitutional layers, inorganic solid electrolytes, particularly an oxide-based inorganic solid electrolyte and a sulfide-based inorganic solid electrolyte have been in the limelight in recent years as electrolyte materials having a high ion conductivity comparable to that of the organic electrolytic solution. However, as a material that forms a constitutional layer (a constitutional layer forming material) of an all-solid state secondary battery, the material (the composition) containing the above-described inorganic solid electrolyte has not been studied JP2015-005526A and JP2013-209355A.

### SUMMARY OF THE INVENTION

Constitutional layers of an all-solid state secondary battery are formed of solid particles (an inorganic solid electrolyte, an active material, a conductive auxiliary agent, and the like), and thus the interfacial contact state between solid particles is inherently restricted. As a result, the all-solid state secondary battery tends to induce an increase in interface resistance (a decrease in ion conductivity) as compared with the non-aqueous electrolyte secondary battery, which consequently causes a decrease in the cycle characteristics of the all-solid state secondary battery. In particular, in a case where a polymer binder is contained in the constitutional layer, the interface resistance between the solid particles tends to increase.

In addition, in a case of forming a constitutional layer of an all-solid state secondary battery with solid particles, a constitutional layer forming material is required to have properties (dispersion stability) of stably maintaining the excellent dispersibility of the solid particle immediately after preparation and properties (handleability) of having a proper viscosity thus being excellent in fluidity, from the viewpoint of improving the battery performance (the ion conductivity, the cycle characteristics, and the like) of the all-solid state secondary battery having a constitutional layer formed from the constitutional layer forming material.

By the way, in recent years, research and development for improving the performance and the practical application of electric vehicles have progressed rapidly, and the demand for battery performance required for all-solid state secondary batteries has become higher. In order to respond to such demands in recent years, it is required to develop a constitutional layer forming material that has both dispersion stability and handleability at a higher level and is capable of forming a constitutional layer having low resistance.

An object of the present invention is to provide an inorganic solid electrolyte-containing composition excellent in dispersion stability and handleability, where the inorganic solid electrolyte-containing composition is capable of realizing a constitutional layer having low resistance by suppressing an increase in interface resistance between solid particles. In addition, another object of the present invention is to provide a sheet for an all-solid state secondary battery and an all-solid state secondary battery, and manufacturing methods for a sheet for an all-solid state secondary battery and an all-solid state secondary battery, in which the above inorganic solid electrolyte-containing composition is used.

As a result of carrying out various studies on a constitutional layer constituent material using an inorganic solid electrolyte and a constitutional layer formed from the constitutional layer constituent material, the inventors of the present invention found that in a case where in the presence of inorganic solid electrolyte particles, a polymer binder is allowed to present together with a metal element-containing compound that is capable of providing a metal element ion to the polymer binder, and then the dispersed state (the solubility property) of the polymer binder and the metal element-containing compound in a dispersion medium is specified, it is possible to suppress temporal reaggregation, sedimentation, or the like of the inorganic solid electrolyte particles and an excessive increase in viscosity (thickening). Further, it was found that a film of this inorganic solid electrolyte composition can be formed by binding inorganic solid electrolytes to each other, for example, by coating and heating, while suppressing an increase in interface resistance between the particles. As a result of the above findings, it was found that in a case where this inorganic solid electrolyte-containing composition is used as a constitutional layer forming material, it is possible to realize a sheet for an all-solid state secondary battery, having a constitutional layer having low resistance, as well as an all-solid state secondary battery having low resistance and excellent cycle characteristics as well. The present invention has been completed by further repeating studies on the basis of the above-described finding.

That is, the above-described objects have been achieved by the following means.

<1> An inorganic solid electrolyte-containing composition for an all-solid state secondary battery, comprising:

an inorganic solid electrolyte having an ion conductivity of a metal belonging to Group 1 or Group 2 in the periodic table;

a polymer binder;

a metal element-containing compound; and

a dispersion medium,

in which the metal element-containing compound is a compound that is capable of supplying, as an ion, a metal element constituting a molecule to a polymer that forms the polymer binder, and

the polymer binder is dissolved in the dispersion medium, where the metal element-containing compound is present in a solid state.

<2> The inorganic solid electrolyte-containing composition according to <1>, in which the metal element-containing compound is dispersed in the dispersion medium.

<3> The inorganic solid electrolyte-containing composition according to <1> or <2>, in which the metal element-containing compound has an average particle diameter of 0.1 to 5 μm.

<4> The inorganic solid electrolyte-containing composition according to any one of <1> to <3>, in which the metal element-containing compound is an organic metal salt.

<5> The inorganic solid electrolyte-containing composition according to any one of <1> to <4>, in which the metal element-containing compound has an anion of which a conjugate acid has a negative common logarithm [pKa] of an acid dissociation constant of −2 to 20.

<6> The inorganic solid electrolyte-containing composition according to any one of <1> to <5>, in which the metal element-containing compound has an anion derived from an organic compound containing 6 to 21 carbon atoms.

<7> The inorganic solid electrolyte-containing composition according to any one of <1> to <6>, in which a metal element constituting the metal element-containing compound includes a metal element belonging to Group 1 or Group 2 in the periodic table.

<8> The inorganic solid electrolyte-containing composition according to any one of <1> to <7>, in which a metal element constituting the metal element-containing compound includes a lithium element.

<9> The inorganic solid electrolyte-containing composition according to any one of <1> to <8>, in which the polymer that forms the polymer binder has, in a main chain, at least one bond selected from a urethane bond, a urea bond, an amide bond, an imide bond, or an ester bond, or a polymerized chain of carbon-carbon double bond.

<10> The inorganic solid electrolyte-containing composition according to any one of <1> or <9>, in which the polymer that forms the polymer binder contains a constitutional component having a functional group selected from the following Group (A) of functional groups,

<Group (A) of Functional Groups>

a hydroxy group, an amino group, a carboxy group, a sulfo group, a phosphate group, a phosphonate group, a sulfanyl group, a heterocyclic group, and a carboxylic acid anhydride group.

<11> The inorganic solid electrolyte-containing composition according to <10>, in which a pKa of a conjugate acid from which an anion contained in the metal element-containing compound is derived is larger than a pKa of the functional group.

<12> The inorganic solid electrolyte-containing composition according to <1> or <11>, in which a difference between the pKa of the conjugate acid from which the anion contained in the metal element-containing compound is derived and the pKa of the functional group [(the pKa of the conjugate acid)−(the pKa of the functional group)] is 2 or more.

<13> The inorganic solid electrolyte-containing composition according to any one of <1> to <12>, in which in a case where the inorganic solid electrolyte-containing composition is heated to 80° C. or higher, a solubility of the polymer binder in the dispersion medium after heating is lower than a solubility of the polymer binder in the dispersion medium before heating.

<14> The inorganic solid electrolyte-containing composition according to any one of <1> to <13>, in which in a case where the inorganic solid electrolyte-containing composition is concentrated so that a total concentration of the polymer binder and the metal element-containing compound in the inorganic solid electrolyte-containing composition is 30% by mass or more, a solubility of the polymer binder in the dispersion medium after concentration is lower than a solubility of the polymer binder in the dispersion medium before concentration.

<15> The inorganic solid electrolyte-containing composition according to any one of <1> to <14>, in which in a case where a film of the inorganic solid electrolyte-containing composition is formed to form a layer, a solubility of the polymer binder present in the layer in the dispersion medium contained in the inorganic solid electrolyte-containing composition, is lower than a solubility of the polymer binder contained in the inorganic solid electrolyte-containing composition in the dispersion medium.

<16> The inorganic solid electrolyte-containing composition according to any one of <1> to <15>, further comprising an active material.

<17> The inorganic solid electrolyte-containing composition according to any one of <1> to <16>, further comprising a conductive auxiliary agent.

<18> The inorganic solid electrolyte-containing composition according to any one of <1> to <17>, in which the inorganic solid electrolyte is a sulfide-based inorganic solid electrolyte.

<19> The inorganic solid electrolyte-containing composition according to any one of <1> to <18>, in which a viscosity at a temperature of 23° C. and a shear rate of 10/s is 300 to 4,000 cP.

<20> A sheet for an all-solid state secondary battery, comprising a layer composed of the inorganic solid electrolyte-containing composition according to any one of <1> to <19>.

<21> The sheet for an all-solid state secondary battery according to <20>, in which the polymer binder is present in the layer as particles having an average particle diameter of 10 to 800 nm.

<22> The sheet for an all-solid state secondary battery according to <20> or <21>, in which a solubility of the polymer binder present in the layer in the dispersion medium contained in the inorganic solid electrolyte-containing composition, is lower than a solubility of the polymer binder contained in the inorganic solid electrolyte-containing composition in the dispersion medium.

<23> An all-solid state secondary battery comprising, in the following order, a positive electrode active material layer; a solid electrolyte layer; and a negative electrode active material layer, in which at least one layer of the positive electrode active material layer, the solid electrolyte layer, or the negative electrode active material layer is composed of the sheet for an all-solid state secondary battery according to any one of <20> to <22>.

<24> A manufacturing method for a sheet for an all-solid state secondary battery, the manufacturing method comprising forming a film of the inorganic solid electrolyte-containing composition according to any one of <1> to <19>.

<25> The manufacturing method for a sheet for an all-solid state secondary battery according to <24>, in which the film is formed while the polymer binder contained in the inorganic solid electrolyte-containing composition is solidified into a particle shape.

<26> The manufacturing method for a sheet for an all-solid state secondary battery according to <24> or <25>, in which the film of the inorganic solid electrolyte-containing composition is formed while a solubility of the polymer binder contained in the inorganic solid electrolyte-containing composition in a dispersion medium, is reduced.

<27> The manufacturing method for a sheet for an all-solid state secondary battery according to any one of <24> to <26>, in which the inorganic solid electrolyte-containing composition is heated to 80° C. or higher to form the film.

<28> A manufacturing method for an all-solid state secondary battery, comprising manufacturing an all-solid state secondary battery through the manufacturing method according to any one of <24> to <27>.

According to the present invention, it is possible to provide an inorganic solid electrolyte-containing composition which is excellent in dispersion characteristics of dispersion stability and handleability and with which a constitutional layer capable of realizing a constitutional layer having low resistance by suppressing an increase in interface resistance between the solid particles can be produced. In addition, according to the present invention, it is possible to provide a sheet for an all-solid state secondary battery and an all-solid state secondary battery, which have a layer composed of the above inorganic solid electrolyte-containing composition. Further, according to the present invention, it is possible to provide manufacturing methods for a sheet for an all-solid state secondary battery and an all-solid state secondary battery, in which the above inorganic solid electrolyte-containing composition is used.

### BRIEF DESCRIPTION OF THE DRAWINGS

FIG. 1 is a vertical cross-sectional view schematically showing an all-solid state secondary battery according to a preferred embodiment of the present invention.

### DESCRIPTION OF THE PREFERRED EMBODIMENTS

In the present invention, numerical ranges indicated using “to” include numerical values before and after the “to” as the lower limit value and the upper limit value.

In the present invention, the expression of a compound (for example, in a case where a compound is represented by an expression in which “compound” is attached to the end) refers to not only the compound itself but also a salt thereof or an ion thereof. In addition, this expression also refers to a derivative obtained by modifying a part of the compound, for example, by introducing a substituent into the compound within a range where the effects of the present invention are not impaired.

In the present invention, (meth)acryl means one or both of acryl and methacryl. The same applies to (meth)acrylate.

In the present invention, a substituent, a linking group, or the like (hereinafter, referred to as a substituent or the like), which is not specified regarding whether to be substituted or unsubstituted, may have an appropriate substituent. Accordingly, even in a case where a YYY group is simply described in the present invention, this YYY group includes not only an aspect having a substituent but also an aspect not having a substituent. The same shall be applied to a compound that is not specified in the present specification regarding whether to be substituted or unsubstituted. Examples of the preferred examples of the substituent include a substituent Z described below.

In the present invention, in a case where a plurality of substituents or the like represented by a specific reference numeral are present or a plurality of substituents or the like are simultaneously or alternatively defined, the respective substituents or the like may be the same or different from each other. In addition, unless specified otherwise, in a case where a plurality of substituents or the like are adjacent to each other, the substituents may be linked or fused to each other to form a ring.

In the present invention, the polymer means a polymer; however, it is synonymous with a so-called polymeric compound.

[Inorganic Solid Electrolyte-Containing Composition]

An inorganic solid electrolyte-containing composition according to the embodiment of the present invention contains an inorganic solid electrolyte having an ion conductivity of a metal belonging to Group 1 or Group 2 in the periodic table; a polymer binder; a metal element-containing compound; and a dispersion medium.

In this inorganic solid electrolyte-containing composition, the polymer binder is dissolved in the dispersion medium and may be or may not be adsorbed to the inorganic solid electrolyte. This polymer binder functions, in a layer formed of at least an inorganic solid electrolyte-containing composition, as a binder that causes solid particles of an inorganic solid electrolyte (as well as a co-existable active material, conductive auxiliary agent, and the like) or the like to mutually binds therebetween (for example, between solid particles of an inorganic solid electrolyte, solid particles of an inorganic solid electrolyte and an active material, or solid particles of an active material). Further, it may function as a binder that causes a collector to bind to solid particles. In the inorganic solid electrolyte-containing composition, the polymer binder may have or may not have a function of causing solid particles to mutually bind therebetween.

On the other hand, in the inorganic solid electrolyte-containing composition, the metal element-containing compound is present in a solid state, and it is preferably dispersed in a dispersion medium.

The inorganic solid electrolyte-containing composition according to the embodiment of the present invention is preferably a slurry in which the inorganic solid electrolyte and the metal element-containing compound are dispersed in a dispersion medium. In this case, the polymer binder preferably has a function of dispersing solid particles in the dispersion medium.

By allowing a metal element-containing compound insoluble in a dispersion medium to be present together with a polymer binder (a soluble type binder) soluble in the dispersion medium, the present invention makes it possible for the first time to realize, in the constitutional layer, the lower resistance at a level equal to or higher than that of a polymer binder (a particle-shaped binder) insoluble in the dispersion medium, while achieving, in the composition, dispersion stability and handleability (dispersion characteristics) at a level equal to or higher than that of the soluble type binder,

In a case where the inorganic solid electrolyte-containing composition according to the embodiment of the present invention which is excellent in dispersion characteristics is used as a constitutional layer forming material, it is possible to realize a constitutional layer having low resistance, the surface of which is flat and thus excellent in surface property, and a sheet for an all-solid state secondary battery having this constitutional layer, as well as an all-solid state secondary battery having low resistance and excellent in cycle characteristics as well.

In addition, in the aspect in which the active material layer formed on the collector is formed of the inorganic solid electrolyte-containing composition according to the aspect of the present invention, it is also possible to realize strong adhesiveness between the collector and the active material layer, and thus it is possible to achieve a further improvement of the cycle characteristics without causing an increase in resistance.

Although the details of the reason thereof are not yet clear, it is conceived to be due to the fact that the polymer binder in a dissolved state in the inorganic solid electrolyte-containing composition can be allowed to interact with the metal element-containing compound, thereby being solidified into a particle shape, in a case where the constitutional layer is formed.

That is, in the inorganic solid electrolyte-containing composition, even in a case where the metal element-containing compound is present in a solid state, it is conceived that since the polymer binder is dissolved in the dispersion medium, the reaggregation or sedimentation of the inorganic solid electrolyte particles involving the polymer binder can be effectively suppressed not only immediately after the preparation of the inorganic solid electrolyte-containing composition but also after a lapse of time, as compared with a case where the polymer binder is present in a particle shape. As a result, a high degree of dispersibility immediately after preparation can be stably maintained (dispersion stability is excellent), and an excessive increase in viscosity can also be suppressed, whereby good fluidity can be exhibited (handleability is excellent).

In a case where a constitutional layer is formed using the inorganic solid electrolyte-containing composition according to the embodiment of the present invention, which exhibits such excellent dispersion stability and handleability, it is conceived to be possible to suppress the generation of reaggregates, sediments, or the like of the inorganic solid electrolyte particles, even during the formation of a film of a constitutional layer (for example, during the application and as well as during drying of the inorganic solid electrolyte-containing composition). This makes it possible to suppress variations in the contact state between inorganic solid electrolyte particles in the constitutional layer. In particular, in a case where the inorganic solid electrolyte-containing composition contains an active material or the like, specific particles of the active material or the like are less likely to be unevenly distributed in the constitutional layer (solid particles are uniformly arranged in the constitutional layer). As a result, it is possible to suppress an increase in the interface resistance between the solid particles as well as the resistance of the constitutional layer. In addition to this, the inorganic solid electrolyte-containing composition becomes to have proper fluidity (leveling) at the time of forming a film of the inorganic solid electrolyte-containing composition, particularly during coating, and thus the surface roughness of unevenness due to insufficient fluidity or excessive fluidity as well as the surface roughness or the like due to clogging in the ejection unit during film formation does not occur (the surface property of the coated surface is excellent), whereby the constitutional layer has a good surface property. In this way, a constitutional layer having a flat surface and low resistance (high conductivity) can be produced.

On the other hand, in a case where the metal element-containing compound interacts with the polymer binder at the time of forming a film of the inorganic solid electrolyte-containing composition, it is conceived that the solubility of the polymer binder in the dispersion medium is reduced, thereby exhibiting a function of solidifying or precipitating the polymer binder in a dissolved state into a particle shape. Since the polymer binder solidified into a particle shape partially covers (is adsorbed to) the surface of the inorganic solid electrolyte particles without completely covering the surface, the contact between the inorganic solid electrolyte particles is not hindered by the presence of the polymer binder, and the inorganic solid electrolyte particles can be bound while sufficiently constructing an ion conduction path due to the contact between inorganic solid electrolyte particles (suppressing an increase in interface resistance between inorganic solid electrolyte particles).

An all-solid state secondary battery having such a constitutional layer having low resistance exhibits high conductivity (ion conductivity and electron conductivity). In addition, since such an all-solid state secondary battery has low resistance, it has a small energy loss in a case of being used at a large current, and it is possible to realize high-speed charging and discharging at a large current in addition to charging and discharging under normal conditions. Moreover, since overcurrent hardly occurs during charging and discharging, battery characteristics can be maintained even in a case where high-speed charging and discharging is repeated as well as in a case of charging and discharging under normal conditions, whereby excellent cycle characteristics are also exhibited.

In a case where an active material layer is formed of the inorganic solid electrolyte-containing composition according to the embodiment of the present invention, a constitutional layer is formed while a highly (homogeneously) dispersed state immediately after preparation is maintained as described above. For this reason, it is conceived that the contact (the adhesion) of the polymer binder to the surface of the collector is not hindered by the solid particles that have been preferentially sedimented, and the polymer binder can come into contact with (adhesion to) the surface of the collector in a state of being dispersed together with the solid particles. As a result, in the electrode sheet for an all-solid state secondary battery in which an active material layer is formed of the inorganic solid electrolyte-containing composition according to the embodiment of the present invention on a collector, it is possible to realize strong adhesiveness between the collector and the active material. In addition, in the all-solid state secondary battery in which an active material layer is formed of the inorganic solid electrolyte-containing composition according to the embodiment of the present invention on a collector, it is possible to realize further improvement of the current collector and the exhibition of strong adhesiveness between the collector and the active material, as well as the improvement of the conductivity in addition to the excellent cycle characteristics.

The inorganic solid electrolyte-containing composition according to the embodiment of the present invention can be preferably used a material (a constitutional layer forming material) for forming a solid electrolyte layer or an active material layer, where the material is for a sheet for an all-solid state secondary battery (including an electrode sheet for an all-solid state secondary battery) or an all-solid state secondary battery. In particular, it can be preferably used as a material for forming a negative electrode sheet for an all-solid state secondary battery or a material for forming a negative electrode active material layer, which contains a negative electrode active material having a large expansion and contraction due to charging and discharging, and high cycle characteristics and furthermore, high conductivity can be achieved in this aspect as well.

The inorganic solid electrolyte-containing composition according to the aspect of the present invention includes an aspect including not only an inorganic solid electrolyte but also an active material, as well as a conductive auxiliary agent or the like (the composition in this aspect may be referred to as the “composition for an electrode”).

Hereinafter, components that are contained and components that can be contained in the inorganic solid electrolyte-containing composition according to the embodiment of the present invention will be described.

<Inorganic Solid Electrolyte>

The inorganic solid electrolyte-containing composition according to the embodiment of the present invention contains an inorganic solid electrolyte.

In the present invention, the inorganic solid electrolyte is an inorganic solid electrolyte, and the solid electrolyte refers to a solid-form electrolyte capable of migrating ions therein. The inorganic solid electrolyte is clearly distinguished from the organic solid electrolyte (the polymeric electrolyte such as polyethylene oxide (PEO) or the organic electrolyte salt such as lithium bis(trifluoromethanesulfonyl)imide (LiTFSI)) since the inorganic solid electrolyte does not include any organic substance as a principal ion-conductive material. In addition, the inorganic solid electrolyte is solid in a steady state and thus, typically, is not dissociated or liberated into cations and anions. Due to this fact, the inorganic solid electrolyte is also clearly distinguished from inorganic electrolyte salts of which cations and anions are dissociated or liberated in electrolytic solutions or polymers (LiPF₆, LiBF₄, lithium bis(fluorosulfonyl)imide (LiFSI), LiCl, and the like). The inorganic solid electrolyte is not particularly limited as long as it has an ion conductivity of a metal belonging to Group 1 or Group 2 in the periodic table and generally does not have electron conductivity. In a case where the all-solid state secondary battery according to the embodiment of the present invention is a lithium ion battery, the inorganic solid electrolyte preferably has an ion conductivity of a lithium ion.

As the inorganic solid electrolyte, a solid electrolyte material that is typically used for an all-solid state secondary battery can be appropriately selected and used. Examples of the inorganic solid electrolyte include (i) a sulfide-based inorganic solid electrolyte, (ii) an oxide-based inorganic solid electrolyte, (iii) a halide-based inorganic solid electrolyte, and (iv) a hydride-based solid electrolyte. The sulfide-based inorganic solid electrolytes are preferably used from the viewpoint that it is possible to form a more favorable interface between the active material and the inorganic solid electrolyte.

(i) Sulfide-Based Inorganic Solid Electrolyte

The sulfide-based inorganic solid electrolyte is preferably an electrolyte that contains a sulfur atom, has an ion conductivity of a metal belonging to Group 1 or Group 2 in the periodic table, and has electron-insulating properties. The sulfide-based inorganic solid electrolyte is preferably an inorganic solid electrolyte that contains at least Li, S, and P as elements and has an ion conductivity of the lithium ion. However, the sulfide-based inorganic solid electrolyte may include elements other than Li, S, and P depending on the purposes or cases.

Examples of the sulfide-based inorganic solid electrolyte include an inorganic solid electrolyte having an ion conductivity of the lithium ion, which satisfies a composition represented by the following Formula (S1).

Lₐ₁M_{b1}P_{c1}S_{d1}Aₑ₁ (S1)

In the formula, L represents an element selected from Li, Na, or K and is preferably Li. M represents an element selected from B, Zn, Sn, Si, Cu, Ga, Sb, Al, or Ge. A represents an element selected from I, Br, Cl, or F. a1 to e1 represent the compositional ratios between the respective elements, and a1:b1:c1:d1:e1 satisfies 1 to 12:0 to 5:1:2 to 12:0 to 10. a1 is preferably 1 to 9 and more preferably 1.5 to 7.5. b1 is preferably 0 to 3 and more preferably 0 to 1. d1 is preferably 2.5 to 10 and more preferably 3.0 to 8.5. e1 is preferably 0 to 5 and more preferably 0 to 3.

The compositional ratios among the respective elements can be controlled by adjusting the amounts of raw material compounds blended to manufacture the sulfide-based inorganic solid electrolyte as described below.

The sulfide-based inorganic solid electrolyte may be non-crystalline (glass) or crystallized (made into glass ceramic) or may be only partially crystallized. For example, it is possible to use Li—P—S-based glass containing Li, P, and S or Li—P—S-based glass ceramic containing Li, P, and S.

The sulfide-based inorganic solid electrolytes can be manufactured by a reaction of at least two or more raw materials of, for example, lithium sulfide (Li₂S), phosphorus sulfide (for example, diphosphorus pentasulfide (P₂S₅)), a phosphorus single body, a sulfur single body, sodium sulfide, hydrogen sulfide, lithium halides (for example, LiI, LiBr, and LiCl), or sulfides of an element represented by M described above (for example, SiS₂, SnS, and GeS₂).

The ratio between Li₂S and P₂S₅ in each of Li—P—S-based glass and Li—P—S-based glass ceramic is preferably 60:40 to 90:10 and more preferably 68:32 to 78:22 in terms of the molar ratio between Li₂S:P₂S₅. In a case where the ratio between Li₂S and P₂S₅ is set in the above-described range, it is possible to increase an ion conductivity of a lithium ion. Specifically, the ion conductivity of the lithium ion can be preferably set to 1×10⁻⁴ S/cm or more and more preferably set to 1×10⁻³ S/cm or more. The upper limit is not particularly limited; however, it is realistically 1×10⁻¹ S/cm or lower.

As specific examples of the sulfide-based inorganic solid electrolytes, combination examples of raw materials will be described below. Examples thereof include Li₂S—P₂S₅, Li₂S—P₂S₅—LiCl, Li₂S—P₂S₅—H₂S, Li₂S—P₂S₅—H₂S—LiCl, Li₂S—LiI—P₂S₅, Li₂S—LiI—Li₂O—P₂S₅, Li₂S—LiBr—P₂S₅, Li₂S—Li₂O—P₂S₅, Li₂S—Li₃PO₄—P₂S₅, Li₂S—P₂S₅—P₂O₅, Li₂S—P₂S₅—SiS₂, Li₂S—P₂S₅—SiS₂—LiCl, Li₂S—P₂S₅—SnS, Li₂S—P₂S₅—Al₂S₃, Li₂S—GeS₂, Li₂S—GeS₂—ZnS, Li₂S—Ga₂S₃, Li₂S—GeS₂—Ga₂S₃, Li₂S—GeS₂—P₂S₅, Li₂S—GeS₂—Sb₂S₅, Li₂S—GeS₂—Al₂S₃, Li₂S—SiS₂, Li₂S—Al₂S₃, Li₂S—SiS₂—Al₂S₃, Li₂S—SiS₂—P₂S₅, Li₂S—SiS₂—P₂S₅—LiI, Li₂S—SiS₂—LiI, Li₂S—SiS₂—Li₄SiO₄, Li₂S—SiS₂—Li₃PO₄, and Li₁₀GeP₂S₁₂. The mixing ratio between the individual raw materials does not matter. Examples of the method of synthesizing a sulfide-based inorganic solid electrolyte material using the above-described raw material compositions include an amorphization method. Examples of the amorphization method include a mechanical milling method, a solution method, and a melting quenching method. This is because treatments at a normal temperature become possible, and it is possible to simplify manufacturing processes.

(ii) Oxide-Based Inorganic Solid Electrolyte

The oxide-based inorganic solid electrolyte is preferably an electrolyte that contains an oxygen atom, has an ion conductivity of a metal belonging to Group 1 or Group 2 in the periodic table, and has electron-insulating properties.

The ion conductivity of the oxide-based inorganic solid electrolyte is preferably 1×10⁻⁶ S/cm or more, more preferably 5×10⁻⁶ S/cm or more, and particularly preferably 1×10⁻⁵ S/cm or more. The upper limit is not particularly limited; however, it is practically 1×10⁻¹ S/cm or less.

Specific examples of the compound include LiₓₐLa_{ya}TiO₃ (LLT) [xa satisfies 0.3≤xa≤0.7, and ya satisfies 0.3≤ya≤0.7]; Li_{xb}La_{yb}Zr_{zb}M^{bb}_{mb}O_{nb} (M^{bb} is one or more elements selected from Al, Mg, Ca, Sr, V, Nb, Ta, Ti, Ge, In, and Sn, xb satisfies 5≤xb≤10, yb satisfies 1≤yb≤4, zb satisfies 1≤zb≤4, mb satisfies 0≤mb≤2, and nb satisfies 5≤nb≤20); Li_{xc}B_{yc}M^{cc}_{zc}O_{nc} (M^{cc} is one or more elements selected from C, S, Al, Si, Ga, Ge, In, and Sn, xc satisfies 0<xc≤5, yc satisfies 0<yc≤1, zc satisfies 0<zc≤1, and nc satisfies 0<nc≤6); Li_{xd}(Al, Ga)_{yd}(Ti, Ge)_{zd}Si_{ad}P_{md}O_{nd} (xd satisfies 1≤xd≤3, yd satisfies 0≤yd≤1, zd satisfies 0≤zd≤2, ad satisfies 0≤ad≤1, md satisfies 1≤md≤7, and nd satisfies 3≤nd≤13); Li₍₃₋₂ₑ₎M^{ee}ₓₑD^{ee}O (xe represents a number between 0 and 0.1, and M^{ee} represents a divalent metal atom, D^{ee} represents a halogen atom or a combination of two or more halogen atoms); Li_{xf}Si_{yf}O_{zf} (xf satisfies 1≤xf≤5, yf satisfies 0<yf≤3, zf satisfies 1≤zf≤10); Li_{xg}S_{yg}O_{zg} (xg satisfies 1≤xg≤3, yg satisfies 0≤yg≤2, zg satisfies 1≤zg≤10); Li₃BO₃; Li₃BO₃—Li₂SO₄; Li₂O—B₂O₃—P₂O₅; Li₂O—SiO₂; Li₆BaLa₂Ta₂O₁₂; Li₃PO_{(4-3/2w)}N_{w} (w satisfies w<1); Li_{3.5}Zn_{0.25}GeO₄ having a lithium super ionic conductor (LISICON)-type crystal structure; La_{0.55}Li_{0.35}TiO₃ having a perovskite-type crystal structure; LiTi₂P₃O₁₂ having a natrium super ionic conductor (NASICON)-type crystal structure; Li_{1+xh+yh}(Al, Ga)ₓₕ(Ti, Ge)₂₋ₓₕSi_{yh}P_{3-yh}O₁₂ (xh satisfies 0≤xh≤1, and yh satisfies 0≤yh≤1); and Li₇La₃Zr₂O₁₂ (LLZ) having a garnet-type crystal structure.

In addition, a phosphorus compound containing Li, P, or O is also desirable. Examples thereof include lithium phosphate (Li₃PO₄); LiPON in which a part of oxygen atoms in lithium phosphate are substituted with a nitrogen atom; and LiPOD¹ (D¹ is preferably one or more elements selected from Ti, V, Cr, Mn, Fe, Co, Ni, Cu, Zr, Nb, Mo, Ru, Ag, Ta, W, Pt, and Au).

Further, for example, LiA¹ON (A¹ represents one or more elements selected from Si, B, Ge, Al, C, or Ga) can be preferably used.

(iii) Halide-Based Inorganic Solid Electrolytes

The halide-based inorganic solid electrolyte is preferably a compound that contains a halogen atom, has an ion conductivity of a metal belonging to Group 1 or Group 2 in the periodic table, and has electron-insulating properties.

The halide-based inorganic solid electrolyte is not particularly limited; however, examples thereof include LiCl, LiBr, LiI, and compounds such as Li₃YBr₆ or Li₃YCl₆ described in ADVANCED MATERIALS, 2018, 30, 1803075. In particular, Li₃YBr₆ or Li₃YCl₆ is preferable.

(iv) Hydride-Based Inorganic Solid Electrolytes

The hydride-based inorganic solid electrolyte is preferably a compound that contains a hydrogen atom, has an ion conductivity of a metal belonging to Group 1 or Group 2 in the periodic table, and has electron-insulating properties.

The hydride-based inorganic solid electrolyte is not particularly limited, and examples thereof include LiBH₄, Li₄(BH₄)₃I, and 3LiBH₄—LiCl.

The inorganic solid electrolyte is preferably in the form of particles. In this case, the average particle diameter (the volume average particle diameter) of the inorganic solid electrolyte is not particularly limited; however, it is preferably 0.01 μm or more and more preferably 0.1 μm or more. The upper limit is preferably 100 μm or less and more preferably 50 μm or less.

The particle diameter of the inorganic solid electrolyte is measured in the following order. The inorganic solid electrolyte particles are diluted and prepared using water (heptane in a case where the inorganic solid electrolyte is unstable in water) in a 20 mL sample bottle to prepare 1% by mass of a dispersion liquid. The diluted dispersion liquid sample is irradiated with 1 kHz ultrasonic waves for 10 minutes and is then immediately used for testing. Data collection is carried out 50 times using this dispersion liquid sample, a laser diffraction/scattering-type particle size distribution analyzer LA-920 (product name, manufactured by Horiba Ltd.), and a quartz cell for measurement at a temperature of 25° C. to obtain the volume average particle diameter. Other detailed conditions and the like can be found in JIS Z8828: 2013 “particle diameter Analysis-Dynamic Light Scattering” as necessary. For each level, five samples are prepared and the average value thereof is adopted.

One kind of inorganic solid electrolyte may be contained, or two or more kinds thereof may be contained.

In a case of forming a solid electrolyte layer, the mass (mg) (mass per unit area) of the inorganic solid electrolyte per unit area (cm²) of the solid electrolyte layer is not particularly limited. It can be appropriately determined according to the designed battery capacity and can be set to, for example, 1 to 100 mg/cm².

However, in a case where the inorganic solid electrolyte-containing composition contains an active material described later, the mass per unit area of the inorganic solid electrolyte is preferably such that the total amount of the active material and the inorganic solid electrolyte is in the above range.

The content of the inorganic solid electrolyte in the inorganic solid electrolyte-containing composition is not particularly limited. However, in terms of the binding property as well as in terms of dispersibility, it is preferably 50% by mass or more, more preferably 70% by mass or more, and still more preferably 90% by mass or more, in the solid content of 100% by mass. From the same viewpoint, the upper limit thereof is preferably 99.9% by mass or less, more preferably 99.5% by mass or less, and particularly preferably 99% by mass or less.

However, in a case where the inorganic solid electrolyte-containing composition contains an active material described below, regarding the content of the inorganic solid electrolyte in the inorganic solid electrolyte-containing composition, the total content of the active material and the inorganic solid electrolyte is preferably in the above-described range.

In the present invention, the solid content (solid component) refers to components that neither volatilize nor evaporate and disappear in a case where the inorganic solid electrolyte-containing composition is subjected to drying treatment at 150° C. for 6 hours in a nitrogen atmosphere at a pressure of 1 mmHg. Typically, the solid content refers to components other than a dispersion medium described below.

<Polymer Binder>

The polymer binder that is used in the inorganic solid electrolyte-containing composition according to the embodiment of the present invention is a binder formed by containing a polymer, and it exhibits solubility in a dispersion medium contained in the inorganic solid electrolyte-containing composition and is dissolved therein. In a case where this polymer binder is used in combination with solid particles such as the inorganic solid electrolyte and a metal element-containing compound described later, it is possible to improve the dispersion stability and handleability of the inorganic solid electrolyte-containing composition (the slurry), whereby a constitutional layer having low resistance can be produced.

In the present invention, the description that the polymer binder (also referred to as a binder) is dissolved in a dispersion medium is not limited to an aspect in which the entire polymer binder is dissolved in the dispersion medium, and it refers to, for example, that the solubility in the dispersion medium is 80% or more. The measuring method for solubility is as follows.

That is, a specified amount of a binder to be measured is weighed in a glass bottle, 100 g of a dispersion medium that is the same kind as the dispersion medium contained in the inorganic solid electrolyte-containing composition is added thereto, and stirring is carried out at a temperature of 25° C. on a mix rotor at a rotation speed of 80 rpm for 24 hours. After stirring for 24 hours, the obtained mixed solution is subjected to the transmittance measurement under the following conditions. This test (the transmittance measurement) is carried out by changing the amount of the binder dissolved (the above specified amount), and the upper limit concentration X (% by mass) at which the transmittance is 99.8% is defined as the solubility of the binder in the above dispersion medium.

Transmittance Measurement Conditions—

Dynamic light scattering (DLS) measurement

Device: DLS measuring device DLS-8000 manufactured by Otsuka Electronics Co., Ltd.

Laser wavelength, output: 488 nm/100 mW

Sample cell: NMR tube

(Polymer that Forms Polymer Binder)

The polymer that forms the polymer binder (also referred to as a binder forming polymer) is not particularly limited as long as it is dissolved in a dispersion medium, and various polymers that are generally used in the constitutional layers of the all-solid state secondary battery can be used. Among them, preferred examples thereof include a polymer (a sequential polymerization polymer) having, in the main chain, at least one bond selected from a urethane bond, a urea bond, an amide bond, an imide bond, or an ester bond, or a polymer (a chain polymerization polymer) having, in the main chain, a polymerized chain of carbon-carbon double bond.

In the present invention, a main chain of the polymer refers to a linear molecular chain in which all the molecular chains that constitutes the polymer other than the main chain can be considered branched chains or pendants to the main chain. Although it depends on the mass average molecular weight of the molecular chain regarded as a branched chain or pendant chain, the longest chain among the molecular chains that constitute the polymer is typically the main chain. In this case, a terminal group at the polymer terminal is not included in the main chain. In addition, side chain of the polymer refers to molecular chains other than the main chain and include a short molecular chain and a long molecular chain.

The above bond is not particularly limited as long as it is contained in the main chain of the polymer, and it may have any aspect in which it is contained in the constitutional unit (the repeating unit) and/or an aspect in which it is contained as a bond that connects different constitutional units to each other). Further, the above-described bond contained in the main chain is not limited to one kind, it may be 2 or more kinds, and it is preferably 1 to 6 kinds and more preferably 1 to 4 kinds. In this case, the binding mode of the main chain is not particularly limited. The main chain may be a main chain where two or more bonds are randomly present or may be a segmented main chain including a segment having a specific bond and a segment having another bond.

Examples of the polymer having, among the above bonds, a urethane bond, a urea bond, an amide bond, an imide bond, or an ester bond in the main chain include a sequential polymerization (polycondensation, polyaddition, or addition condensation) polymers such as polyurethane, polyurea, polyamide, polyimide, and polyester, and copolymers thereof. The copolymer may be a block copolymer having each of the above polymers as a segment, or a random copolymer in which each constitutional component constituting two or more polymers among the above polymers is randomly bonded.

Examples of the polymer having a polymerized chain of carbon-carbon double bond in the main chain include chain polymerization polymers such as a fluorine-containing polymer, a hydrocarbon-based polymer, a vinyl polymer, and a (meth)acrylic polymer. In a case where the chain polymerization polymer is a copolymer, it may be a block copolymer or a random copolymer.

The binder forming polymer may be one kind or two or more kinds.

The binder forming polymer is a polymer that interacts with a metal element-containing compound at the time of forming a film of the inorganic solid electrolyte-containing composition, and specifically, it is a polymer capable of receiving (by a chemical reaction, chemical or physical adsorption, or the like) an ion of a metal element from a metal element-containing compound described later. This makes it possible for the polymer binder to receive the metal element ion that is generated from the metal element-containing compound, thereby imparting the above-described action to the polymer binder. The partial structure for the interaction or receiving a metal element ion is not particularly limited as long as this action or reception is possible, and examples thereof include a chemical structure of the main chain (for example, each of the above-described bonds) and a functional group (a) described later.

The binder forming polymer preferably contains a constitutional component having a functional group (a) selected from the following Group (A) of functional groups as, for example, a substituent. The constitutional component having the functional group (a) preferentially receives an ion of a metal element from the metal element-containing compound at the time of forming a film of the inorganic solid electrolyte-containing composition, for example, by a salt exchange reaction, whereby a metal salt or the like of the functional group (a) can be formed. The polymer binder having a functional group (a) that has undergone metal chlorination is solidified into a particle shape in a state where solid particles are adsorbed thereto. The functional group (a) that is contained in one constitutional component may be one kind or two or more kinds, and the number thereof is not particularly limited.

<Group (A) of Functional Groups>

A hydroxy group, an amino group, a carboxy group, a sulfo group (a sulfonate group: —SO₃H), a phosphate group (a phosphoryl group: —OPO(OH)₂), a phosphonate group (—PO(OH)₂), a sulfanyl group, a heterocyclic group, and a carboxylic acid anhydride group (an anhydrous carboxylic acid group)

Each functional group contained in Group (A) of functional groups is not particularly limited; however, it is synonymous with the corresponding group of the substituent Z described later. However, the amino group is more preferably —NH₂ and in a case where the corresponding group of the substituent Z has R^{P}, it is more preferable that R¹ is a hydrogen atom. Each functional group may form a salt. The hydroxy group does not include the —OH group contained in the acid group such as the carboxy group. The carboxylic acid anhydride group contained in Group (A) of functional groups is not particularly limited; however, it is synonymous with an anhydrous carboxylic acid group contained in Group (B) of functional groups described later, and the same also applies to the preferred range thereof.

The functional group contained in Group (A) of functional groups is preferably a group having an active hydrogen atom, such as a hydroxy group, a carboxy group, a sulfo group, a phosphate group, a phosphonate group, or a sulfanyl group, more preferably an acid group such as a carboxy group, a sulfo group, a phosphate group, or a phosphonate group, and still more preferably a carboxy group, in that the functional group contained therein easily interacts with a metal element-containing compound and particularly, easily undergoes a salt exchange reaction.

The negative common logarithm [pKa] of the acid dissociation constant of each functional group contained in Group (A) of functional groups is not particularly limited; however, it is preferably −2.0 to 8.0, more preferably −1.0 to 6.0, still more preferably 0.0 to 4.0, and particularly preferably 0.0 to 2.0, in that the interaction with the metal element-containing compound is effectively exhibited, for example, in that the salt exchange reaction proceeds rapidly to receive a metal element ion.

In the present invention, pKa shall be a value (in water) measured by neutralization titration using an automatic potential difference titration device (product name: Titrando 905, manufactured by Metrohm Japan Ltd.).

In a case where the binder forming polymer has a plurality of kinds of functional groups (a), it suffices that at least a pKa exhibiting the lowest value among the pKa's of the respective functional groups is included in the above range, and the pKa's of the other functional groups may be or may not be included in the above range.

The functional group (a) may be incorporated into the main chain or the side chain of the polymer.

In a case of being incorporated into the side chain, an aspect in which the incorporation is made by being bonded directly or through a linking group to the atom that forms the main chain of the polymer is included. Examples of the linking group that bonds the functional group (a) to the main chain include an alkylene group (preferably having 1 to 12 carbon atoms, more preferably 1 to 6 carbon atoms, and still more preferably having 1 to 3 carbon atoms), an alkenylene group (preferably having 2 to 6 carbon atoms and more preferably having 2 or 3 carbon atoms), an arylene group (preferably having 6 to 24 carbon atoms and more preferably having 6 to 10 carbon atoms), an oxygen atom, a sulfur atom, an imino group (—NR^{N}—: R^{N} represents a hydrogen atom, an alkyl group having 1 to 6 carbon atoms or an aryl group having 6 to 10 carbon atoms), a carbonyl group, a phosphate linking group (—O—P(OH)(O)—O—), a phosphonate linking group (—P)(OH)(O)—O—), and a group involved in the combination thereof. The linking group is preferably a group composed of a combination of an alkylene group, an arylene group, a carbonyl group, an oxygen atom, a sulfur atom, and an imino group.

In the present invention, the number of atoms forming the linking group is preferably 1 to 36, more preferably 1 to 24, still more preferably 1 to 12, and still more preferably 1 to 6. The number of linking atoms of the linking group is preferably 10 or less and more preferably 8 or less. The lower limit thereof is 1 or more. The number of linking atoms refers to the minimum number of atoms linking predetermined structural parts. For example, in the case of —CH₂—C(═O)—O—, the number of atoms forming the linking group is 6, but the number of linking atoms is 3.

Further, in a case where the functional group (a) is incorporated into the side chain, an aspect in which the functional group (a) is contained in a polymerized chain of a macromonomer constituting the side chain is also included, in addition to the aspect in which the functional group (a) is bonded through the linking group. Examples of such a macromonomer include a macromonomer that is appropriately determined depending on the kind of the main chain of the binder forming polymer, for example, a macromonomer having a polymerized chain of a chain polymerization polymer described later, although it is not unique.

The functional groups contained in Group (A) of functional groups are used for the interaction with the metal element-containing compound; however, some of them may be used for the interaction with the solid particles as the functional group (b) described later.

The constitutional component having the functional group (a) is not particularly limited as long as it is a constitutional component that can constitute the binder forming polymer, and it is appropriately selected depending on the kind, composition, and the like of the binder forming polymer.

In the binder forming polymer (all the constitutional components), the content of the constitutional component having the functional group (a) is not particularly limited; however, it is preferably 0.1% to 10% by mole, more preferably 0.1% to 5% by mole, still more preferably 0.2% to 4.0% by mole, in terms of exhibiting sufficient interaction with the metal element-containing compound. In a case where the binder forming polymer has a plurality of constitutional components having the functional group (a), the content of the constitutional components having the functional group (a) shall be the total amount thereof. In addition, in a case where one constitutional component has a plurality of functional groups (a) or a plurality of kinds of functional groups (a), the content of a constitutional component having the functional group (a) generally refers to the content of the above one constitutional component; however, in the present invention, the total amount of contents in terms of the respective functional groups shall be used in relation to the interaction with the metal element-containing compound, the binding property of solid particles, and the like. However, in a case where a plurality of functional groups (a) or a plurality of kinds of functional groups (a) are present in one molecular chain (in a case of being derived from a common raw material compound), the contents in terms of the respective functional groups (a) are not included in the above total amount, and contents of a plurality of functional groups or a plurality of kinds of functional groups are collectively included in the total amount as one content in terms of one functional group.

The binder forming polymer preferably contains a constitutional component having a functional group (b) selected from the following Group (B) of functional groups as, for example, a substituent. The constitutional component having the functional group (b) has a function of enhancing the adsorptive force of the polymer binder to the solid particles. The polymer binder is preferably adsorbed to solid particles by the physical or chemical action (the formation of a chemical bond, giving or receiving an electron, or the like). The functional group (b) may be incorporated into the main chain or the side chain of the polymer. In a case of being incorporated into the side chain, an aspect in which the incorporation is made by being bonded directly or through a linking group to the atom that forms the main chain of the polymer is included. The linking group that binds the functional group (b) to the main chain is not particularly limited; however, preferred examples thereof include a linking group that binds the functional group (a) to the main chain. In addition, it also includes an aspect in which the functional group (b) is incorporated as a substituent into the polymerized chain of the macromonomer constitutional component constituting the side chain. Examples of the macromonomer from which the macromonomer constitutional component is derived include a macromonomer that is appropriately determined depending on the kind of the main chain of the binder forming polymer, for example, a macromonomer having a polymerized chain of a chain polymerization polymer described later, although it is not unique. The functional group (b) contained in one constitutional component may be one kind or two or more kinds, and in a case where two or more kinds are contained, they may be or may not be bonded to each other.

<Group (B) of Functional Groups>

A hydroxy group, an amino group, a carboxy group, a sulfo group, a phosphate group, a phosphonate group, a sulfanyl group, an ether bond (—O—), an imino group (═NR, or —NR—), an ester bond (—CO—O—), an amide bond (—CO—NR—), a urethane bond (—NR—CO—O—), a urea bond (—NR—CO—NR—), a heterocyclic group, an aryl group, an anhydrous carboxylic acid group, a fluoroalkyl group, and a siloxane group

Each of the amino group, the sulfo group, the phosphate group, the heterocyclic group, and the aryl group, which are included in Group (B) of functional groups, is not particularly limited; however, it is synonymous with the corresponding group of the substituent Z described later. However, the amino group more preferably has 0 to 12 carbon atoms, still more preferably 0 to 6 carbon atoms, and particularly preferably 0 to 2 carbon atoms. In a case where a ring structure contains an amino group, an ether bond, an imino group (—NR—), an ester bond, an amide bond, a urethane bond, a urea bond, or the like, it is classified as a heterocycle.

The hydroxy group, the amino group, the carboxy group, the sulfo group, the phosphate group, the phosphonate group, or the sulfanyl group may form a salt.

The fluoroalkyl group is a group obtained by substituting at least one hydrogen atom of an alkyl group or cycloalkyl group with a fluorine atom, and it preferably has 1 to 20 carbon atoms, more preferably 2 to 15 carbon atoms, and still more preferably 3 to 10 carbon atoms. Regarding the number of fluorine atoms on the carbon atom, a part of the hydrogen atoms may be substituted, or all the hydrogen atoms may be substituted (a perfluoroalkyl group).

The siloxane group is not particularly limited, and it is preferably, for example, a group having a structure represented by —(SiR₂—O)ₙ—. The repetition number n is preferably an integer of 1 to 100, more preferably an integer of 5 to 50, and still more preferably an integer of 10 to 30.

R in each bond or group represents a hydrogen atom or a substituent, and it is preferably a hydrogen atom. The substituent is not particularly limited. It is selected from a substituent Z described later, and an alkyl group is preferable.

The anhydrous carboxylic acid group is not particularly limited; however, it includes a group obtained by removing one or more hydrogen atoms from a carboxylic acid anhydride (for example, a group represented by Formula (2a)), as well as a constitutional component itself (for example, a constitutional component represented by Formula (2b)) obtained by copolymerizing a polymerizable carboxylic acid anhydride as a copolymerizable compound. The group obtained by removing one or more hydrogen atoms from a carboxylic acid anhydride is preferably a group obtained by removing one or more hydrogen atoms from a cyclic carboxylic acid anhydride. The anhydrous carboxylic acid group derived from a cyclic carboxylic acid anhydride also corresponds to a heterocyclic group; however, it is classified as an anhydrous carboxylic acid group in the present invention. Examples the anhydrous carboxylic acid group include acyclic carboxylic acid anhydrides such as acetic acid anhydride, propionic acid anhydride, and benzoic acid anhydride; and cyclic carboxylic acid anhydrides such as maleic acid anhydride, phthalic acid anhydride, fumaric acid anhydride, succinic acid anhydride, and itaconic acid anhydride. The polymerizable carboxylic acid anhydride is not particularly limited; however, examples thereof include a carboxylic acid anhydride having an unsaturated bond in the molecule, and a polymerizable cyclic carboxylic acid anhydride is preferable. Specific examples thereof include maleic acid anhydride and itaconic acid anhydride.

Examples of the anhydrous carboxylic acid group include a group represented by Formula (2a) and a constitutional component represented by Formula (2b); however, the present invention is not limited thereto. In each of the formulae, * represents a bonding position.

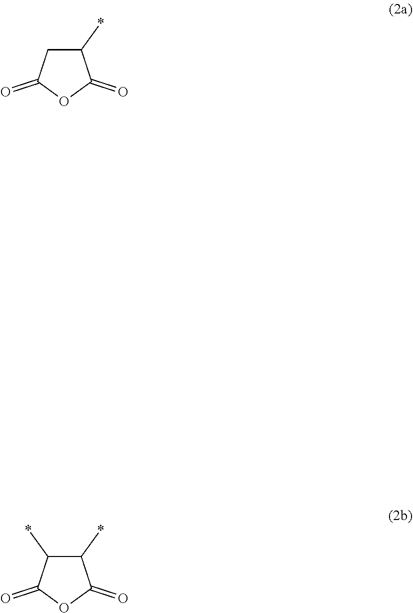 [SMILES: *C1CC(=O)OC1=O ; *C1C(=O)OC(=O)C1*]

In the sequential polymerization polymer, the ester bond (—CO—O—), the amide bond (—CO—NR—), the urethane bond (—NR—CO—O—), and the urea bond (—NR—CO—NR—) are represented by being divided into, a —CO— group and a —O— group, a —CO group and a —NR— group, a —NR—CO— group and a —O— group, and an NR—CO— group and a —NR— group, respectively, in a case where the chemical structure of the polymer is represented by constitutional components derived from raw material compounds. As a result, in the present invention, the constitutional components having these bonds are regarded as constitutional components derived from the carboxylic acid compound or constitutional components derived from the isocyanate compound regardless of the notation of the polymer, and they cannot include constitutional components derived from the polyol or polyamine compound.

In addition, in the chain polymerization polymer, the constitutional component having an ester bond (excluding an ester bond that forms a carboxy group) or an amide bond as a functional group means a constitutional component in which an ester bond or an amide bond is not directly bonded to an atom that constitutes the main chain, and it does not include, for example, a constitutional component derived from a (meth)acrylic acid alkyl ester.

The constitutional component having the functional group (b) is not particularly limited as long as it is a constitutional component that can constitute the binder forming polymer, and it is appropriately selected depending on the kind, composition, and the like of the binder forming polymer.

In the binder forming polymer (all the constitutional components), the content of the constitutional component having the functional group (b) is not particularly limited; however, it is preferably 1% to 90% by mole, more preferably 20% to 87% by mole, and still more preferably 30% to 85% by mole, in terms of the binding property of the solid particles. In a case where the binder forming polymer has a plurality of constitutional components having the functional group (b), the content of the constitutional components having the functional group (b) shall be the total amount thereof. In addition, in a case where one constitutional component has a plurality of functional groups (b) or a plurality of kinds of functional groups (b), the content of the constitutional component having the functional group (b) shall be the total amount calculated in the same manner as the content of the constitutional component having the functional group (a) in the case where one constitutional component has a plurality of functional groups (a) or a plurality of kinds of functional groups (a).

It is noted that in a case where the functional group (b) also corresponds to the functional group (a), although the content of the constitutional component having the functional group (b) shall be the content of the constitutional component having the functional group (a) in terms of exhibiting the interaction with the metal element-containing compound, it is preferably set the content of the constitutional component having the functional group (b) in terms of achieving the binding property of the solid particles as well.

Sequential Polymerization Polymer—

Examples of the sequential polymerization (polycondensation, polyaddition, or addition condensation) polymer as the binder forming polymer include polyurethane, polyurea, polyamide, polyimide, polyester, polyether, and polycarbonate, where polyurethane, polyurea, polyamide, polyimide, or polyester is preferable. The sequential polymerization polymer preferably has, as a constitutional component thereof, the above-described constitutional component having the functional group (a) or the functional group (b).

Examples of the polyurethane, polyurea, polyamide, and polyimide polymers that can be adopted as sequential polymerization polymers include the polymer disclosed JP2015-088480A (the polymeric binder (B)) having a hard segment and a soft segment and a polymer obtained by introducing a constitutional component having the functional group (a) or functional group (b) into each polymer described in WO2015/046313A.

The method of incorporating a functional group is not particularly limited, and examples thereof include a method of copolymerizing a compound having a functional group selected from Group (A) of functional groups or Group (B) of functional groups, a method of using a polymerization initiator having (generating) the above functional group, and a method of using a polymeric reaction. Alternatively, a functional group can be introduced as a reaction point, by using a functional group that is present in the side chain or the terminal of the binder forming polymer. For example, as shown in Examples described later, it is possible to introduce the functional group (a) or the like by an ene reaction or ene-thiol reaction with a double bond remaining in the binder forming polymer by using a compound having a functional group as well as by various reactions with an anhydrous carboxylic acid group (a carboxylic acid anhydride group).

The compound having the above-described functional group is not particularly limited; however, examples thereof include a compound having at least one carbon-carbon unsaturated bond and at least one functional group described above. For example, it includes a compound in which a carbon-carbon unsaturated bond and the above-described functional group are directly bonded, a compound in which a carbon-carbon unsaturated bond and the above-described functional group are bonded through the above-described linking group, as well as a compound (for example, the polymerizable cyclic carboxylic acid anhydride) in which the functional group itself contains a carbon-carbon unsaturated bond. Further, the compound having the above-described functional group include compounds that are capable of introducing a functional group into the constitutional component in the binder forming polymer by various reactions (for example, alcohol and each of the amino, mercapto, and epoxy compounds (including polymers thereof), which are capable of undergoing an addition reaction or condensation reaction with a constitutional component derived from carboxylic acid anhydride, a constitutional component having a carbon-carbon unsaturated bond, or the like). Further, examples of the compound having the above-described functional group also include a compound in which a carbon-carbon unsaturated bond is bonded directly or through the above-described linking group to a macromonomer having a functional group incorporated as a substituent in the polymerized chain. Examples of the macromonomer from which the macromonomer constitutional component is derived include a macromonomer that is appropriately determined depending on the kind of the main chain of the binder forming polymer, for example, a macromonomer having a polymerized chain of a chain polymerization polymer described later, although it is not unique.

The number average molecular weight of the macromonomer is not particularly limited; however, it is preferably 500 to 100,000, more preferably 1,000 to 50,000, and still more preferably 2,000 to 20,000, in that the binding force of solid particles as well as the adhesiveness to the collector can be further strengthened while maintaining excellent dispersion stability and handleability. The content of the repeating unit having the functional group (b) that is incorporated into the macromonomer is preferably 1% to 100% by mole, more preferably 3% to 80% by mole, and still more preferably 5% to 70% by mole. The content of the repeating unit having no functional group (b) is preferably 0%% to 90% by mole, more preferably 0% to 70% by mole, and still more preferably 0% to 50% by mole. Any component can be selected from the viewpoint of solubility property.

Chain Polymerization Polymer

Examples of the chain polymerization polymer as the binder forming polymer include a fluorine-containing polymer, a hydrocarbon-based polymer, a vinyl polymer, and a (meth)acrylic polymer, where a vinyl polymer, a hydrocarbon-based polymer, or a (meth)acrylic polymer is preferable. The chain polymerization polymer preferably has, as the constitutional component thereof, the above-described constitutional component having the functional group (a) or the functional group (b).

Examples of the fluorine-containing polymer, which are not particularly limited, include polytetrafluoroethylene (PTFE), polyvinylene difluoride (PVdF), a copolymer of polyvinylene difluoride and hexafluoropropylene (PVdF-HFP), and a copolymer (PVdF-HFP-TFE) of polyvinylidene difluoride, hexafluoropropylene, and tetrafluoroethylene. In PVdF-HFP, the copolymerization ratio [PVdF:HFP] (mass ratio) of PVdF to HFP is not particularly limited; however, it is preferably 9:1 to 5:5 and more preferably 9:1 to 7:3 from the viewpoint of adhesiveness. In PVdF-HFP-TFE, the copolymerization ratio [PVdF:HFP:TFE] (mass ratio) of PVdF, HFP, and TFE is not particularly limited; however, it is preferably 20 to 60:10 to 40:5 to 30.

Examples of the hydrocarbon-based polymer, which are not particularly limited, include polyethylene, polypropylene, a polyethylene-poly(ethylene-butyl)-polyethylene copolymer, natural rubber, polybutadiene, polyisoprene, polystyrene, a polystyrene butadiene copolymer, a polypropylene-polyethylene-polybutylene copolymer (CEBC), a styrene-based thermoplastic elastomer, polybutylene, an acrylonitrile-butadiene copolymer, and hydrogen-added (hydrogenated) polymers thereof. The styrene-based thermoplastic elastomer or the hydride thereof is not particularly limited. However, examples thereof include a styrene-ethylene-butylene-styrene block copolymer (SEBS), a styrene-isoprene-styrene block copolymer (SIS), a hydrogenated SIS, a styrene-isobutylene-styrene block copolymer (SIBS), a styrene-butadiene-styrene block copolymer (SBS), a hydrogenated SBS, a styrene-ethylene-ethylene-propylene-styrene block copolymer (SEEPS), a styrene-ethylene-propylene-styrene block copolymer (SEPS), a styrene-butadiene rubber (SBR), a hydrogenated a styrene-butadiene rubber (HSBR), and the like, and as well as a random copolymer corresponding to each of the above-described block copolymers such as SEBS. In the present invention, the hydrocarbon-based polymer preferably has no unsaturated group (for example, a 1,2-butadiene constitutional component) that is bonded to the main chain from the viewpoint that the formation of chemical crosslink can be suppressed.

The hydrocarbon-based polymer may have, in the side chain thereof, the functional group (b) selected from Group (B) of functional groups, for example, a fluoroalkyl group or a siloxane group. This is because the adsorptive force to solid particles can be adjusted appropriately.

The vinyl polymer is not particularly limited; however, examples thereof include a polymer containing a vinyl monomer other than the (meth)acrylic compound (M1), where the content of the vinyl polymer is, for example, 50% by mole or more. Examples of the vinyl monomer include vinyl compounds described later. Specific examples of the vinyl polymer include polyvinyl alcohol, polyvinyl acetal, polyvinyl acetate, and a copolymer containing these.

In addition to the constitutional component derived from the vinyl monomer, this vinyl polymer preferably has a constitutional component derived from the (meth)acrylic compound (M1) that forms a (meth)acrylic polymer described later and further, a constitutional component (MM) derived from a macromonomer described later. The content of the constitutional component derived from the vinyl monomer is preferably the same as the content of the constitutional component derived from the (meth)acrylic compound (M1) in the (meth)acrylic polymer. The content of the constitutional component derived from the (meth)acrylic compound (M1) in the polymer is not particularly limited as long as it is less than 50% by mole; however, it is preferably 0% to 40% by mole and more preferably 5% to 35% by mole. The content of the constitutional component (MM) in the polymer is preferably the same as the content in the (meth)acrylic polymer.

The (meth)acrylic polymer is not particularly limited; however, it is preferably, for example, a polymer obtained by (co)polymerizing at least one (meta)acrylic compound (M1) selected from a (meth)acrylic acid compound, a (meth)acrylic acid ester compound, a (meth)acrylamide compound, or a (meth)acrylonitrile compound. Further, a (meth)acrylic polymer consisting of a copolymer of the (meth)acrylic compound (M1) and another polymerizable compound (M2) is also preferable. The other polymerizable compound (M2) is not particularly limited, and examples thereof include vinyl compounds such as a styrene compound, a vinylnaphthalene compound, a vinylcarbazole compound, an allyl compound, a vinyl ether compound, a vinyl ester compound, a dialkyl itaconate compound, and an unsaturated carboxylic acid anhydride. Examples of the vinyl compound include the “vinyl monomer” disclosed in JP2015-88486A.

The content of the other polymerizable compound (M2) in the (meth)acrylic polymer is not particularly limited; however, it can be, for example, less than 50% by mole.

Examples of the (meth)acrylic polymer include those described in JP6295332B.

Examples of the chain polymerization polymer include a polymer obtained by introducing a constitutional component having the functional group (a) or functional group (b) into each of the polymers described above. The method of incorporating a functional group is the same as that of the sequential polymerization polymer.

The binder forming polymer (each constitutional component and raw material compound) may have a substituent. The substituent is not particularly limited as long as it is a group other than the functional group included in the above-described Group (A) of functional groups and Group (B) of functional groups, and preferred examples thereof include a group selected from the substituent Z described below.

Substituent Z—

The examples are an alkyl group (preferably an alkyl group having 1 to 20 carbon atoms, for example, methyl, ethyl, isopropyl, t-butyl, pentyl, heptyl, 1-ethylpentyl, benzyl, 2-ethoxyethyl, and 1-carboxymethyl), an alkenyl group (preferably an alkenyl group having 2 to 20 carbon atoms, such as vinyl, allyl, andoleyl), an alkynyl group (preferably an alkynyl group having 2 to 20 carbon atoms, for example, ethynyl, butadynyl, and phenylethynyl), a cycloalkyl group (preferably a cycloalkyl group having 3 to 20 carbon atoms, such as cyclopropyl, cyclopentyl, cyclohexyl, and 4-methylcyclohexyl; in the present specification, the alkyl group generally has a meaning including a cycloalkyl group therein when being referred to, however, it will be described separately here), an aryl group (preferably an aryl group having 6 to 26 carbon atoms, such as phenyl, 1-naphthyl, 4-methoxyphenyl, 2-chlorophenyl, and 3-methylphenyl), an aralkyl group (preferably an aralkyl group having 7 to 23 carbon atoms, for example, benzyl or phenethyl), and a heterocyclic group (preferably a heterocyclic group having 2 to 20 carbon atoms and more preferably a 5- or 6-membered heterocyclic group having at least one oxygen atom, one sulfur atom, or one nitrogen atom. The heterocyclic group includes an aromatic heterocyclic group and an aliphatic heterocyclic group. Examples thereof include a tetrahydropyran ring group, a tetrahydrofuran ring group, a 2-pyridyl group, a 4-pyridyl group, a 2-imidazolyl group, a 2-benzimidazolyl group, a 2-thiazolyl group, a 2-oxazolyl group, or a pyrrolidone group); an alkoxy group (preferably an alkoxy group having 1 to 20 carbon atoms, for example, a methoxy group, an ethoxy group, an isopropyloxy group, or a benzyloxy group); an aryloxy group (preferably an aryloxy group having 6 to 26 carbon atoms, for example, a phenoxy group, a 1-naphthyloxy group, a 3-methylphenoxy group, or a 4-methoxyphenoxy group; in the present specification, the aryloxy group has a meaning including an aryloyloxy group therein when being referred to); a heterocyclic oxy group (a group in which an —O— group is bonded to the above-described heterocyclic group), an alkoxycarbonyl group (preferably an alkoxycarbonyl group having 2 to 20 carbon atoms, for example, an ethoxycarbonyl group, a 2-ethylhexyloxycarbonyl group, or a dodecyloxycarbonyl group); an aryloxycarbonyl group (preferably an aryloxycarbonyl group having 6 to 26 carbon atoms, for example, a phenoxycarbonyl group, a 1-naphthyloxycarbonyl group, a 3-methylphenoxycarbonyl group, or a 4-methoxyphenoxycarbonyl group); an amino group (preferably an amino group having 0 to 20 carbon atoms, an alkylamino group, or an arylamino group, for example, an amino (—NH₂) group, an N,N-dimethylamino group, an N,N-diethylamino group, an N-ethylamino group, or an anilino group); a sulfamoyl group (preferably a sulfamoyl group having 0 to 20 carbon atoms, for example, an N,N-dimethylsulfamoyl group or an N-phenylsufamoyl group); an acyl group (an alkylcarbonyl group, an alkenylcarbonyl group, an alkynylcarbonyl group, an arylcarbonyl group, or a heterocyclic carbonyl group, preferably an acyl group having 1 to 20 carbon atoms, for example, an acetyl group, a propionyl group, a butyryl group, an octanoyl group, a hexadecanoyl group, an acryloyl group, a methacryloyl group, a crotonoyl group, a benzoyl group, a naphthoyl group, or a nicotinoyl group); an acyloxy group (an alkylcarbonyloxy group, an alkenylcarbonyloxy group, an alkynylcarbonyloxy group, an arylcarbonyloxy group, or a heterocyclic carbonyloxy group, preferably an acyloxy group having 1 to 20 carbon atoms, for example, an acetyloxy group, a propionyloxy group, a butyryloxy group, an octanoyloxy group, a hexadecanoyloxy group, an acryloyloxy group, a methacryloyloxy group, a crotonoyloxy group, a benzoyloxy group, a naphthoyloxy group, or a nicotinoyloxy group); an aryloyloxy group (preferably an aryloyloxy group having 7 to 23 carbon atoms, for example, a benzoyloxy group); a carbamoyl group (preferably a carbamoyl group having 1 to 20 carbon atoms, for example, an N,N-dimethylcarbamoyl group or an N-phenylcarbamoyl group); an acylamino group (preferably an acylamino group having 1 to 20 carbon atoms, for example, an acetylamino group or a benzoylamino group); an alkylthio group (preferably an alkylthio group having 1 to 20 carbon atoms, for example, a methylthio group, an ethylthio group, an isopropylthio group, or a benzylthio group); an arylthio group (preferably an arylthio group having 6 to 26 carbon atoms, for example, a phenylthio group, a 1-naphthylthio group, a 3-methylphenylthio group, or a 4-methoxyphenylthio group); a heterocyclic thio group (a group in which an —S— group is bonded to the above-described heterocyclic group), an alkylsulfonyl group (preferably an alkylsulfonyl group having 1 to 20 carbon atoms, for example, a methylsulfonyl group or an ethylsulfonyl group), an arylsulfonyl group (preferably an arylsulfonyl group having 6 to 22 carbon atoms, for example, a benzenesulfonyl group), an alkylsilyl group (preferably an alkylsilyl group having 1 to 20 carbon atoms, for example, a monomethylsilyl group, a dimethylsilyl group, a trimethylsilyl group, or a triethylsilyl group); an arylsilyl group (preferably an arylsilyl group having 6 to 42 carbon atoms, for example, a triphenylsilyl group), an alkoxysilyl group (preferably an alkoxysilyl group having 1 to 20 carbon atoms, for example, a monomethoxysilyl group, a dimethoxysilyl group, a trimethoxysilyl group, or a triethoxysilyl group), an aryloxysilyl group (preferably an aryloxysilyl group having 6 to 42 carbon atoms, for example, a triphenyloxysilyl group), a phosphate group (preferably a phosphate group having 0 to 20 carbon atoms, for example, —OP(═O)(R^{P})₂), a phosphonyl group (preferably a phosphonyl group having 0 to 20 carbon atoms, for example, —P(═O)(R^{P})₂), a phosphinyl group (preferably a phosphinyl group having 0 to 20 carbon atoms, for example, —P(R^{P})₂), a phosphonate group (preferably a phosphonate group having 0 to 20 carbon atoms, for example, —PO(OR^{P})₂), a sulfo group (a sulfonate group or —SO₃R^{P}), a carboxy group, a hydroxy group, a sulfanyl group, a cyano group, and a halogen atom (for example, a fluorine atom, a chlorine atom, a bromine atom, or an iodine atom). R^{P} represents a hydrogen atom or a substituent (preferably a group selected from the substituent Z).

In addition, each group exemplified in the substituent Z may be further substituted with the substituent Z.

The alkyl group, the alkylene group, the alkenyl group, the alkenylene group, the alkynyl group, the alkynylene group, and/or the like may be cyclic or chained, may be linear or branched.

(Physical Properties, Characteristics, or the Like of Polymer Binder or Binder Forming Polymer)

The polymer binder or the binder forming polymer preferably has the following physical properties or characteristics.

The water concentration of the polymer binder (the polymer) is preferably 100 ppm (mass basis) or less. Further, as this polymer binder, a polymer may be crystallized and dried, or a polymer binder dispersion liquid may be used as it is.

It is preferable that the binder forming polymer is amorphous. In the present invention, “amorphous polymer” typically refers to a resin that shows no endothermic peak caused by crystal melting during the measurement of the glass transition temperature.

The binder forming polymer may be a non-crosslinked polymer or a crosslinked polymer. In addition, in a case where the crosslinking of the polymer progresses due to heating or voltage application, the molecular weight may be higher than the above-described molecular weight. Preferably, the polymer has a mass average molecular weight in the range described below at the start of use of the all-solid state secondary battery.

The mass average molecular weight of the binder forming polymer is not particularly limited. For example, it is preferably 15,000 or more, and it is more preferably 30,000 or more and still more preferably 50,000 or more. The upper limit thereof is practically 5,000,000 or less, and it is preferably 4,000,000 or less and more preferably 3,000,000 or less.

Measurement of Molecular Weight—

In the present invention, unless specified otherwise, molecular weights of a polymer chain and a macromonomer refer to a mass average molecular weight and number average molecular weight in terms of standard polystyrene equivalent, which are determined by gel permeation chromatography (GPC). Regarding a measuring method, basically, a value measured using a method under the following condition 1 or condition 2 (preferred) is used. However, depending on the kind of polymer or macromonomer, an appropriate eluent may be appropriately selected and used.

(Conditions 1)

Column: Connect two TOSOH TSKgel Super AWM-H (product name, manufactured by Tosoh Corporation)

Carrier: 10 mM LiBr/N-methylpyrrolidone

Measurement temperature: 40° C.

Carrier flow rate: 1.0 ml/min

Sample concentration: 0.1% by mass

Detector: refractive indicator (RI) detector

(Conditions 2)

Column: A column obtained by connecting TOSOH TSKgel Super HZM-H, TOSOH TSKgel Super HZ4000, and TOSOH TSKgel Super HZ2000 (all of which are product names, manufactured by Tosoh Corporation)

Carrier: tetrahydrofuran

Measurement temperature: 40° C.

Carrier flow rate: 1.0 ml/min

Sample concentration: 0.1% by mass

Detector: refractive indicator (RI) detector

The inorganic solid electrolyte-containing composition according to the embodiment of the present invention may contain one kind of polymer binder or two or more kinds thereof.

The (total) content of the polymer binder in the inorganic solid electrolyte-containing composition is not particularly limited. However, it is preferably 0.1% to 10.0% by mass, more preferably 0.2% to 8% by mass, still more preferably 0.3% to 6% by mass, and particularly preferably 0.5% to 3% by mass in 100% by mass of the solid content, in that dispersion stability and handleability are improved and furthermore, the sufficient binding property is exhibited.

In the present invention, the mass ratio [(the mass of the inorganic solid electrolyte+the mass of the active material)/(the total mass of the polymer binder)] of the total mass (the total amount) of the inorganic solid electrolyte and the active material to the total mass of the polymer binder in the solid content of 100% by mass is preferably in a range of 1,000 to 1. Furthermore, this ratio is more preferably 500 to 2 and still more preferably 100 to 10.

<Metal Element-Containing Compound>

The inorganic solid electrolyte-containing composition according to the embodiment of the present invention contains a metal element-containing compound. In a case where a metal element-containing compound is allowed to present in a solid state together with the inorganic solid electrolyte particles and the polymer binder, it interacts with the polymer binder in a dissolved state, whereby the polymer binder can be solidified into a particle shape, for example, with the ion receiving part of the metal element-containing compound or the metal element being serving as the starting point.

This metal element-containing compound has a property of being capable of supplying, as an ion (a cation), at least a part of the metal elements constituting the molecule to the binder forming polymer.

The property that the metal element-containing compound is capable of supplying the metal element ion is not uniquely determined by a chemical structure or the like of the binder forming polymer, where the chemical structure is capable of receiving the metal element ion. For example, regarding the anion that constitutes the metal element-containing compound, the negative common logarithm [pKa] (in water) of the acid dissociation constant of the conjugate acid thereof is preferably −2 to 40, more preferably −2 to 20, still more preferably 0 to 10, and particularly preferably 2 to 8. In a case where the pKa of the conjugate acid is within the above range, the metal element-containing compound can rapidly liberate and generate a metal element ion as a cation to effectively supply it to the binder forming polymer. The pKa of the conjugate acid can be measured in the same manner as the pKa of the functional group (a).

The pKa of the conjugate acid from which the anion is derived is preferably larger than the pKa (in a case where the binder forming polymer has a plurality of kinds of functional groups (a), at least a pKa exhibiting the lowest value among the pKa's of the respective functional groups) of the functional group (a) in terms of realizing the improvement of dispersion characteristics and battery characteristics. Here, the pKa difference between the pKa of the conjugate acid and the pKa of the functional group (a) [(the pKa of the conjugate acid)−(the pKa of the functional group)] is not particularly limited and can be 0.1 or more. However, it is preferably 2 or more and more preferably 2.5 or more, in that both the dispersion characteristics and the resistance can be achieved at a higher level. The upper limit of the pKa difference is not particularly limited and can be set to, for example, 35 or less. It is preferably 30 or less and more preferably 20 or less.

In a case where the metal element-containing compound can liberate a metal element ion at the time of forming a film of the inorganic solid electrolyte-containing composition, it may liberate a part of metal elements as ions at a time other than the time of forming a film (at the time of preparation, storage, or the like).

The metal element-containing compound is insoluble in the dispersion medium contained in the inorganic solid electrolyte-containing composition and is present in a solid state in the inorganic solid electrolyte-containing composition. Due to being present in a solid state, it covers only partially the surface of the solid particles even in a case where it covers the surface thereof at the time of forming a film, and thus it is possible to suppress an increase in the interface resistance between the solid particles. In the present invention, “insoluble” refers to that the solubility in the dispersion medium according to the above-described measuring method is 0.05% or less, and a part of the metal element-containing compound may be dissolved in the dispersion medium within a range where the effects of the present invention are not impaired.

In the inorganic solid electrolyte-containing composition, the metal element-containing compound is preferably dispersed in a dispersion medium in a solid state. The description that the metal element-containing compound is dispersed in a dispersion medium in a solid state refers to that the reduced amount of solid content in the dispersion stability test in Examples described later is less than 5% by mass in a case where a dispersion liquid obtained by mixing (dispersing) the metal element-containing compound with a dispersion medium at a proportion of a solid content concentration of 10% by mass.

The average particle diameter of the metal element-containing compound that is present in a solid state is not particularly limited and can be 0.05 to 35 μm. In terms of improving the dispersion characteristics and the battery characteristics, the lower limit of the average particle diameter is preferably 0.05 μm or more, more preferably 0.07 μm or more, still more preferably 0.1 μm or more. The upper limit of the average particle diameter is preferably 5 μm or less, more preferably 3 μm or less, and still more preferably 2 μm or less. The average particle diameter is a value measured by a method described in Examples described later. The average particle diameter of the metal element-containing compound can be adjusted by, for example, the compound structure, for example, the kind or content of an anion or metal element, and the kind of dispersion medium.

The metal element-containing compound is not particularly limited as long as it is a compound exhibiting a property of being capable of supplying a metal element ion, and examples thereof include various compounds. Although the metal element-containing compound may be an inorganic compound, it is preferably an organic compound, and although it may be a polymeric compound, it is preferably a low-molecular-weight compound (a non-polymerizable compound). It is preferable that this metal element-containing compound does not exhibit the ion conductivity of a metal belonging to Group 1 or Group 2 in the periodic table (lithium ion conductivity: less than 10⁻⁶ S/cm).

The metal element-containing compound that is used in the present invention is such a compound group that the pKa of the conjugate acid of the anion thereof is as small as less than −2 in terms of exhibiting the property of being capable of supplying the metal element ion, for example, in terms of exhibiting the pKa described above, and it is different from the inorganic solid electrolyte, the active material, the conductive auxiliary agent, the lithium salt, the ionic liquid, the viscosity improver, and the like, which are generally used in the all-solid state secondary battery and do not exhibit the property of being capable of supplying the metal element ion.

The metal element-containing compound is preferably, for example, an organic metal compound or an organic metal salt, which contains an anion derived from an organic compound such as an organic acid, an alcohol, or a hydrocarbon and a cation derived from a metal element. The organic metal compound or the organic metal salt is not particularly limited, and examples thereof include an organic acid metal salt containing an anion derived from an organic acid and a cation derived from a metal element, an alkoxide (an alcoholate) containing an anion derived from alcohol and a cation derived from a metal element, and an organic metal compound containing an anion derived from a hydrocarbon and a cation derived from a metal element. Among them, an organic acid metal salt or an alkoxide is preferable, and an organic acid metal salt is more preferable. Here, the anion is preferably such an anion that the pKa of the conjugate acid (the above-described organic compound) thereof is in the above range.

The metal element that forms the cation is not particularly limited and is appropriately selected from the metal elements belonging to Group 1 to Group 17 of the periodic table. However, it is preferable to contain a metal element belonging to Group 1, Group 2, Group 12, or Group 13 of the periodic table, more preferable to contain a metal element (an alkali metal) belonging to Group 1 of the periodic table or a metal element (an alkaline earth metal) belonging to Group 2 thereof, still more preferable to contain a metal element belonging to Group 1 of the periodic table, and particularly preferable to contain a lithium element, in terms of improving the dispersion characteristics and the battery characteristics.

The valence that can be adopted by the metal element or the ion thereof is not particularly limited and is selected from, for example, in a range of a valence of 1 to a valence of 7. However, a small valence is preferable in terms of improving the dispersion characteristics and the battery characteristics, and it is for example, more preferably a valence of 1 to 3, still more preferably a valence of 1 or a valence of 2, and particularly preferably a valence of 1.

The kinds of metal element is preferably the same as that of the metal element contained in the inorganic solid electrolyte in relation to the inorganic solid electrolyte.

The organic compound that forms the anion is a compound in which the metal element of the metal element-containing compound is substituted with a hydrogen atom, and it is not particularly limited. However, among the above, an organic acid, an alcohol, or a hydrocarbon is preferable, and an organic acid is more preferable.

The organic acid is a hydrocarbon compound having an acid group, and examples thereof include an organic carboxylic acid, an organic sulfonic acid, an organic phosphonic acid, and an organic boronic acid, where an organic carboxylic acid is preferable in terms of achieving both the improvement of dispersion characteristics and the lower resistance at a high level. The number of acid groups contained in the organic acid is not particularly limited, and it is preferably 1 to 3 and more preferably 1 or 2.

The hydrocarbon compound that constitutes the organic acid is not particularly limited, and examples thereof include a chain-type or cyclic-type saturated hydrocarbon, a chain-type or cyclic-type unsaturated hydrocarbon, and an aromatic hydrocarbon, where a chain-type saturated hydrocarbon is preferable. Further, the structure of the chain-type saturated hydrocarbon or unsaturated hydrocarbon may be a linear chain structure or a branched chain. Each of the hydrocarbon compounds may have a substituent selected from the substituent Z described above.

The organic carboxylic acid is not particularly limited; however, examples thereof include a saturated or unsaturated fatty acid, a saturated or unsaturated aliphatic dicarboxylic acid, and an aromatic dicarboxylic acid. It is noted that formic acid is a compound in which one carboxy group and a hydrogen atom are bonded, and oxalic acid is a compound in which two carboxy groups are bonded, both of which are included in the organic carboxylic acid.

The alcohol is a hydrocarbon compound having a hydroxyl group, and the number of hydroxyl groups contained in the hydrocarbon compound is not particularly limited, and it is preferably 1 to 3 and more preferably 1 or 2. The hydrocarbon compound that constitutes the alcohol is not particularly limited, and preferred examples thereof include a hydrocarbon compound that constitutes an organic acid.

The hydrocarbon that forms the anion is not particularly limited, and preferred examples thereof include a hydrocarbon compound that constitutes an organic acid.

The number of carbon atoms of the organic compound that forms the anion is not particularly limited, and it may be 1 to 24. However, it is preferably 3 to 22, more preferably 6 to 21, still more preferably 10 to 20, and particularly preferably 12 to 19, in terms of improving the dispersion characteristics and the battery characteristics.

The metal element-containing compound may be present alone in the inorganic solid electrolyte-containing composition, or it may form a composite body (for example, an adsorbent, a complex, or a solvate) with other components. However, the organic carboxylic acid metal salt does not form a boron trifluoride complex as in JP2013-209355A.

Specific examples of the metal element-containing compound are shown below and in Examples; however, the present invention is not limited thereto. It is noted that although all of the exemplary compounds C-4 to C-26 are shown as lithium salts, they are not limited to lithium salts.

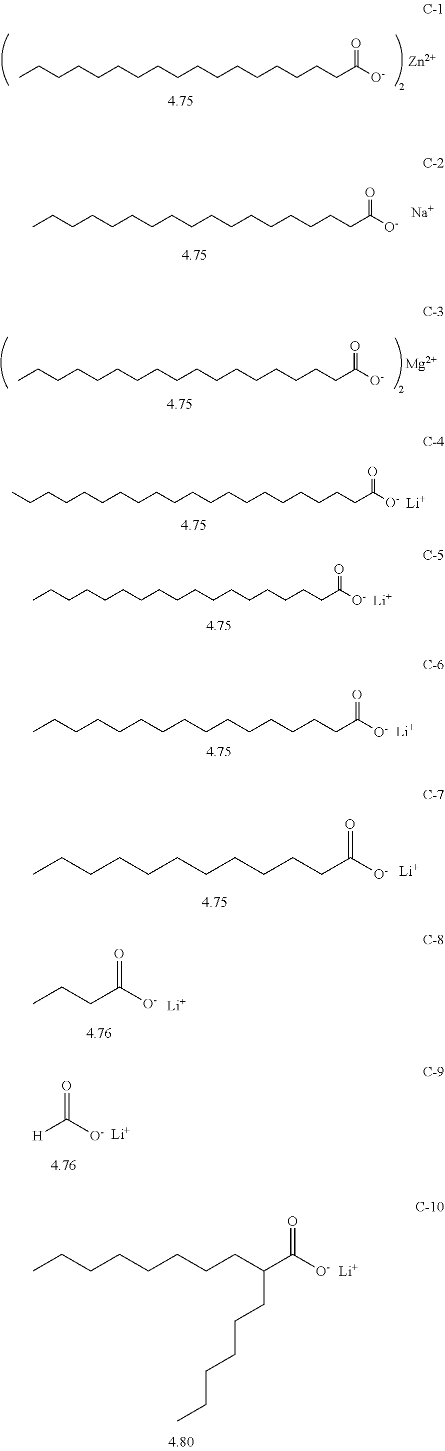

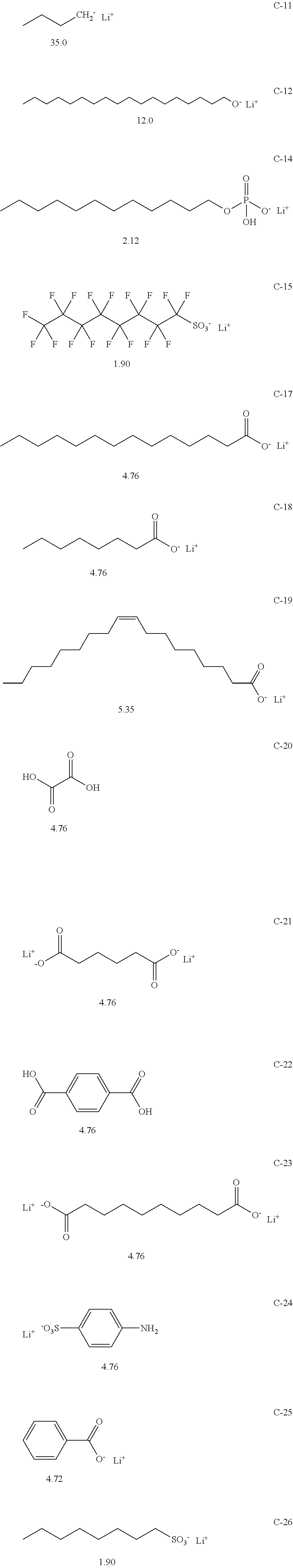

The inorganic solid electrolyte-containing composition of the present invention may contain one kind of metal element-containing compound or two or more kinds thereof.

The content of the metal element-containing compound in the inorganic solid electrolyte-containing composition is not particularly limited. However, it is preferably 0.005% to 3% by mass, more preferably 0.007% to 1% by mass, and still more preferably 0.01% to 0.1% by mass in 100% by mass of the solid content, in that both the improvement of the dispersion characteristics and the lower resistance can be achieved and moreover, solid particles can be sufficiently bound.

In a case where the polymer binder has the functional group (a), the content of the metal element-containing compound can be such an amount that the metal element-containing compound is capable of supplying to the functional group (a) preferably 1% to 100% by mole and more preferably 30% to 99% by mole of the metal element as an ion.

<Dispersion Medium>

The inorganic solid electrolyte-containing composition according to the embodiment of the present invention contains a dispersion medium that dissolves the binder forming polymer and disperses the metal element-containing compound.

It suffices that the dispersion medium is an organic compound that is in a liquid state in the use environment, examples thereof include various organic solvents, and specific examples thereof include an alcohol compound, an ether compound, an amide compound, an amine compound, a ketone compound, an aromatic compound, an aliphatic compound, a nitrile compound, and an ester compound.

The dispersion medium may be a non-polar dispersion medium (a hydrophobic dispersion medium) or a polar dispersion medium (a hydrophilic dispersion medium); however, a non-polar dispersion medium is preferable in terms of realizing the dissolved state of the polymer binder and the dispersed state of the metal element-containing compound. The non-polar dispersion medium generally refers to a solvent having a property of a low affinity to water; however, in the present invention, it is preferably a dispersion medium having a CLogP value of 1.5 to 6, and examples thereof include an ester compound, a ketone compound, an ether compound, an aromatic compound, and an aliphatic compound.

Examples of the alcohol compound include methyl alcohol, ethyl alcohol, 1-propyl alcohol, 2-propyl alcohol, 2-butanol, ethylene glycol, propylene glycol, glycerin, 1,6-hexanediol, cyclohexanediol, sorbitol, xylitol, 2-methyl-2,4-pentanediol, 1,3-butanediol, and 1,4-butanediol.

Examples of the ether compound include an alkylene glycol (diethylene glycol, triethylene glycol, polyethylene glycol, dipropylene glycol, or the like), an alkylene glycol monoalkyl ether (ethylene glycol monomethyl ether, ethylene glycol monobutyl ether, propylene glycol monomethyl ether, diethylene glycol monomethyl ether, dipropylene glycol monomethyl ether, tripropylene glycol monomethyl ether, diethylene glycol monobutyl ether, diethylene glycol monobutyl ether, or the like), alkylene glycol dialkyl ether (ethylene glycol dimethyl ether or the like), a dialkyl ether (dimethyl ether, diethyl ether, diisopropyl ether, dibutyl ether, or the like), and a cyclic ether (tetrahydrofuran, dioxane (including 1,2-, 1,3- or 1,4-isomer), or the like).

Examples of the amide compound include N,N-dimethylformamide, N-methyl-2-pyrrolidone, 2-pyrrolidinone, 1,3-dimethyl-2-imidazolidinone, ε-caprolactam, formamide, N-methylformamide, acetamide, N-methylacetamide, N,N-dimethylacetamide, N-methylpropanamide, and hexamethylphosphorictriamide.

Examples of the amine compound include triethylamine, diisopropylethylamine, and tributylamine.

Examples of the ketone compound include acetone, methyl ethyl ketone, methyl isobutyl ketone (MIBK), cyclopentanone, cyclohexanone, cycloheptanone, dipropyl ketone, dibutyl ketone, diisopropyl ketone, diisobutyl ketone (DIBK), isobutyl propyl ketone, sec-butyl propyl ketone, pentyl propyl ketone, and butyl propyl ketone.

Examples of the aromatic compound include benzene, toluene, and xylene.

Examples of the aliphatic compound include hexane, heptane, octane, decane, cyclohexane, methylcyclohexane, ethylcyclohexane, cyclooctane, decalin, paraffin, gasoline, naphtha, kerosene, and light oil.

Examples of the nitrile compound include acetonitrile, propionitrile, and isobutyronitrile.

Examples of the ester compound include ethyl acetate, butyl acetate, propyl acetate, propyl butyrate, isopropyl butyrate, butyl butyrate, isobutyl butyrate, butyl pentanoate, ethyl isobutyrate, propyl isobutyrate, isopropyl isobutyrate, isobutyl isobutyrate, propyl pivalate, isopropyl pivalate, butyl pivalate, and isobutyl pivalate.

In the present invention, among them, an ether compound, a ketone compound, an aromatic compound, an aliphatic compound, or an ester compound is preferable, and an ester compound, a ketone compound, or an ether compound is more preferable.

The number of carbon atoms in the compound forming the dispersion medium is not particularly limited and is preferably 2 to 30, more preferably 4 to 20, still more preferably 6 to 15, and still more preferably 7 to 12.

The compound that constitutes the dispersion medium preferably has a CLogP value of 1 or more, more preferably 1.5 or more, still more preferably 2 or more, and particularly preferably 3 or more. The upper limit thereof is not particularly limited; however, it is practically 10 or less and preferably 6 or less.

In the present invention, the CLogP value is a value obtained by calculating the common logarithm LogP of the partition coefficient P between 1-octanol and water. Known methods and software can be used for calculating the CLogP value. However, unless otherwise specified, a value calculated from a structure that is drawn by using ChemDraw of PerkinElmer, Inc. is used.

In a case where two or more kinds of dispersion media are contained, the CLogP value of the dispersion medium is the sum of the products of the CLogP values and the mass fractions of the respective dispersion media.

Examples of such a dispersion medium among those described above include toluene (CLogP=2.5), xylene (ClogP=3.12), hexane (CLogP=3.9), heptane (Hep, CLogP=4.4), Octane (CLogP=4.9), cyclohexane (CLogP=3.4), cyclooctane (CLogP=4.5), decalin (CLogP=4.8), diisobutyl ketone (DIBK, CLogP=3.0), dibutyl ether (DBE, CLogP=2.57), butyl butyrate (CLogP=2.8), tributylamine (CLogP=4.8), methyl isobutyl ketone (MIBK, ClogP=1.31), and ethylcyclohexane (ECH, ClogP=3.4).

The boiling point of the dispersion medium under normal pressure (1 atm) is preferably 50° C. or higher and more preferably 70° C. or higher. The upper limit is preferably 250° C. or lower and more preferably 220° C. or lower.

It suffices that the inorganic solid electrolyte-containing composition according to the embodiment of the present invention contains at least one kind of dispersion medium, and it may contain two or more kinds thereof.

In the present invention, the content of the dispersion medium in the inorganic solid electrolyte-containing composition is not particularly limited and can be appropriately set. For example, in the inorganic solid electrolyte-containing composition, it is preferably 20% to 80% by mass, more preferably 30% to 70% by mass, and particularly preferably 40% to 60% by mass.

<Active Material>

The inorganic solid electrolyte-containing composition according to the embodiment of the present invention can also contain an active material capable of intercalating and deintercalating an ion of a metal belonging to Group 1 or Group 2 of the periodic table. Examples of such active materials include a positive electrode active material and a negative electrode active material, which will be described later.

In the present invention, the inorganic solid electrolyte-containing composition containing an active material (a positive electrode active material or a negative electrode active material) may be referred to as a composition for an electrode (a composition for a positive electrode or a composition for a negative electrode).

(Positive Electrode Active Material)

The positive electrode active material is preferably a positive electrode active material capable of reversibly intercalating and deintercalating lithium ions. The above-described material is not particularly limited as long as the material has the above-described characteristics and may be a transition metal oxide or an element, which is capable of being complexed with Li, such as sulfur or the like by disassembling the battery.

Among the above, as the positive electrode active material, transition metal oxides are preferably used, and transition metal oxides having a transition metal element Ma (one or more elements selected from Co, Ni, Fe, Mn, Cu, and V) are more preferable. In addition, an element M^{b} (an element other than lithium, such as an element of Group 1 (Ia) or an element of Group 2 (IIa) of the periodic table of metals, or an element such as Al, Ga, In, Ge, Sn, Pb, Sb, Bi, Si, P, or B) may be mixed into this transition metal oxide. The amount of the element mixed is preferably 0% to 30% by mole of the amount (100% by mole) of the transition metal element Ma. It is more preferable that the transition metal oxide is synthesized by mixing the above components such that a molar ratio Li/Ma is 0.3 to 2.2.

Specific examples of the transition metal oxides include transition metal oxides having a bedded salt-type structure (MA), transition metal oxides having a spinel-type structure (MB), lithium-containing transition metal phosphate compounds (MC), lithium-containing transition metal halogenated phosphoric acid compounds (MD), and lithium-containing transition metal silicate compounds (ME).

Specific examples of the transition metal oxides having a layered rock salt structure (MA) include LiCoO₂ (lithium cobalt oxide [LCO]), LiNi₂O₂ (lithium nickel oxide) LiNi_{0.85}Co_{0.10}Al_{0.05}O₂ (lithium nickel cobalt aluminum oxide [NCA]), LiNi_{1/3}Co_{1/3}Mn_{1/3}O₂ (lithium nickel manganese cobalt oxide [NMC]), and LiNi_{0.5}Mn_{0.5}O₂ (lithium manganese nickelate).

Specific examples of the transition metal oxides having a spinel-type structure (MB) include LiMn₂O₄ (LMO), LiCoMnO₄, Li₂FeMn₃O₈, Li₂CuMn₃O₈, Li₂CrMn₃O₈, and Li₂NiMn₃O₈.

Examples of the lithium-containing transition metal phosphoric acid compound (MC) include olivine-type iron phosphate salts such as LiFePO₄ and Li₃Fe₂(PO₄)₃, iron pyrophosphates such as LiFeP₂O₇, and cobalt phosphates such as LiCoPO₄, and a monoclinic NASICON type vanadium phosphate salt such as Li₃V₂(PO₄)₃ (lithium vanadium phosphate).

Examples of the lithium-containing transition metal halogenated phosphoric acid compound (MD) include iron fluorophosphates such as Li₂FePO₄F, manganese fluorophosphates such as Li₂MnPO₄F, cobalt fluorophosphates such as Li₂CoPO₄F.

Examples of the lithium-containing transition metal silicate compounds (ME) include Li₂FeSiO₄, Li₂MnSiO₄, and Li₂CoSiO₄.

In the present invention, the transition metal oxides having a layered rock salt structure (MA) is preferable, and LCO or NMC is more preferable.

The shape of the positive electrode active material is not particularly limited; however, it is preferably a particle shape. The particle diameter (the volume average particle diameter) of the positive electrode active material is not particularly limited. For example, it can be set to 0.1 to 50 The particle diameter of the positive electrode active material particle can be measured using the same method as that of the particle diameter of the inorganic solid electrolyte. In order to allow the positive electrode active material to have a predetermined particle diameter, an ordinary pulverizer or classifier is used. For example, a mortar, a ball mill, a sand mill, a vibration ball mill, a satellite ball mill, a planetary ball mill, a swirling air flow jet mill, or a sieve is preferably used. During crushing, it is also possible to carry out wet-type crushing in which water or a dispersion medium such as methanol is made to be present together. In order to provide the desired particle diameter, classification is preferably carried out. The classification is not particularly limited and can be carried out using a sieve, a wind power classifier, or the like. Both the dry-type classification and the wet-type classification can be carried out.

The positive electrode active materials obtained using a baking method may be used after being washed with water, an acidic aqueous solution, an alkaline aqueous solution, or an organic solvent.

As the positive electrode active material, one kind may be used alone, or two or more kinds may be used in combination.

In a case of forming a positive electrode active material layer, the mass (mg) (mass per unit area) of the positive electrode active material per unit area (cm²) of the positive electrode active material layer is not particularly limited. It can be appropriately determined according to the designed battery capacity and can be set to, for example, 1 to 100 mg/cm².

The content of the positive electrode active material in the inorganic solid electrolyte-containing composition is not particularly limited; however, it is preferably 10% to 97% by mass, more preferably 30% to 95% by mass, still more preferably 40 to 93% by mass, and particularly preferably 50% to 90% by mass, in the solid content of 100% by mass.

(Negative Electrode Active Material)

The negative electrode active material is preferably capable of reversibly intercalating and deintercalating lithium ions. The material is not particularly limited as long as it has the above-described properties, and examples thereof include a carbonaceous material, a metal oxide, a metal composite oxide, a lithium single body, a lithium alloy, and a negative electrode active material that is capable of forming an alloy with lithium. Among these, a carbonaceous material, a metal composite oxide, or a lithium single body is preferably used from the viewpoint of reliability.

The carbonaceous material which is used as the negative electrode active material is a material substantially consisting of carbon. Examples thereof include petroleum pitch, carbon black such as acetylene black (AB), graphite (natural graphite, artificial graphite such as vapor-grown graphite), and carbonaceous material obtained by firing a variety of synthetic resins such as polyacrylonitrile (PAN)-based resins or furfuryl alcohol resins. Furthermore, examples thereof also include a variety of carbon fibers such as PAN-based carbon fibers, cellulose-based carbon fibers, pitch-based carbon fibers, vapor-grown carbon fibers, dehydrated polyvinyl alcohol (PVA)-based carbon fibers, lignin carbon fibers, vitreous carbon fibers, and activated carbon fibers, mesophase microspheres, graphite whisker, and tabular graphite.

These carbonaceous materials can be classified into non-graphitizable carbonaceous materials (also referred to as “hard carbon”) and graphitizable carbonaceous materials based on the graphitization degree. In addition, it is preferable that the carbonaceous material has the lattice spacing, density, and crystallite size described in JP1987-22066A (JP-S62-22066A), JP1990-6856A (JP-H2-6856A), and JP1991-45473A (JP-H3-45473A). The carbonaceous material is not necessarily a single material and, for example, may be a mixture of natural graphite and artificial graphite described in JP1993-90844A (JP-H5-90844A) or graphite having a coating layer described in JP1994-4516A (JP-H6-4516A).

As the carbonaceous materials, hard carbon or graphite is preferably used, and graphite is more preferably used.

The oxide of the metal or metalloid element applied as the negative electrode active material is not particularly limited as long as the oxide is an oxide capable of occluding and releasing lithium, and examples thereof include an oxide of a metal element (metal oxide), a composite oxide of a metal element or a composite oxide of a metal element and a metalloid element (collectively referred to as a metal composite oxide), and an oxide of a metalloid element (a metalloid oxide). The oxides are preferably amorphous oxides, and preferred examples thereof include chalcogenides which are reaction products between metal elements and elements in Group 16 of the periodic table). In the present invention, the metalloid element refers to an element having intermediate properties between those of a metal element and a non-metal element. Typically, the metalloid elements include six elements including boron, silicon, germanium, arsenic, antimony, and tellurium, and further include three elements including selenium, polonium, and astatine. In addition, “amorphous” represents a substance having a broad scattering band with a peak in a range of 20° to 40° in terms of the 20 value in case of being measured by an X-ray diffraction method using CuKα rays, and the substance may have a crystal diffraction line. The highest intensity in a crystal diffraction line observed in a range of 40° to 70° in terms of the 20 value is preferably 100 times or less and more preferably 5 times or less relative to the intensity of a diffraction peak line in a broad scattering band observed in a range of 20° to 40° in terms of the 20 value, and it is still more preferable that the substance does not have a crystal diffraction line.

In a compound group consisting of the amorphous oxides and the chalcogenides, amorphous oxides of metalloid elements and chalcogenides are more preferable, and (composite) oxides consisting of one element or a combination of two or more elements selected from elements (for example, Al, Ga, Si, Sn, Ge, Pb, Sb, and Bi) belonging to Groups 13 (IIIB) to 15 (VB) in the periodic table or chalcogenides are more preferable. Specific examples of preferred amorphous oxides and chalcogenides include Ga₂O₃, GeO, PbO, PbO₂, Pb₂O₃, Pb₂O₄, Pb₃O₄, Sb₂O₃, Sb₂O₄, Sb₂O₈Bi₂O₃, Sb₂O₈Si₂O₃, Sb₂O₅, Bi₂O₃, Bi₂O₄, GeS, PbS, PbS₂, Sb₂S₃, and Sb₂S₅.

Preferred examples of the negative electrode active material which can be used in combination with amorphous oxides containing Sn, Si, or Ge as a major component include a carbonaceous material capable of intercalating and/or deintercalating lithium ions or lithium metal, a lithium single body, a lithium alloy, and a negative electrode active material that is capable of being alloyed with lithium.

It is preferable that the oxide of a metal or a metalloid element, in particular, the metal (composite) oxide and the chalcogenide include at least one of titanium or lithium as a constitutional component from the viewpoint of high current density charging and discharging characteristics. Examples of the metal composite oxide (lithium composite metal oxide) including lithium include a composite oxide of lithium oxide and the above metal (composite) oxide or the above chalcogenide, and more specific examples thereof include Li₂SnO₂.

As the negative electrode active material, for example, a metal oxide (titanium oxide) having a titanium element is also preferable. Specifically, Li₄Ti₅O₁₂ (lithium titanium oxide [LTO]) is preferable since the volume variation during the intercalation and deintercalation of lithium ions is small, and thus the high-speed charging and discharging characteristics are excellent, and the deterioration of electrodes is suppressed, whereby it becomes possible to improve the service lives of lithium ion secondary batteries.

The lithium alloy as the negative electrode active material is not particularly limited as long as the lithium alloy is an alloy generally used as a negative electrode active material of a secondary battery, and examples thereof include a lithium aluminum alloy.

The negative electrode active material that is capable of forming an alloy with lithium is not particularly limited as long as it is typically used as a negative electrode active material for a secondary battery. Such an active material has a large expansion and contraction due to charging and discharging of the all-solid state secondary battery and accelerates the deterioration of the cycle characteristics. However, since the inorganic solid electrolyte-containing composition according to the embodiment of the present invention contains the polymer binder and the metal element-containing compound described above, and thus it is possible to suppress the deterioration of the cycle characteristics. Examples of the active material include a (negative electrode) active material (for example, an alloy) having silicon element or tin element and a metal such as Al or In. A negative electrode active material (silicon-containing active material) including a silicon element capable of exhibiting high battery capacity is preferable, and a silicon-containing active material in which the content of the silicon element is 50% by mole or more with respect to all the constitutional elements is more preferable.

In general, a negative electrode including the negative electrode active material (for example, a Si negative electrode including a silicon-containing active material or an Sn negative electrode containing an active material containing a tin element) can intercalate a larger amount of Li ions than a carbon negative electrode (for example, graphite or acetylene black). That is, the amount of Li ions intercalated per unit mass increases. Therefore, it is possible to increase the battery capacity. As a result, there is an advantage that the battery driving duration can be extended.

Examples of the silicon-containing active material include a silicon-containing alloy (for example, LaSi₂, VSi₂, La—Si, Gd—Si, or Ni—Si) including a silicon material such as Si or SiOx (0<x≤1) and titanium, vanadium, chromium, manganese, nickel, copper, lanthanum, or the like or a structured active material thereof (for example, LaSi₂/Si), and an active material such as SnSiO₃ or SnSiS₃ including silicon element and tin element. In addition, since SiOx itself can be used as a negative electrode active material (a metalloid oxide) and Si is produced along with the operation of an all-solid state secondary battery, SiOx can be used as a negative electrode active material (or a precursor material thereof) capable of being alloyed with lithium.

Examples of the negative electrode active material including tin element include Sn, SnO, SnO₂, SnS, SnS₂, and the above-described active material including silicon element and tin element. Furthermore, examples thereof may also include a composite oxide with lithium oxide, for example, Li₂SnO₂.

In the present invention, the above-described negative electrode active material can be used without any particular limitation. From the viewpoint of battery capacity, as the negative electrode active material, a negative electrode active material capable of being alloyed with lithium is preferable, the above-described silicon material or a silicon-containing alloy (an alloy including silicon element) is more preferable, and a negative electrode active material including silicon (Si) or a silicon-containing alloy is still more preferable.

The chemical formulae of the compounds obtained using the baking method can be calculated using an inductively coupled plasma (ICP) emission spectroscopic analysis method as a measuring method from the mass difference of powder before and after baking as a convenient method.

The shape of the negative electrode active material is not particularly limited; however, it is preferably a particle shape. The volume average particle diameter of the negative electrode active material is not particularly limited; however, it is preferably 0.1 to 60 μm. The volume average particle diameter of the negative electrode active material particles can be measured using the same method as that of the average particle diameter of the inorganic solid electrolyte. In order to allow the negative electrode active material to have a predetermined particle diameter, a general pulverizer or classifier may be used as in the positive electrode active material.

As the negative electrode active material, one kind may be used alone, or two or more kinds may be used in combination.

In a case of forming a negative electrode active material layer, the mass (mg) (mass per unit area) of the negative electrode active material per unit area (cm²) in the negative electrode active material layer is not particularly limited. It can be appropriately determined according to the designed battery capacity and can be set to, for example, 1 to 100 mg/cm².

The content of the negative electrode active material in the inorganic solid electrolyte-containing composition is not particularly limited, and it is preferably 10% to 90% by mass, more preferably 20% to 85% by mass, still more preferably 30% to 80% by mass, and even still more preferably 40% by mass to 75% by mass, in the solid content of 100% by mass.

In the present invention, in a case where a negative electrode active material layer is formed by charging a secondary battery, ions of a metal belonging to Group 1 or Group 2 in the periodic table produced in the all-solid state secondary battery can be used instead of the negative electrode active material. By binding the ions to electrons and precipitating a metal, a negative electrode active material layer can be formed.

(Coating of Active Material)

The surfaces of the positive electrode active material and the negative electrode active material may be coated with a separate metal oxide. Examples of the surface coating agent include metal oxides and the like containing Ti, Nb, Ta, W, Zr, Al, Si, or Li. Specific examples thereof include titanium oxide spinel, tantalum-based oxides, niobium-based oxides, and lithium niobate-based compounds, and specific examples thereof include Li₄Ti₅O₁₂, Li₂Ti₂O₅, LiTaO₃, LiNbO₃, LiAlO₂, Li₂ZrO₃, Li₂WO₄, Li₂TiO₃, Li₂B₄O₇, Li₃PO₄, Li₂MoO₄, Li₃BO₃, LiBO₂, Li₂CO₃, Li₂SiO₃, SiO₂, TiO₂, ZrO₂, Al₂O₃, and B₂O₃.

In addition, a surface treatment may be carried out on the surfaces of electrodes including the positive electrode active material or the negative electrode active material using sulfur, phosphorous, or the like.

Furthermore, the particle surfaces of the positive electrode active material or the negative electrode active material may be treated with an actinic ray or an active gas (plasma or the like) before and after the coating of the surfaces.

<Conductive Auxiliary Agent>

The inorganic solid electrolyte-containing composition according to the embodiment of the present invention preferably contains a conductive auxiliary agent, and for example, it is preferable that the silicon atom-containing active material as the negative electrode active material is used in combination with a conductive auxiliary agent.

The conductive auxiliary agent is not particularly limited, and conductive auxiliary agents that are known as ordinary conductive auxiliary agents can be used. The conductive auxiliary agent may be, for example, graphite such as natural graphite or artificial graphite, carbon black such as acetylene black, Ketjen black, or furnace black, amorphous carbon such as needle cokes, a carbon fiber such as a vapor-grown carbon fiber or a carbon nanotube, or a carbonaceous material such as graphene or fullerene which are electron-conductive materials and also may be a metal powder or a metal fiber of copper, nickel, or the like, and a conductive polymer such as polyaniline, polypyrrole, polythiophene, polyacetylene, or a polyphenylene derivative may also be used.

In the present invention, in a case where the active material is used in combination with the conductive auxiliary agent, among the above-described conductive auxiliary agents, a conductive auxiliary agent that does not intercalate and deintercalate ions (preferably Li ions) of a metal belonging to Group 1 or Group 2 in the periodic table and does not function as an active material at the time of charging and discharging of the battery is classified as the conductive auxiliary agent. Therefore, among the conductive auxiliary agents, a conductive auxiliary agent that can function as the active material in the active material layer at the time of charging and discharging of the battery is classified as an active material but not as a conductive auxiliary agent. Whether or not the conductive auxiliary agent functions as the active material during charging and discharging of the battery is not uniquely determined but is determined based on a combination of the conductive auxiliary agent with the active material.

One kind of conductive auxiliary agent may be contained, or two or more kinds thereof may be contained.

The shape of the conductive auxiliary agent is not particularly limited; however, it is preferably a particle shape.

In a case where the inorganic solid electrolyte-containing composition according to the embodiment of the present invention contains a conductive auxiliary agent, the content of the conductive auxiliary agent in the inorganic solid electrolyte-containing composition is preferably 0% to 10% by mass in the solid content of 100% by mass.

<Lithium Salt>

The inorganic solid electrolyte-containing composition according to the embodiment of the present invention preferably contains a lithium salt (a supporting electrolyte) as well.

Generally, the lithium salt is preferably a lithium salt that is used for this kind of product and is not particularly limited. For example, lithium salts described in paragraphs 0082 to 0085 of JP2015-088486A are preferable.

In a case where the inorganic solid electrolyte-containing composition according to the embodiment of the present invention contains a lithium salt, the content of the lithium salt is preferably 0.1 part by mass or more and more preferably 5 parts by mass or more with respect to 100 parts by mass of the solid electrolyte. The upper limit thereof is preferably 50 parts by mass or less and more preferably 20 parts by mass or less.

<Dispersing Agent>

Since the above-described polymer binder functions as a dispersing agent as well, the inorganic solid electrolyte-containing composition according to the embodiment of the present invention may not contain a dispersing agent other than this polymer binder; however, it may contain a dispersing agent. As the dispersing agent, a dispersing agent that is generally used for an all-solid state secondary battery can be appropriately selected and used. Generally, a compound intended for particle adsorption and steric repulsion and/or electrostatic repulsion is suitably used.

<Other Additives>

As components other than the respective components described above, the inorganic solid electrolyte-containing composition according to the embodiment of the present invention may appropriately contain an ionic liquid, a viscosity improver, a crosslinking agent (an agent causing a crosslinking reaction by radical polymerization, condensation polymerization, or ring-opening polymerization), a polymerization initiator (an agent that generates an acid or a radical by heat or light), an antifoaming agent, a leveling agent, a dehydrating agent, or an antioxidant. The ionic liquid is contained in order to further improve the ion conductivity, and the known one in the related art can be used without particular limitation. In addition, a polymer other than the polymer that forms the above-described polymer binder, a typically used binder, or the like may be contained.

(Preparation of Inorganic Solid Electrolyte-Containing Composition)

For the inorganic solid electrolyte-containing composition according to the embodiment of the present invention, an inorganic solid electrolyte, a polymer binder, a metal element-containing compound, a dispersion medium, as well as a conductive auxiliary agent, a lithium salt as appropriate, and any other component are mixed by using, for example, various mixers that are generally usually used. As a result, the mixture is prepared as a mixture, preferably as a slurry, in which the polymer binder is dissolved in the dispersion medium and the metal element-containing compound is not dissolved and is present in a solid state. In a case of a composition for an electrode, an active material is further mixed. In preparing the composition, the polymer binder, the metal element-containing compound, and the dispersion medium are appropriately selected in a combination that gives the above-described dissolved state and dispersed state in the dispersion medium.

A mixing method is not particularly limited, and the components may be mixed at once or sequentially. A mixing environment is not particularly limited, and examples thereof include a dry air environment and an inert gas environment.

Particularly, in a case where the above-described content is satisfied, the polymer binder hardly reacts interactively with the metal element-containing compound in the inorganic solid electrolyte-containing composition according to the embodiment of the present invention at room temperature, and the proportion thereof is small enough to maintain the dispersion stability of the composition, for example, even in a case where the above-described salt exchange reaction is allowed to occur. In the present invention, the film forming conditions described later are preferably applied in order to cause an interaction sufficient for solidifying the polymer binder to occur.

<Characteristics or Physical Properties of Inorganic Solid Electrolyte-Containing Composition>

The inorganic solid electrolyte-containing composition according to the embodiment of the present invention is preferably a non-aqueous composition. In the present invention, the non-aqueous composition includes not only an aspect including no moisture but also an aspect where the moisture content (also referred to as the “water content”) is preferably 500 ppm or less. In the non-aqueous composition, the moisture content is more preferably 200 ppm or less, still more preferably 100 ppm or less, and particularly preferably 50 ppm or less. In a case where the inorganic solid electrolyte-containing composition is a non-aqueous composition, it is possible to suppress the deterioration of the inorganic solid electrolyte. The water content refers to the water amount (the mass proportion to the inorganic solid electrolyte-containing composition) in the inorganic solid electrolyte-containing composition, and specifically, it is a value determined by filtration through a 0.02 μm membrane filter and then by Karl Fischer titration.

In the inorganic solid electrolyte-containing composition according to the embodiment of the present invention, the viscosity (the initial viscosity) after preparation is not particularly limited; however, for example, the viscosity under the following measurement conditions is preferably 1,000 cP to 4,000 cP, more preferably 300 cP to 4,000 cP, and still more preferably 500 cP to 2,500 cP in consideration of coatability and the like. Since the inorganic solid electrolyte-containing composition according to the embodiment of the present invention exhibits excellent dispersion characteristics as described above, the above initial viscosity can be maintained temporally.

Measurement Conditions—

Temperature: 23° C.

Shear rate: 10/s

Measuring equipment: TV-35 type viscometer (manufactured by TOKI SANGYO Co., Ltd.)

Measuring method: 1.1 ml of the composition is dropwise added to a sample cup, the sample cup is set on a main body of the viscometer equipped with a standard cone rotor (1° 34′×R24), the measurement range is set to “U”, rotation is carried out at the above-described shear rate, and then the value after 1 minute is read.

In a case where the inorganic solid electrolyte-containing composition according to the embodiment of the present invention is heated to 80° C. or higher, it is preferable that the solubility of the polymer binder in the dispersion medium after heating is lower than the solubility of the polymer binder in the dispersion medium before heating. In a case where the solubility of the polymer binder becomes lower by heating, the polymer binder can be solidified as particles from the dispersion medium at the time of forming (drying) a film of the inorganic solid electrolyte-containing composition, and thus it is possible to suppress the increase in resistance and realize excellent cycle characteristics while maintaining excellent dispersion characteristics.

The above-described characteristics (the decrease in solubility due to heating) of the inorganic solid electrolyte-containing composition can be evaluated and confirmed in a case of being the inorganic solid electrolyte-containing composition according to the embodiment of the present invention; however, as shown in Example 2 described later, it can be evaluated and confirmed more clearly in a case where the content of the polymer binder in the composition is set to 10% by mass and the content of the metal element-containing compound in the composition is set to 0.5% by mass.

In a case where the heating temperature is 80° C. or higher, the above-described characteristics can be evaluated and confirmed more clearly, and the heating temperature can be set to, for example, 80° C. to 120° C. It is noted that conditions other than the heating temperature as well as the content are appropriately determined, and for example, the heating time can be set to 10 minutes or more.

In the inorganic solid electrolyte-containing composition according to the embodiment of the present invention, it is preferable that in a case where the total concentration of the polymer binder and the metal element-containing compound in the inorganic solid electrolyte-containing composition is concentrated to 30% by mass or more, the solubility of the polymer binder in the dispersion medium after concentration is lower than the solubility of the polymer binder in the dispersion medium before concentration. In a case where the solubility of the polymer binder becomes lower by concentration, the polymer binder can be solidified as particles from the dispersion medium at the time of forming (drying) a film of the inorganic solid electrolyte-containing composition, and thus it is possible to suppress the increase in resistance and realize excellent cycle characteristics while maintaining excellent dispersion characteristics.

The above-described characteristics (the decrease in solubility due to concentration) of the inorganic solid electrolyte-containing composition can be evaluated and confirmed in a case of being the inorganic solid electrolyte-containing composition according to the embodiment of the present invention; however, as shown in Example 2 described later, it can be evaluated and confirmed more clearly in a case where the content of the polymer binder in the composition is set to 10% by mass and the content of the metal element-containing compound in the composition is set to 0.5% by mass.

In a case where the total concentration to be concentrated is 30% by mass or more, the above-described characteristics can be evaluated and confirmed more clearly, and the total concentration can be set to, for example, 50% by mass or more. The heating temperature at the time of concentration may be appropriately set and may be 80° C. or higher. However, it is preferably less than 80° C., at which a decrease in solubility due to heating hardly occurs, and it can be set to, for example, 30° C. to 60° C. It is noted that conditions other than the total content and the heating temperature are appropriately determined.

In a case where a film of the inorganic solid electrolyte-containing composition according to the embodiment of the present invention is formed to form a constitutional layer, it is preferable that the solubility of the polymer binder present in the constitutional layer in the dispersion medium contained in the inorganic solid electrolyte-containing composition, is lower than the solubility of the polymer binder contained in the inorganic solid electrolyte-containing composition in the dispersion medium. In a case where the solubility of the polymer binder can be lowered by carrying out a film forming step, the polymer binder can be solidified from the dispersion medium to form particles of the polymer binder in the constitutional layer, an increase in resistance can be suppressed, and thus excellent cycle characteristics can be realized.

The above-described characteristics (the decrease in solubility due to film formation) of the inorganic solid electrolyte-containing composition can be evaluated and confirmed in a case of being the inorganic solid electrolyte-containing composition according to the embodiment of the present invention; however, it can be evaluated and confirmed more clearly in a case where the content of the polymer binder in the composition is set to 10% by mass and the content of the metal element-containing compound in the composition is set to 0.5% by mass.

The film forming conditions are not particularly limited, and the drying conditions described later can be appropriately selected.

In the characteristics of the solubility reduction due to the heating, concentration, or film formation described above, it suffices that the solubility of the polymer binder can be lowered to a solubility at which the polymer binder can be solidified from the dispersion medium and precipitated, and it is preferable that the difference in solubility is 20% by mass or more. It is conceived that such a decrease in solubility is due to the interaction between the polymer binder in the dissolved state and the metal element-containing compound.

[Sheet for an all-Solid State Secondary Battery]

A sheet for an all-solid state secondary battery according to the aspect of the present invention is a sheet-shaped molded body with which a constitutional layer of an all-solid state secondary battery can be formed, and it includes various aspects depending on uses thereof. Examples of thereof include a sheet that is preferably used in a solid electrolyte layer (also referred to as a solid electrolyte sheet for an all-solid state secondary battery), and a sheet that is preferably used in an electrode or a laminate of an electrode and a solid electrolyte layer (an electrode sheet for an all-solid state secondary battery). In the present invention, the variety of sheets described above will be collectively referred to as a sheet for an all-solid state secondary battery.

It suffices that the solid electrolyte sheet for an all-solid state secondary battery according to the embodiment of the present invention is a sheet having a solid electrolyte layer, and it may be a sheet in which a solid electrolyte layer is formed on a substrate or may be a sheet that is formed of a solid electrolyte layer without including a substrate. The solid electrolyte sheet for an all-solid state secondary battery may include another layer in addition to the solid electrolyte layer. Examples of the other layer include a protective layer (a peeling sheet), a collector, and a coating layer.

Examples of the solid electrolyte sheet for an all-solid state secondary battery according to the embodiment of the present invention include a sheet including a layer composed of the inorganic solid electrolyte-containing composition according to the embodiment of the present invention, a typical solid electrolyte layer, and a protective layer on a substrate in this order. The layer thickness of each layer that constitutes the solid electrolyte sheet for an all-solid state secondary battery is the same as the layer thickness of each layer described later in the all-solid state secondary battery.

The solid electrolyte layer included in the solid electrolyte sheet for an all-solid state secondary battery is formed of the inorganic solid electrolyte-containing composition according to the embodiment of the present invention.

In the process of forming a film of the inorganic solid electrolyte-containing composition according to the embodiment of the present invention, the polymer binder in the dissolved state interacts with the metal element-containing compound and is solidified into a particle shape while maintaining the adsorption to the solid particles. As a result, the solid electrolyte layer composed of this inorganic solid electrolyte-containing composition contains particles (a particle-shaped solidified material) derived from the polymer binder. The average particle diameter of the particles derived from the polymer binder, in the solid electrolyte layer, is not particularly limited and it can be set to 5 to 1,600 nm. However, it is preferably 8 to 1,200 nm, more preferably 10 to 800 nm, and still more preferably 30 to 600 nm, in terms of improving the dispersion characteristics and the battery characteristics. Here, the average particle diameter is a value measured by a method described in Examples described later.

The average particle diameter of these particles can be adjusted by, for example, the characteristics of the polymer binder (the kind, the composition, the molecular weight, and the like), the kind of metal element-containing compound (the kind of anion or metal element), the contents of the polymer binder and the metal element-containing compound, the kind of dispersion medium, as well as the film forming conditions.

The presence state of the metal element-containing compound in the solid electrolyte layer is not particularly limited. However, the metal element-containing compound that has supplied a metal element may be present as an anion or as a conjugate acid in which an anion and a hydrogen atom are bonded by a salt exchange reaction or the like.

The polymer binder (the particle-shaped solidified material) present in the solid electrolyte layer is a polymer binder that is generated by being solidified from the dissolved state by the above-described interaction. As a result, the solubility of the polymer binder present in the solid electrolyte layer in the dispersion medium contained in the used inorganic solid electrolyte-containing composition, is lower than the solubility of the polymer binder (before interaction) contained in the inorganic solid electrolyte-containing composition in the dispersion medium. The decrease in the solubility of the polymer binder before and after the interaction with the metal element-containing compound can be confirmed by the measuring method in Examples described later.

The contents of the respective components in the solid electrolyte layer are not particularly limited; however, the contents are preferably the same as the contents of the respective components with respect to the solid content of the inorganic solid electrolyte-containing composition according to the embodiment of the present invention.

The substrate is not particularly limited as long as it can support the solid electrolyte layer, and examples thereof include a sheet body (plate-shaped body) formed of materials described below regarding the collector, an organic material, an inorganic material, or the like. Examples of the organic materials include various polymers, and specific examples thereof include polyethylene terephthalate, polypropylene, polyethylene, and cellulose. Examples of the inorganic materials include glass and ceramic.

It suffices that an electrode sheet for an all-solid state secondary battery according to the embodiment of the present invention (simply also referred to as an “electrode sheet”) is an electrode sheet including an active material layer, and it may be a sheet in which an active material layer is formed on a substrate (collector) or may be a sheet that is formed of an active material layer without including a substrate. The electrode sheet is typically a sheet including the current collector and the active material layer, and examples of an aspect thereof include an aspect including the current collector, the active material layer, and the solid electrolyte layer in this order and an aspect including the current collector, the active material layer, the solid electrolyte layer, and the active material layer in this order.

At least one of the solid electrolyte layer or the active material layer, which is included in the electrode sheet, is formed of the inorganic solid electrolyte-containing composition according to the embodiment of the present invention. In the solid electrolyte layer and the active material layer, which is formed of the inorganic solid electrolyte-containing composition according to the embodiment of the present invention, the presence state of the polymer binder and the metal element-containing compound is the same as the presence state in the solid electrolyte layer included in the above-described solid electrolyte sheet for an all-solid state secondary battery. In addition, the contents of the respective components in this solid electrolyte layer or active material layer are not particularly limited; however, the contents are preferably the same as the contents of the respective components with respect to the solid content of the inorganic solid electrolyte-containing composition (the composition for an electrode) according to the embodiment of the present invention. The layer thickness of each of the layers that form the electrode sheet according to the embodiment of the present invention is the same as the layer thickness of each of the layers described below regarding the all-solid state secondary battery. The electrode sheet according to the embodiment of the present invention may include the above-described other layers.

It is noted that in a case where the solid electrolyte layer or the active material layer is not formed of the inorganic solid electrolyte-containing composition according to the embodiment of the present invention, it is formed of a general constitutional layer forming material.

The sheet for an all-solid state secondary battery sheet according to the embodiment of the present invention has a constitutional layer having low resistance the surface of which is flat, in which at least one layer of the solid electrolyte layer or the active material layer is formed of the inorganic solid electrolyte-containing composition according to the embodiment of the present invention. As a result, in a case where the sheet for an all-solid state secondary battery according to the embodiment of the present invention is used as a constitutional layer of the all-solid state secondary battery, it is possible to realize the lower resistance (the high conductivity) of the all-solid state secondary battery and excellent cycle characteristics. In particular, in the electrode sheet for an all-solid state secondary battery and the all-solid state secondary battery, in which the active material layer is formed of the inorganic solid electrolyte-containing composition according to the embodiment of the present invention, the active material layer and the collector exhibit strong adhesiveness, and thus it is possible to realize further improvement of the cycle characteristics. As a result, the sheet for an all-solid state secondary battery according to the embodiment of the present invention is suitably used as a sheet with which a constitutional layer of an all-solid state secondary battery can be formed.

[Manufacturing Method for Sheet for all-Solid State Secondary Battery]

The manufacturing method for a sheet for an all-solid state secondary battery according to the embodiment of the present invention is not particularly limited, and the sheet can be manufactured by forming each of the above layers using the inorganic solid electrolyte-containing composition according to the embodiment of the present invention. Examples thereof include a method in which the film formation (the coating and drying) is carried out preferably on a substrate or a collector (the other layer may be interposed) to form a layer (a coated and dried layer) consisting of an inorganic solid electrolyte-containing composition. As a result, the sheet for an all-solid state secondary battery including the substrate or the collector and the coated and dried layer can be produced. Here, the coated and dried layer refers to a layer formed by carrying out coating with the inorganic solid electrolyte-containing composition according to the embodiment of the present invention and drying the dispersion medium (that is, a layer formed using the inorganic solid electrolyte-containing composition according to the embodiment of the present invention and consisting of a composition obtained by removing the dispersion medium from the inorganic solid electrolyte-containing composition according to the embodiment of the present invention). In the active material layer and the coated and dried layer, the dispersion medium may remain within a range where the effects of the present invention are not impaired, where the residual amount thereof in each of the layers may be, for example, 3% mass or less. As described above, this coated and dried layer contains particles derived from the polymer binder.

Each of steps of coating, drying, or the like in the method of manufacturing a sheet for an all-solid state secondary battery according to the embodiment of the present invention will be described below regarding the manufacturing method for an all-solid state secondary battery.

In the above-described preferred method, in a case where a film of the inorganic solid electrolyte-containing composition according to the embodiment of the present invention is formed on a collector to produce a sheet for an all-solid state secondary battery, it is possible to strengthen the adhesion between the collector and the active material layer.

In the manufacturing method for a sheet for an all-solid state secondary battery according to the embodiment of the present invention, it is also possible to pressurize the coated and dried layer. The pressurizing condition and the like will be described later in the manufacturing method for an all-solid state secondary battery.

The obtained coated and dried layer is appropriately subjected to pressurization treatment or the like to become a solid electrolyte layer or an active material layer.

In addition, in the manufacturing method for a sheet for an all-solid state secondary battery according to the embodiment of the present invention, it is also possible to peel the substrate, the protective layer (particularly, the peeling sheet), or the like.

[All-Solid State Secondary Battery]

The all-solid state secondary battery according to the embodiment of the present invention includes a positive electrode active material layer, a negative electrode active material layer facing the positive electrode active material layer, and a solid electrolyte layer disposed between the positive electrode active material layer and the negative electrode active material layer. The positive electrode active material layer is preferably formed on a positive electrode collector to configure a positive electrode. The negative electrode active material layer is preferably formed on a negative electrode collector to configure a negative electrode.

At least one layer of the negative electrode active material layer, the positive electrode active material layer, or the solid electrolyte layer is formed of the inorganic solid electrolyte-containing composition according to the embodiment of the present invention, and at least one of the solid electrolyte layer, the negative electrode active material layer, or the positive electrode active material layer is preferably formed of the inorganic solid electrolyte-containing composition according to the embodiment of the present invention.

An aspect in which all of the layers are formed of the inorganic solid electrolyte-containing composition according to the aspect of the present invention is also one of the preferred aspects. In the present invention, forming the constitutional layer of the all-solid state secondary battery with the inorganic solid electrolyte-containing composition according to the embodiment of the present invention includes an aspect in which the constitutional layer is formed of the sheet for an all-solid state secondary battery of the present invention (however, in a case where a layer other than the layer formed of the inorganic solid electrolyte-containing composition according to the embodiment of the present invention is provided, a sheet from which this layer is removed). In the active material layer or the solid electrolyte layer formed of the inorganic solid electrolyte-containing composition according to the embodiment of the present invention, the kinds of components to be contained and the contents thereof are preferably the same as the solid content of the inorganic solid electrolyte-containing composition according to the embodiment of the present invention. In a case where the active material layer or the solid electrolyte layer is not formed of the inorganic solid electrolyte-containing composition according to the embodiment of the present invention, a known material in the related art can be used.

The thickness of each of the negative electrode active material layer, the solid electrolyte layer, and the positive electrode active material layer is not particularly limited. In case of taking a dimension of an ordinary all-solid state secondary battery into account, the thickness of each of the layers is preferably 10 to 1,000 μm and more preferably 20 μm or more and less than 500 μm. In the all-solid state secondary battery according to the embodiment of the present invention, the thickness of at least one layer of the positive electrode active material layer or the negative electrode active material layer is still more preferably 50 μm or more and less than 500 μm.

Each of the positive electrode active material layer and the negative electrode active material layer may include the collector opposite to the solid electrolyte layer.

<Housing>

Depending on the use application, the all-solid state secondary battery according to the embodiment of the present invention may be used as the all-solid state secondary battery having the above-described structure as it is but is preferably sealed in an appropriate housing to be used in the form of a dry cell. The housing may be a metallic housing or a resin (plastic) housing. In a case where a metallic housing is used, examples thereof include an aluminum alloy housing and a stainless steel housing. It is preferable that the metallic housing is classified into a positive electrode-side housing and a negative electrode-side housing and that the positive electrode-side housing and the negative electrode-side housing are electrically connected to the positive electrode collector and the negative electrode collector, respectively. The housing on the positive electrode side and the housing on the negative electrode side are preferably integrated by being joined together by sandwiching a gasket for short circuit prevention therebetween.

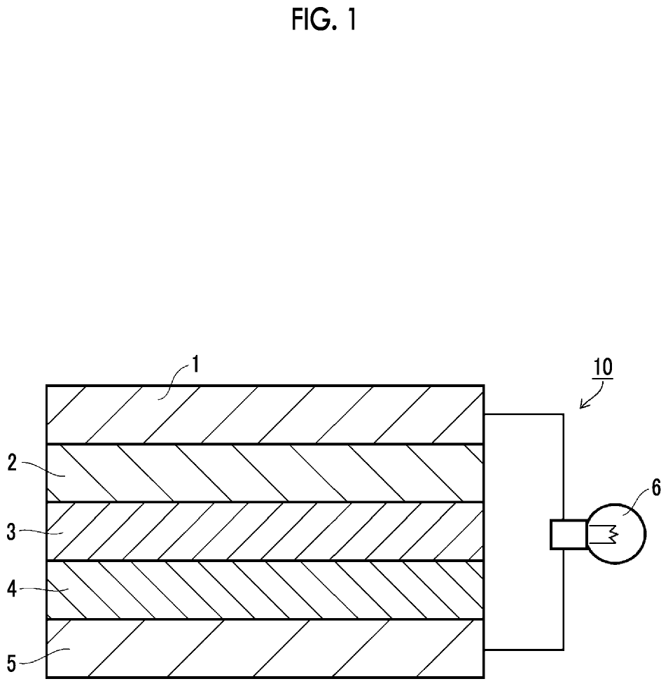

Hereinafter, an all-solid state secondary battery according to a preferred embodiment of the present invention will be described with reference to FIG. 1, but the present invention is not limited thereto.

FIG. 1 is a cross-sectional view schematically illustrating the all-solid state secondary battery (lithium ion secondary battery) according to the preferred embodiment of the present invention. In the case of being seen from the negative electrode side, an all-solid state secondary battery 10 of the present embodiment includes a negative electrode collector 1, a negative electrode active material layer 2, a solid electrolyte layer 3, a positive electrode active material layer 4, and a positive electrode collector 5 in this order. The respective layers are in contact with each other, and thus structures thereof are adjacent. In a case in which the above-described structure is employed, during charging, electrons (e⁻) are supplied to the negative electrode side, and lithium ions (Li⁺) are accumulated on the negative electrode side. On the other hand, during discharging, the lithium ions (Li⁺) accumulated on the negative electrode side return to the positive electrode, and electrons are supplied to an operation portion 6. In an example shown in the drawing, an electric bulb is adopted as a model of the operation portion 6 and is lit by discharging.

In a case where the all-solid state secondary battery having a layer constitution illustrated in FIG. 1 is put into a 2032-type coin case, the all-solid state secondary battery will be referred to as “laminate for an all-solid state secondary battery”, and a battery prepared by putting this laminate for an all-solid state secondary battery into a 2032-type coin case will be referred to as “all-solid state secondary battery”, thereby referring to both batteries distinctively in some cases.

(Positive Electrode Active Material Layer, Solid Electrolyte Layer, and Negative Electrode Active Material Layer)

In the all-solid state secondary battery 10, all of the positive electrode active material layer, the solid electrolyte layer, and the negative electrode active material layer are formed of the inorganic solid electrolyte-containing composition of the embodiment of the present invention. This all-solid state secondary battery 10 exhibits excellent battery performance. The presence state of the polymer binder and the metal element-containing compound in the positive electrode active material layer 4, the solid electrolyte layer 3, and the negative electrode active material layer 2 is the same as the presence state in the solid electrolyte layer included in the above-described solid electrolyte sheet for an all-solid state secondary battery. The kinds of the inorganic solid electrolyte and the polymer binder which are contained in the positive electrode active material layer 4, the solid electrolyte layer 3, and the negative electrode active material layer 2 may be identical to or different from each other.

In the present invention, any one of the positive electrode active material layer and the negative electrode active material layer, or collectively both of them may be simply referred to as an active material layer or an electrode active material layer. In addition, either or both of the positive electrode active material and the negative electrode active material will also be simply referred to as “active material” or “electrode active material”.

In the present invention, in a case where the constitutional layer is formed of the inorganic solid electrolyte-containing composition according to the embodiment of the present invention, it is possible to realize an all-solid state secondary battery exhibiting low resistance and excellent cycle characteristics.

In the all-solid state secondary battery 10, the negative electrode active material layer can be formed as a lithium metal layer. Examples of the lithium metal layer include a layer formed by depositing or molding a lithium metal powder, a lithium foil, and a lithium vapor deposition film. The thickness of the lithium metal layer is not limited to the above-described thickness of the above-described negative electrode active material layer and may be, for example, 1 to 500 μm.

The positive electrode collector 5 and the negative electrode collector 1 are preferably an electron conductor.

In the present invention, either the positive electrode collector or the negative electrode collector or both of them may be simply referred to as the collector.

As a material that forms the positive electrode collector, not only aluminum, an aluminum alloy, stainless steel, nickel, or titanium but also a material (a material on which a thin film is formed) obtained by treating the surface of aluminum or stainless steel with carbon, nickel, titanium, or silver is preferable. Among these, aluminum or an aluminum alloy is more preferable.

As a material for forming the negative electrode collector, not only aluminum, copper, a copper alloy, stainless steel, nickel, or titanium but also a material obtained by treating the surface of aluminum, copper, a copper alloy, or stainless steel with carbon, nickel, titanium, or silver is preferable, and aluminum, copper, a copper alloy, or stainless steel is more preferable.

Regarding the shape of the collector, typically, collectors having a film sheet-like shape are used, but it is also possible to use net-shaped collectors, punched collectors, compacts of lath bodies, porous bodies, foaming bodies, or molded bodies of fibers, and the like.

The thickness of the collector is not particularly limited; however, it is preferably 1 to 500 μm. In addition, it is also preferable that the surface of the collector is made to be uneven through a surface treatment.

In the all-solid state secondary battery 10, a layer formed of a known constitutional layer forming material can be applied to the positive electrode active material layer.

In the present invention, a functional layer, a functional member, or the like may be appropriately interposed or disposed between respective layers of the negative electrode collector, the negative electrode active material layer, the solid electrolyte layer, the positive electrode active material layer, and the positive electrode collector or on the outside thereof. In addition, each of the layers may have a single-layer structure or a multi-layer structure.

[Manufacturing of all-Solid State Secondary Battery]

The all-solid state secondary battery can be manufactured by a conventional method. Specifically, the all-solid state secondary battery can be manufactured by forming each of the layers described above using the inorganic solid electrolyte-containing composition of the embodiment of the present invention or the like. Hereinafter, the details will be described in detail.

The all-solid state secondary battery according to the embodiment of the present invention can be manufactured by carrying out a method (a manufacturing method for a sheet for an all-solid state secondary battery according to the embodiment of the present invention) which includes (is carried out through) a step of coating and drying an appropriate substrate (for example, a metal foil which serves as a collector) with the inorganic solid electrolyte-containing composition according to the embodiment of the present invention to form a coating film (form a film).

For example, a film of an inorganic solid electrolyte-containing composition which contains a positive electrode active material and serves as a material for a positive electrode (a composition for a positive electrode) is formed on a metal foil which is a positive electrode collector, to form a positive electrode active material layer, thereby producing a positive electrode sheet for an all-solid state secondary battery. Next, a film of the inorganic solid electrolyte-containing composition for forming a solid electrolyte layer is formed on the positive electrode active material layer to form the solid electrolyte layer. Furthermore, a film of the inorganic solid electrolyte-containing composition containing a negative electrode active material as a material for a negative electrode (a composition for a negative electrode) is formed on the solid electrolyte layer to form a negative electrode active material layer. A negative electrode collector (a metal foil) is overlaid on the negative electrode active material layer, whereby it is possible to obtain an all-solid state secondary battery having a structure in which the solid electrolyte layer is sandwiched between the positive electrode active material layer and the negative electrode active material layer. A desired all-solid state secondary battery can also be manufactured by enclosing the all-solid state secondary battery in a housing.

In addition, an all-solid state secondary battery can also be manufactured by forming the negative electrode active material layer, the solid electrolyte layer, and the positive electrode active material layer on the negative electrode collector by carrying out the methods of forming the respective layers in the reversed order, and then laminating the positive electrode collector thereon.

As another method, for example, the following method can be used. That is, the positive electrode sheet for an all-solid state secondary battery is produced as described above. In addition, a film of an inorganic solid electrolyte-containing composition which contains a negative electrode active material and serves as a material for a negative electrode (a composition for a negative electrode) is formed on a metal foil which is a negative electrode collector, to form a negative electrode active material layer, thereby producing a negative electrode sheet for an all-solid state secondary battery. Next, the solid electrolyte layer is formed on the active material layer in any one of the sheets as described above. Furthermore, the other one of the positive electrode sheet for an all-solid state secondary battery and the negative electrode sheet for an all-solid state secondary battery is laminated on the solid electrolyte layer such that the solid electrolyte layer and the active material layer come into contact with each other. In this manner, an all-solid state secondary battery can be manufactured.

As still another method, for example, the following method can be used. That is, the positive electrode sheet for an all-solid state secondary battery and the negative electrode sheet for an all-solid state secondary battery are prepared as described above. In addition, separately from the positive electrode sheet for an all-solid state secondary battery and the negative electrode sheet for an all-solid state secondary battery, a film of the inorganic solid electrolyte-containing composition is formed on a substrate, thereby producing a solid electrolyte sheet for an all-solid state secondary battery consisting of a solid electrolyte layer. Furthermore, the positive electrode sheet for an all-solid state secondary battery and the negative electrode sheet for an all-solid state secondary battery are laminated such that the solid electrolyte layer removed from the substrate is sandwiched therebetween. In this manner, an all-solid state secondary battery can be manufactured.

The solid electrolyte layer or the like can also be formed by, for example, forming an inorganic solid electrolyte-containing composition or the like on a substrate or an active material layer by pressure molding under pressurizing conditions described later.

In the above manufacturing method, it suffices that the inorganic solid electrolyte-containing composition according to the embodiment of the present invention is used in any one of the composition for a positive electrode, the inorganic solid electrolyte-containing composition, or the composition for a negative electrode. The inorganic solid electrolyte-containing composition according to the embodiment of the present invention is preferably used in the inorganic solid electrolyte-containing composition, and the inorganic solid electrolyte-containing composition according to the embodiment of the present invention can be used in any of the compositions.

<Formation (Film Formation) of Each Layer>

The film formation (coating and drying) of the inorganic solid electrolyte-containing composition according to the embodiment of the present invention is carried out while solidifying the polymer binder into a particle shape. The method of carrying out solidification into a particle shape is not particularly limited. However, examples thereof include a method of forming a film while reducing the solubility of the polymer binder contained in the inorganic solid electrolyte-containing composition in a dispersion medium, and a method of forming a film by heating the inorganic solid electrolyte-containing composition to 80° C. or higher.

The method for applying the inorganic solid electrolyte-containing composition is not particularly limited and can be appropriately selected. Examples thereof include coating (preferably wet-type coating), spray coating, spin coating, dip coating, slit coating, stripe coating, and bar coating.

The applied inorganic solid electrolyte-containing composition is subjected to a drying treatment (a heating treatment). In the drying treatment, the polymer binder in the dissolved state in the applied inorganic solid electrolyte-containing composition is solidified into a particle shape while maintaining the adsorption to the solid particles, whereby the solid particles can be bound to each other while suppressing an increase in interface resistance. Coupled with the excellent dispersion characteristics of the inorganic solid electrolyte-containing composition, such solidification of the polymer binder makes it possible to bind solid particles while suppressing the variation in contact state and the increase in interface resistance, and furthermore makes it possible to form a coated and dried layer having a flat surface.

In the drying treatment, in a case where the inorganic solid electrolyte-containing composition according to the embodiment of the present invention is heated, it is conceived that the dispersion medium volatilizes as the temperature rises, the solid content concentration gradually rises (becomes concentrated), and the exhibition of the interaction (for example, a salt exchange reaction) between the polymer binder and the metal element-containing compound is promoted, whereby the solubility of the polymer binder in the dispersion medium gradually decreases. In this way, the polymer binder is solidified into a particle shape.

The drying treatment may be carried out each time after the inorganic solid electrolyte-containing composition is applied or may be carried out after it is subjected to multilayer application.

The drying conditions are not particularly limited as long as the above-described interaction is exhibited; however, the conditions under which the solubility of the polymer binder in the dispersion medium can be reduced are suitably selected. Examples thereof include those in the drying method and a drying temperature.

The drying method is not particularly limited, and a general drying method under atmospheric pressure or in a reduced pressure environment, such as static drying (air drying), blast drying, or heating drying, can be applied. The inorganic solid electrolyte-containing composition according to the embodiment of the present invention exhibits excellent dispersion characteristics. Further, in the above-described drying treatment, the total concentration of the polymer binder and the metal element-containing compound in the applied inorganic solid electrolyte-containing composition becomes inevitably 30% by mass or more, and thus the solubility of the polymer binder is reduced. This makes it possible to apply air drying as a drying method for the inorganic solid electrolyte-containing composition according to the embodiment of the present invention. However, in the present invention, a drying method or drying conditions for actively removing the dispersion medium are preferable, and heating drying is more preferable in order to rapidly exhibit the above-described interaction. The conditions in each drying method are appropriately determined in consideration of the amount of decrease in the solubility of the polymer binder, preferably the amount of volatilization of the dispersion medium (the increase in the concentration of the polymer binder and the metal element-containing compound). In the present invention, it is preferable to set the drying temperature of the applied inorganic solid electrolyte-containing composition. The drying temperature is not unique according to the drying method, and it is, for example, preferably 30° C. or higher, more preferably 60° C. or higher, and still more preferably 80° C. or higher. The upper limit thereof is not particularly limited; however, it is preferably 300° C. or lower, more preferably 250° C. or lower, and still more preferably 200° C. or lower, for example, in that the damage to each member of the all-solid state secondary battery can be prevented.

The all-solid state secondary battery having the constitutional layer produced in this way can exhibit excellent overall performance and can realize good binding property and good ion conductivity even without pressurization.

After applying the inorganic solid electrolyte-containing composition, it is preferable to pressurize each layer or the all-solid state secondary battery after superimposing the constitutional layers or producing the all-solid state secondary battery. In addition, each of the layers is also preferably pressurized together in a state of being laminated. Examples of the pressurizing method include a method using a hydraulic cylinder pressing machine. The pressurizing force is not particularly limited; however, it is generally preferably in a range of 5 to 1,500 MPa.

In addition, the applied inorganic solid electrolyte-containing composition may be heated at the same time as the pressurization. The heating temperature is not particularly limited but is generally in a range of 30° C. to 300° C. The pressing can also be applied at a temperature higher than the glass transition temperature of the inorganic solid electrolyte. It is also possible to carry out press at a temperature higher than the glass transition temperature of the polymer contained in the polymer binder. However, in general, the temperature does not exceed the melting point of this polymer.

The pressurization may be carried out in a state in which the coating solvent or dispersion medium has been dried in advance or in a state in which the solvent or the dispersion medium remains.

The respective compositions may be applied at the same time, and the application, the drying, and the pressing may be carried out simultaneously and/or sequentially. The respective compositions may be applied to separate substrates and then laminated by transfer.

The atmosphere during the pressurization is not particularly limited and may be any one of in the atmosphere, under the dried air (the dew point: −20° C. or lower), in an inert gas (for example, in an argon gas, in a helium gas, or in a nitrogen gas), or the like.

The pressurization time may be a short time (for example, within several hours) under the application of a high pressure or a long time (one day or longer) under the application of an intermediate pressure. In case of members other than the sheet for an all-solid state secondary battery, for example, the all-solid state secondary battery, it is also possible to use a restraining device (screw fastening pressure or the like) of the all-solid state secondary battery in order to continuously apply an intermediate pressure.

The pressing pressure may be a pressure that is constant or varies with respect to a portion under pressure such as a sheet surface.

The pressing pressure may be variable depending on the area or the film thickness of the portion under pressure. In addition, the pressure may also be variable stepwise for the same portion.

A pressing surface may be smooth or roughened.

<Initialization>

The all-solid state secondary battery manufactured as described above is preferably initialized after the manufacturing or before use. The initialization is not particularly limited, and it is possible to initialize the all-solid state secondary battery by, for example, carrying out initial charging and discharging in a state in which the pressing pressure is increased and then releasing the pressure up to a pressure at which the all-solid state secondary battery is ordinarily used.

[Use Application of all-Solid State Secondary Battery]

The all-solid state secondary battery according to the embodiment of the present invention can be applied to a variety of use applications. The application aspect thereof is not particularly limited, and in a case of being mounted in an electronic apparatus, examples thereof include a notebook computer, a pen-based input personal computer, a mobile personal computer, an e-book player, a mobile phone, a cordless phone handset, a pager, a handy terminal, a portable fax, a mobile copier, a portable printer, a headphone stereo, a video movie, a liquid crystal television, a handy cleaner, a portable CD, a mini disc, an electric shaver, a transceiver, an electronic notebook, a calculator, a memory card, a portable tape recorder, a radio, and a backup power supply. Additionally, examples of the consumer usage thereof include an automobile, an electric vehicle, a motor, a lighting instrument, a toy, a game device, a road conditioner, a watch, a strobe, a camera, and a medical device (a pacemaker, a hearing aid, a shoulder massage device, and the like). Furthermore, the all-solid state secondary battery can be used for a variety of military usages and universe usages. In addition, the all-solid state secondary battery can also be combined with a solar battery.

### EXAMPLES

Hereinafter, the present invention will be described in more detail based on Examples; however, the present invention is not limited thereto be interpreted. “Parts” and “%” that represent compositions in the following Examples are mass-based unless particularly otherwise described. In the present invention, “room temperature” refers to 25° C.

1. Preparation of Metal Element-Containing Compound

The metal element-containing compound that has been used in the preparation of the inorganic solid electrolyte-containing composition is a commercially available product, and regarding the compounds represented by symbols in Table 1, the symbols are respectively the same as those attached to the above-described exemplary compounds.

Regarding each metal element-containing compound, Table 1 shows the solubility property and dispersed state in the inorganic solid electrolyte-containing composition described later, the valence (the number of metal elements contained in the molecule), the pKa of the conjugate acid of the anion (according to the above-described measuring method), and the number of carbon atoms of the organic compound that forms the anion. In addition, Table 1 shows the results of measuring the average particle diameter of the metal element-containing compound after the preparation of the inorganic solid electrolyte-containing composition, according to the method described later.

The solubility property and dispersed state of the metal element-containing compounds in the inorganic solid electrolyte-containing compositions are classified based on the following properties.

Solubility Property—

Soluble: It indicates being present in a dissolved state, and the solubility in butyl butyrate according to the above-described measuring method is 80% by mass or more.

Solid: It indicates being present in a solid state, and the above-described solubility is 0.05% by mass or less.

Dispersibility—

In the same manner as in the preparation of each of the compositions, a dispersion liquid prepared by mixing (dispersing) a metal element-containing compound with a dispersion medium at a proportion of a solid content concentration of 10% by mass was used, and the dispersibility of the metal element-containing compounds is classified according to the reduced amount of solid content determined in the same manner as in <Evaluation 1: Dispersion stability test>.

Dispersed: It indicates being in a dispersed state, and the reduced amount of solid content is less than 5% by mass.

Non-dispersed: It indicates being in a non-dispersed state, and the reduced amount of solid content is 5% by mass or more.

TABLE 1

| | | | Average | | | |
|---|---|---|---|---|---|---|
| | | | particle | | pKa of | Number of |
| | Solubility | | diameter | | conjugate | carbon |
| Kind | property | Dispersibility | (μm) | Valence | acid | atoms |
| Aluminum stearate | Solid | Dispersed | 0.80 | 3 | 4.75 | 18 |
| Zinc stearate | Solid | Dispersed | 0.80 | 2 | 4.75 | 18 |
| Magnesium stearate | Solid | Dispersed | 0.80 | 2 | 4.75 | 18 |
| Lithium stearate | Solid | Dispersed | 0.80 | 1 | 4.75 | 18 |
| Lithium stearate | Solid | Dispersed | 8.00 | 1 | 4.75 | 18 |
| Lithium stearate | Solid | Non-dispersed | 30.00 | 1 | 4.75 | 18 |
| Lithium acetate | Solid | Dispersed | 0.80 | 1 | 4.76 | 2 |
| Lithium butyrate | Solid | Dispersed | 0.80 | 1 | 4.76 | 4 |
| Lithium hexanoate | Solid | Dispersed | 0.80 | 1 | 4.75 | 6 |
| Lithium decanoate | Solid | Dispersed | 0.80 | 1 | 5.30 | 12 |
| Lithium heneicosylate | Solid | Dispersed | 0.80 | 1 | 4.72 | 22 |
| C-11 | Solid | Dispersed | 0.80 | 1 | 35 | 3 |
| C-12 | Solid | Dispersed | 0.80 | 1 | 12 | 18 |
| C-14 | Solid | Dispersed | 0.80 | 1 | 2.12 | 12 |
| C-15 | Solid | Dispersed | 0.80 | 1 | 1.9 | 8 |
| C-16 | Solid | Dispersed | 4.0 | 1 | 1.9 | 8 |
| LiTFSI | Soluble | — | 0 | 1 | −11 | 0 |
| Stearic acid amide | Solid | Non-dispersed | 20 | — | 4.75 | 18 |

<Abbreviations in table>
C-11: The above-described exemplary compound C-11
C-12: The above-described exemplary compound C-12
C-14: The above-described exemplary compound C-14
C-15: The above-described exemplary compound C-15
C-16: The following compound C-16
LiTFSI: Lithium bis(trifluoromethanesulfonyl)imide (manufactured by Tokyo Chemical Industry Co., Ltd.)

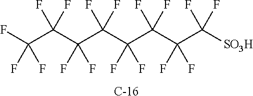

2. Polymer Synthesis and Preparation of Binder Solution or Dispersion Liquid

Polymers B-1 to B-9 shown in the following chemical formulae and Table 2 were synthesized as follows.

### Synthesis Example 1: Synthesis of Polymer B-1 and Preparation of Binder Solution B-1

To a 100 mL flask, 70 g of styrene (manufactured by FUJIFILM Wako Pure Chemical Corporation), 29.7 g of dodecyl acrylate (manufactured by Tokyo Chemical Industry Co., Ltd.), 0.3 g of maleic acid anhydride (manufactured by FUJIFILM Wako Pure Chemical Corporation), and 0.36 g of a polymerization initiator V-601 (product name, manufactured by FUJIFILM Wako Pure Chemical Corporation) were added and dissolved in 36 g of butyl butyrate to prepare a monomer solution. To a 300 mL three-necked flask, 18 g of butyl butyrate was added and stirred at 80° C., and then the above monomer solution was added dropwise thereto over 2 hours. After the completion of the dropwise addition, the solution was heated to 90° C. and stirred for 2 hours. The obtained solution was reprecipitated in methanol, and the obtained solid was dried at 80° C. and then dissolved in butyl butyrate to obtain a target polymer.

In this way, a polymer B-1 (a vinyl polymer, mass average molecular weight: 77,000) was synthesized to obtain a binder solution B-1 (concentration: 10% by mass) consisting of the polymer B-1.

### Synthesis Example 2: Preparation of Binder Dispersion Liquid B-2

Methyl methacrylate (product number: M0088, mass average molecular weight: 90,000, manufactured by Tokyo Chemical Industry Co., Ltd.) was dispersed in butyl butyrate to obtain a binder dispersion liquid B-2 consisting of a (meth)acrylic polymer B-2 (concentration: 10% by mass).

### Synthesis Example 3: Synthesis of Polymer B-3 and Preparation of Binder Solution B-3

To a 200 mL three-necked flask, 28.80 g of NISSO-PB GI1000 (product name, manufactured by NIPPON SODA Co., Ltd.), 1.92 g of polypropylene glycol (PPG400, manufactured by FUJIFILM Wako Pure Chemical Corporation), and 0.11 g of 2,2-bis(hydroxymethyl) butyrate (manufactured by Tokyo Chemical Industry Co., Ltd.) were added and dissolved in 55.5 g of butyl butyrate (manufactured by Tokyo Chemical Industry Co., Ltd.). To this solution, 6.30 g of dicyclohexylmethane-4,4′-diisocyanate (manufactured by Tokyo Chemical Industry Co., Ltd.) was added and stirred at 80° C. to be homogeneously dissolved. To the obtained solution, 100 mg of Neostan U-600 (trade name, manufactured by Nitto Kasei Co., Ltd.) was added and stirred at 80° C. for 10 hours.

In this way, a polymer B-3 (polyurethane, mass average molecular weight: 32,000) was synthesized to obtain a binder solution B-3 (concentration: 10% by mass) consisting of the polymer B-3.

### Synthesis Example 4: Synthesis of Polymer B-4 and Preparation of Binder Solution B-4

A polymer B-4 (a vinyl polymer, mass average molecular weight: 60,000) was synthesized in the same manner as in Synthesis Example 1 to obtain a binder solution B-4 (concentration: 10% by mass) consisting of a polymer B-4, except that in Synthesis Example 1, maleic acid anhydride was changed to 0.3 g of vinyl acetate and 1.0 g of phosphoric acid.

### Synthesis Example 5: Synthesis of Polymer B-5 and Preparation of Binder Solution B-5

150 parts by mass of toluene, 30 parts by mass of styrene, and 70 parts by mass of 1,3-butadiene were added to an autoclave, and 1 part by mass of a polymerization initiator V-601 (manufactured by FUJIFILM Wako Pure Chemical Corporation) were added thereto. Then, the temperature was raised to 80° C., and stirring was carried out for 3 hours. Then, the temperature was raised to 90° C., and the reaction was carried out until the addition conversion rate reached 100%. The obtained solution was reprecipitated in methanol and dried to obtain a solid, and 3 parts by mass of 2,6-di-t-butyl-p-cresol and 0.3 parts by mass of maleic acid anhydride were added with respect to 100 parts by mass of the obtained polymer, and then the reaction was carried out at 180° C. for 5 hours. The obtained solution was reprecipitated in methanol, and the obtained solid was dried at 80° C. to obtain a target polymer (a dry solid product). The mass average molecular weight of this polymer was 89,000. Then, 50 parts by mass of the polymer (the dry solid product) obtained as described above was dissolved in 50 parts by mass of cyclohexane and 150 parts by mass of tetrahydrofuran (THF). After the solution was brought to 70° C., 3 parts by mass of n-butyl lithium, 3 parts by mass of 2,6-di-t-butyl-p-cresol, 1 part by mass of bis(cyclopentadienyl)titanium dichloride, and 2 parts by mass of diethyl aluminum chloride were added thereto. The resultant mixture was reacted at a hydrogen pressure of 10 kg/cm′ for 1 hour, distilled off, dried to synthesize a polymer B-5 (a hydrocarbon-based polymer, mass average molecular weight: 89,000), and dissolved in butyl butyrate to obtain a binder solution B-5 (concentration: 10% by mass) consisting of a polymer B-5.

### Synthesis Example 6: Synthesis of Polymer B-6 and Preparation of Binder Solution B-6

150 parts by mass of toluene, 30 parts by mass of styrene, and 70 parts by mass of 1,3-butadiene were added to an autoclave, and 1 part by mass of a polymerization initiator V-601 (manufactured by FUJIFILM Wako Pure Chemical Corporation) were added thereto. Then, the temperature was raised to 80° C., and stirring was carried out for 3 hours. Then, the temperature was raised to 90° C., and the reaction was carried out until the addition conversion rate reached 100%. The obtained solution was reprecipitated in methanol and dried to obtain a solid, and 3 parts by mass of 2,6-di-t-butyl-p-cresol and 0.5 parts by mass of maleic acid anhydride were added with respect to 100 parts by mass of the obtained polymer, and then the reaction was carried out at 180° C. for 5 hours. The obtained solution was reprecipitated in acetonitrile, and the obtained solid was dried at 80° C. to obtain a polymer (a dry solid product). The mass average molecular weight of this polymer was 90,000. Then, 50 parts by mass of the polymer (the dry solid product) obtained as described above was dissolved in 50 parts by mass of cyclohexane and 150 parts by mass of tetrahydrofuran (THF). After the solution was brought to 70° C., 3 parts by mass of n-butyl lithium, 3 parts by mass of 2,6-di-t-butyl-p-cresol, 1 part by mass of bis(cyclopentadienyl)titanium dichloride, and 2 parts by mass of diethyl aluminum chloride were added thereto, the resultant mixture was reacted at a hydrogen pressure of 10 kg/cm′ for 1 hour, distilled off, and dried to obtain a hydrocarbon-based polymer precursor A (mass average molecular weight: 90,000).

Next, 450 parts by mass of xylene (manufactured by FUJIFILM Wako Pure Chemical Corporation) and 50 parts by mass of the hydrocarbon-based polymer precursor A were added and dissolved in a 1 L three-necked flask equipped with a reflux condenser and a gas introduction cock. Then, 2 parts by mass of 1H,1H,2H,2H-perfluoro-1-octanol (manufactured by FUJIFILM Wako Pure Chemical Corporation) was added thereto, the temperature was raised to 130° C., and stirring was continued for 20 hours. Then, the reaction solution was added dropwise to methanol to obtain a polymer B-6 as a precipitate. After drying under reduced pressure at 60° C. for 5 hours, the precipitate was redissolved in any solvent. In this way, a polymer B-6 (mass average molecular weight: 99,000) was synthesized to obtain a binder solution B-6 (concentration: 10% by mass) consisting of the polymer B-6 (the hydrocarbon-based polymer).

### Synthesis Example 7: Synthesis of Polymer B-7 and Preparation of Binder Solution B-7

450 parts by mass of xylene (mass by FUJIFILM Wako Pure Chemical Corporation) and 50 parts by mass of the hydrocarbon-based polymer precursor A were added and dissolved in a 1 L three-necked flask equipped with a reflux condenser and a gas introduction cock. Then, 10 parts by mass of 1H,1H,2H,2H-perfluoro-1-dodecanethiol (manufactured by Sigma-Aldrich Co., LLC) and 2 parts by mass of azobisbutyronitrile (manufactured by FUJIFILM Wako Pure Chemical Corporation) were added thereto. After introducing nitrogen gas at a flow rate of 200 mL/min for 10 minutes, the temperature was raised to 80° C., and stirring was continued for 5 hours. Then, the reaction solution was added dropwise to methanol to obtain a polymer B-7 as a precipitate. After drying under reduced pressure at 60° C. for 5 hours, the precipitate was redissolved in any solvent.

In this way, a polymer B-7 (mass average molecular weight: 99,000) was synthesized to obtain a binder solution B-7 (concentration: 10% by mass) consisting of the polymer B-7 (a hydrocarbon-based polymer).

### Synthesis Example 8: Synthesis of Polymer B-8 and Preparation of Binder Solution B-8

A polymer B-8 (mass average molecular weight: 101,000) was synthesized in the same manner as in Synthesis Example 6 to obtain a binder solution B-8 (concentration: 10% by mass) consisting of the polymer B-8 (a hydrocarbon-based polymer), except that 1H,1H,2H,2H-perfluoro-1-octanol of Synthesis Example 6 was changed to modified silicone oil having a hydroxyl group at one terminal (product name: X-22-170BX, manufactured by Shin-Etsu Chemical Co., Ltd.).

### Synthesis Example 9: Synthesis of Polymer B-9 and Preparation of Binder Solution B-9

500 parts by mass of xylene (manufactured by FUJIFILM Wako Pure Chemical Corporation), 10 parts by mass of 6-mercapto-1-hexanol (manufactured by Tokyo Chemical Industry Co., Ltd.), 330 parts by mass of lauryl acrylate (manufactured by FUJIFILM Wako Pure Chemical Corporation), 180 part by mass of 1H,1H,2H,2H-tridecafluoro-n-octyl methacrylate (manufactured by Tokyo Chemical Industry Co., Ltd.), and 20 parts by mass of azobisbutyronitrile (manufactured by FUJIFILM Wako Pure Chemical Corporation) were added to a 1 L three-necked flask equipped with a reflux condenser and a gas introduction cock. After introducing nitrogen gas at a flow rate of 200 mL/min for 10 minutes, the temperature was raised to 80° C., and stirring was continued for 5 hours. Then, it was added dropwise to methanol to obtain a precursor B-9 (a macromonomer) as a precipitate. The number average molecular weight of the macromonomer was 4,200.

Next, a polymer B-9 (mass average molecular weight: 102,000) was synthesized in the same manner as Synthesis Example 6 to obtain a binder solution B-9 (concentration: 10% by mass) consisting of a polymer B-9 (a hydrocarbon-based polymer), except that 1H,1H,2H,2H-perfluoro-1-octanol of Synthesis Example 6 was changed to the precursor B-9 described above.

The polymers B-1 to B-9 are shown below. The number at the bottom right of each constitutional component indicates the content (% by mole) of each constitutional component in the polymer. In the following formulae, Me represents methyl, R^{S1} represents an alkylene group having 1 to 10 carbon atoms, and R^{S2} represents an alkyl group having 1 to 10 carbon atoms.

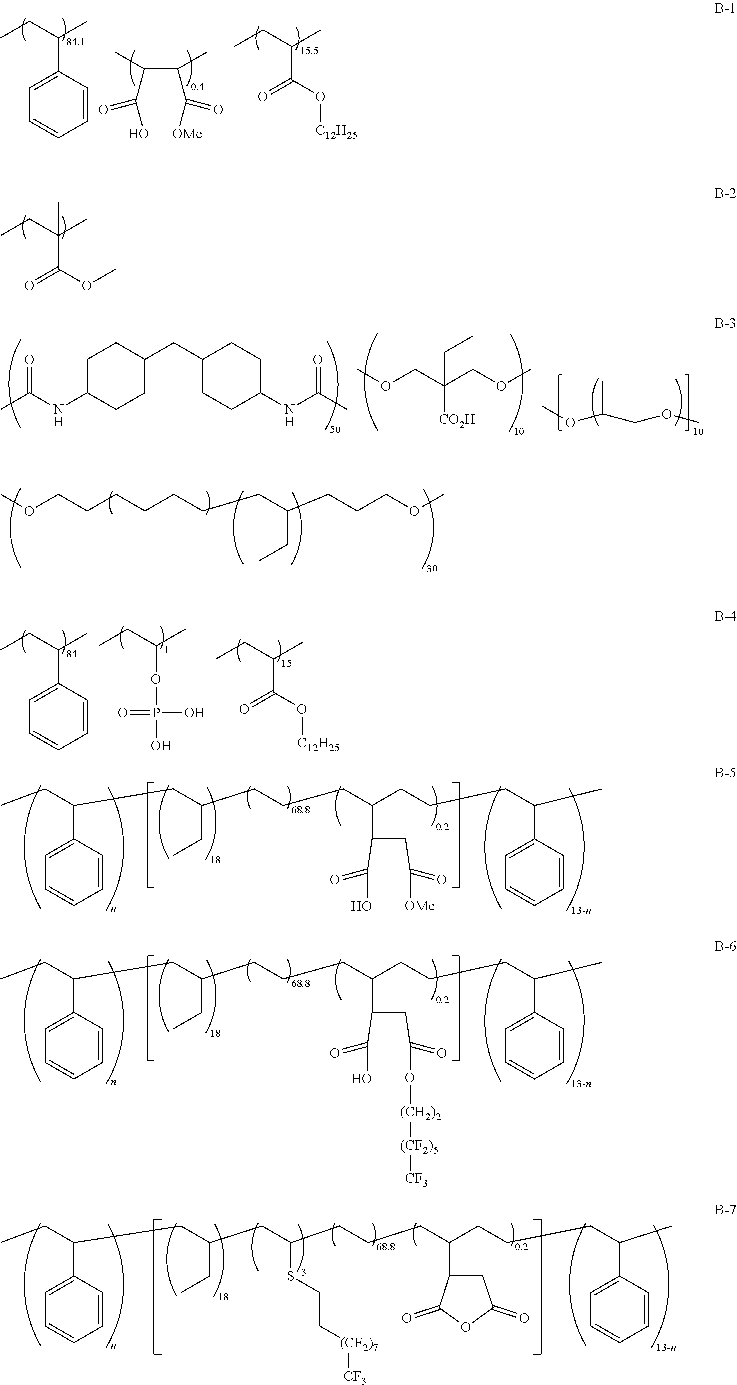

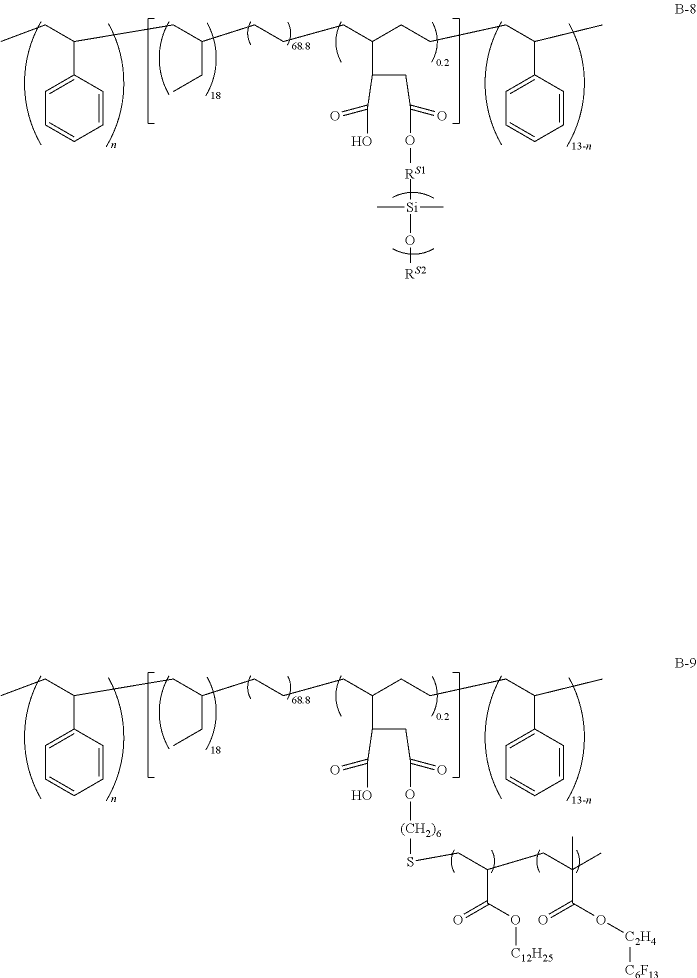

Polymers B-10 to B-13 shown in the following chemical formulae and Table 2 were synthesized as follows.

### Synthesis Example 10: Synthesis of Polymer B-10 and Preparation of Binder Solution B-10

150 parts by mass of toluene, 30 parts by mass of styrene, and 70 parts by mass of 1,3-butadiene were added to an autoclave, and 1 part by mass of a polymerization initiator V-601 (manufactured by FUJIFILM Wako Pure Chemical Corporation) were added thereto. Then, the temperature was raised to 80° C., and stirring was carried out for 3 hours. Then, the temperature was raised to 90° C., and the reaction was carried out until the addition conversion rate reached 100%. The obtained solution was reprecipitated in methanol and dried to obtain a solid, and 3 parts by mass of 2,6-di-t-butyl-p-cresol and 0.5 parts by mass of maleic acid anhydride were added with respect to 100 parts by mass of the obtained polymer, and then the reaction was carried out at 180° C. for 5 hours. The obtained solution was reprecipitated in acetonitrile, and the obtained solid was dried at 80° C. to obtain a polymer (a dry solid product). The mass average molecular weight of this polymer was 90,000. Then, 50 parts by mass of the polymer (the dry solid product) obtained as described above was dissolved in 50 parts by mass of cyclohexane and 150 parts by mass of tetrahydrofuran (THF). After the solution was brought to 70° C., 3 parts by mass of n-butyl lithium, 3 parts by mass of 2,6-di-t-butyl-p-cresol, 1 part by mass of bis(cyclopentadienyl)titanium dichloride, and 2 parts by mass of diethyl aluminum chloride were added thereto, the resultant mixture was reacted at a hydrogen pressure of 10 kg/cm′ for 1 hour, distilled off, and dried to obtain a hydrocarbon-based polymer precursor A (mass average molecular weight: 90,000).

Next, 450 parts by mass of xylene (manufactured by FUJIFILM Wako Pure Chemical Corporation) and 50 parts by mass of the hydrocarbon-based polymer precursor A were added and dissolved in a 1 L three-necked flask equipped with a reflux condenser and a gas introduction cock. Then, 4 parts by mass of N-methylethanolamine (manufactured by Tokyo Chemical Industry Co., Ltd.) was added, the temperature was raised to 90° C., and stirring was continued for 20 hours. Then, a 1 N hydrochloric acid aqueous solution was added and separated to extract the organic layer, and the organic layer was added dropwise to methanol to obtain the polymer B-10 as a precipitate. After drying under reduced pressure at 60° C. for 5 hours, the precipitate was redissolved in any solvent. In this way, a polymer B-10 (mass average molecular weight: 94,000) was synthesized to obtain a binder solution B-10 (concentration: 10% by mass) consisting of the polymer B-10.

### Synthesis Example 11: Synthesis of Polymer B-11 and Preparation of Binder Solution B-11

450 parts by mass of xylene (mass by FUJIFILM Wako Pure Chemical Corporation) and 50 parts by mass of the hydrocarbon-based polymer precursor B synthesized by changing 0.5 parts by mass of maleic acid anhydride in the synthesis of the hydrocarbon-based polymer precursor A to 2.2 parts by mass of maleic acid anhydride were added and dissolved in a 1 L three-necked flask equipped with a reflux condenser and a gas introduction cock. Then, 5.6 parts by mass of diethanolamine (manufactured by Tokyo Chemical Industry Co., Ltd.) was added, the temperature was raised to 90° C., and stirring was continued for 20 hours. Then, a 1 N hydrochloric acid aqueous solution was added and separated to extract the organic layer, and the organic layer was added dropwise to methanol to obtain the polymer B-11 as a precipitate. After drying under reduced pressure at 60° C. for 5 hours, the precipitate was redissolved in any solvent. In this way, a polymer B-11 (mass average molecular weight: 95,000) was synthesized to obtain a binder solution B-11 (concentration: 10% by mass) consisting of the polymer B-11.

### Synthesis Example 12: Synthesis of Polymer B-12 and Preparation of Binder Solution B-12

450 parts by mass of xylene (mass by FUJIFILM Wako Pure Chemical Corporation) and 50 parts by mass of the hydrocarbon-based polymer precursor A were added and dissolved in a 1 L three-necked flask equipped with a reflux condenser and a gas introduction cock. Then, 2.3 parts by mass of α-thioglycerol (manufactured by Tokyo Chemical Industry Co., Ltd.) and 2 parts by mass of azobisbutyronitrile (manufactured by FUJIFILM Wako Pure Chemical Corporation) were added thereto. After introducing nitrogen gas at a flow rate of 200 mL/min for 10 minutes, the temperature was raised to 80° C., and stirring was continued for 5 hours. Then, the reaction solution was added dropwise to methanol to obtain a polymer B-12 as a precipitate. After drying under reduced pressure at 60° C. for 5 hours, the precipitate was redissolved in any solvent. In this way, a polymer B-12 (mass average molecular weight: 98,000) was synthesized to obtain a binder solution B-12 (concentration: 10% by mass) consisting of the polymer B-12.

### Synthesis Example 13: Synthesis of Polymer B-13 and Preparation of Binder Solution B-13

100 parts by mass of xylene (manufactured by FUJIFILM Wako Pure Chemical Corporation) was added to a 2 L three-necked flask equipped with a reflux condenser and a gas introduction cock, nitrogen gas was introduced at a flow rate of 100 mL/min for 10 minutes, and then the temperature was raised to 80° C. A mixed solution of 9.2 parts by mass of 2-aminoethanethiol hydrochloride (manufactured by Tokyo Chemical Industry Co., Ltd.) and 100 parts by mass of ethanol (manufactured by FUJIFILM Wako Pure Chemical Corporation) and a mixed solution of 400 parts by mass of lauryl acrylate (manufactured by FUJIFILM Wako Pure Chemical Corporation), 100 parts by mass of hydroxyethyl acrylate (manufactured by FUJIFILM Wako Pure Chemical Corporation), 170 parts by mass of xylene (manufactured by FUJIFILM Wako Pure Chemical Corporation), and 10 parts by mass of azobisbutyronitrile (manufactured by FUJIFILM Wako Pure Chemical Corporation) were each separately added dropwise into the above three-necked flask over 2 hours. After the dropwise addition, the mixture was further stirred at 80° C. for 2 hours. Then, it was added dropwise to methanol to obtain a macromonomer having a terminal amino group (a hydrochloride) as a precipitate. The number average molecular weight of the macromonomer was 4,000.

Next, 450 parts by mass of xylene (mass by FUJIFILM Wako Pure Chemical Corporation) and 50 parts by mass of the hydrocarbon-based polymer precursor B were added and dissolved in a 1 L three-necked flask equipped with a reflux condenser and a gas introduction cock. Then, 68 parts by mass of the macromonomer having a terminal amino group and 1.6 parts by mass of 1,8-diazabicycloundecene (DBU, manufactured by FUJIFILM Wako Pure Chemical Corporation) were added thereto, the temperature was 130° C., and stirring was continued for 10 hours. Then, a 1 N hydrochloric acid aqueous solution was added and separated to extract the organic layer, and the organic layer was added dropwise to acetone to obtain the polymer B-13 as a precipitate. After drying under reduced pressure at 60° C. for 5 hours, the precipitate was redissolved in any solvent. In this way, a polymer B-13 (mass average molecular weight: 110,000) was synthesized to obtain a binder solution B-13 (concentration: 10% by mass) consisting of the polymer B-13.

The polymers B-10 to B-13 are shown below. The number at the bottom right of each constitutional component indicates the content (% by mole) of each constitutional component in the polymer.

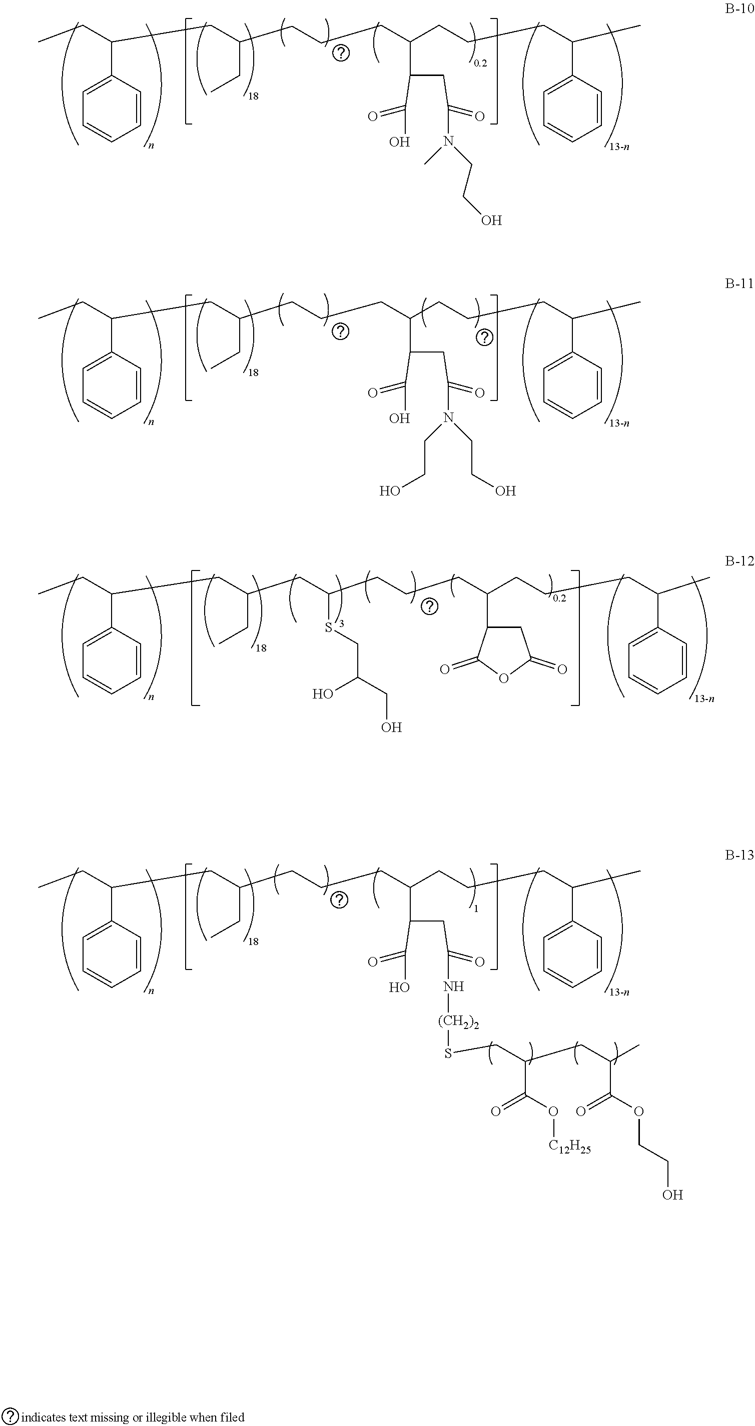

The solubility of the polymer binder consisting of each of the synthesized polymers in the dispersion medium (butyl butyrate) that has been used in the preparation of the inorganic solid electrolyte-containing composition described later is measured according to the above-described method and is shown in Table 2. In addition, the solubility property in the inorganic solid electrolyte-containing compositions described later was classified based on the measured solubility. Further, Table 2 shows, regarding each of the synthesized polymers, the presence or absence (the kind) of the functional group, the content, and the pKa (only the lowest value in a case of having a plurality of kinds of functional groups) of the functional group according to the above-described measuring method.

The solubility property of the polymer binders was classified as follows.

Solubility Property—

Soluble: It indicates being present in a dissolved state, and the measured solubility in butyl butyrate is 80% by mass or more.

Solid: It indicates being present in a solid state, and the above-described solubility is 30% by mass or less.

TABLE 2

| | Solubility | Functional group | Content of functional | | | |
|---|---|---|---|---|---|---|
| Kind | property | (a) | group (a) | pKa | Type | Solubility |
| B-1 | Soluble | Carboxy group | 0.4% by mole | 1.92 | Vinyl polymer | 95% |
| B-2 | Solid | Absent | 0% by mole | >20 | (Meth)acrylic polymer | 0.0% |
| B-3 | Soluble | Carboxy group | 10% by mole | 4.66 | Polyurethane | 90% |
| B-4 | Soluble | Phosphate group | 1% by mole | 1.2 | Vinyl polymer | 96% |
| B-5 | Soluble | Carboxy group | 0.2% by mole | 1.92 | Hydrocarbon-based | 92% |
| | | | | | polymer | |
| B-6 | Soluble | Carboxy group | 0.2% by mole | 1.92 | Hydrocarbon-based | 92% |
| | | | | | polymer | |
| B-7 | Soluble | Carboxylic acid | 0.2% by mole | 1.92 | Hydrocarbon-based | 92% |
| | | anhydride | | | polymer | |
| B-8 | Soluble | Carboxy group | 0.2% by mole | 1.92 | Hydrocarbon-based | 92% |
| | | | | | polymer | |
| B-9 | Soluble | Carboxy group | 0.2% by mole | 1.92 | Hydrocarbon-based | 92% |
| | | | | | polymer | |
| B-10 | Soluble | Carboxy group/ | 0.2% by mole/ | 1.92 | Hydrocarbon-based | 92% |
| | | Hydroxy group | 0.2% by mole | | polymer | |
| B-11 | Soluble | Carboxy group/ | 1% by mole/ | 1.92 | Hydrocarbon-based | 92% |
| | | Hydroxy group | 1% by mole | | polymer | |
| B-12 | Soluble | Carboxylic acid | 0.2% by mole/ | 1.92 | Hydrocarbon-based | 92% |
| | | anhydride/ | 3% by mole | | polymer | |
| | | Hydroxy group | | | | |
| B-13 | Soluble | Carboxy group/ | 1% by mole/ | 1.92 | Hydrocarbon-based | 92% |
| | | Hydroxy group | 1% by mol | | polymer | |

3. Synthesis of Sulfide-Based Inorganic Solid Electrolyte [Synthesis Example A]

A sulfide-based inorganic solid electrolyte was synthesized with reference to non-patent documents of T. Ohtomo, A. Hayashi, M. Tatsumisago, Y. Tsuchida, S. Hama, K. Kawamoto, Journal of Power Sources, 233, (2013), pp. 231 to 235, and A. Hayashi, S. Hama, H. Morimoto, M. Tatsumisago, T. Minami, Chem. Lett., (2001), pp. 872 and 873.

Specifically, in a globe box under an argon atmosphere (dew point: −70° C.), lithium sulfide (Li₂S, manufactured by Sigma-Aldrich Co., LLC Co., LLC Co., LLC, purity: >99.98%) (2.42 g) and diphosphorus pentasulfide (P₂S₅, manufactured by Sigma-Aldrich Co., LLC Co., LLC Co., LLC, purity: >99%) (3.90 g) each were weighed, put into an agate mortar, and mixed for 5 minutes using an agate muddler for five minutes. The mixing ratio between Li₂S and P₂S₅ (Li₂S:P₂S₅) was set to 75:25 in terms of molar ratio.

Next, 66 g of zirconia beads having a diameter of 5 mm were put into a 45 mL container made of zirconia (manufactured by FRITSCH), the entire amount of the mixture of the above lithium sulfide and the diphosphorus pentasulfide was put thereinto, and the container was completely sealed in an argon atmosphere. The container was set in a planetary ball mill P-7 (product name, manufactured by FRITSCH), mechanical milling was carried out at a temperature of 25° C. and a rotation speed of 510 rpm for 20 hours, thereby obtaining yellow powder (6.20 g) of a sulfide-based inorganic solid electrolyte (Li—P—S-based glass, hereinafter, may be referred to as LPS). The average particle diameter of the Li—P—S-based glass was 15 μm.

### Example 1

<Preparation of Inorganic Solid Electrolyte-Containing Composition>

60 g of zirconia beads having a diameter of 5 mm were put into a 45 mL container made of zirconia (manufactured by FRITSCH), and the LPS synthesized in the synthesis example A, the binder solution or dispersion liquid shown in Table 3-3 and Table 3-4, the metal element-containing compound, and butyl butyrate as a dispersion medium were put thereinto at such a mass proportion that the contents thereof were as shown in Tables 3-3 and 3-4 (however, the solution or dispersion liquid was in terms of solid content mass). Then, this container was set in a planetary ball mill P-7 (product name) manufactured by FRITSCH. Each of the inorganic solid electrolyte-containing compositions (slurries) S-31 and S-32 was prepared by mixing at a temperature of 25° C. and a rotation speed of 150 rpm for 10 minutes.

<Preparation of Composition for Positive Electrode>

60 g of zirconia beads having a diameter of 5 mm were put into a 45 mL container made of zirconia (manufactured by FRITSCH), and the LPS synthesized in Synthesis Example A and the dispersion medium shown in Table 3-1 and Table 3-3 as a dispersion medium were put thereinto at such a mass proportion that the contents thereof were as shown in each table. The container was set in a planetary ball mill P-7 (product name, manufactured by FRITSCH) and the components were stirred for 30 minutes at 25° C. and a rotation speed of 200 rpm. Then, NMC as a positive electrode active material, acetylene black (AB) as a conductive auxiliary agent, the binder solution or dispersion liquid shown in Table 3-2 and Table 3-4, as well as the metal element-containing compound were put into this container at such a mass proportion that the contents thereof were as shown in Table 3-1 and Table 3-3 (however, the solution or dispersion was in terms of solid content mass). The container was set in a planetary ball mill P-7, mixing was continued at a temperature of 25° C. and a rotation speed of 200 rpm for 30 minutes to prepare each of the compositions (slurries) S-1 to S-28 and S-33 to 36 for a positive electrode.

<Preparation of Composition for Negative Electrode>

60 g of zirconia beads having a diameter of 5 mm were put into a 45 mL container made of zirconia (manufactured by FRITSCH), and the LPS synthesized in Synthesis Example A, the binder solution or dispersion liquid shown in Table 3-4, and the dispersion medium shown in Table 3-3 were put thereinto at such a mass proportion that the contents thereof were as shown in Table 3-3 and Table 3-4. The container was set in a planetary ball mill P-7 (product name, manufactured by FRITSCH) and the components were mixed for 60 minutes at a temperature of 25° C. and a rotation speed of 300 rpm. Then, silicon (Si) as a negative electrode active material, acetylene black (AB) as a conductive auxiliary agent, as well as the metal element-containing compound were put into the container at such a mass proportion that the contents thereof were as shown in Table 3-3 and Table 3-4 (however, the solution or dispersion liquid was in terms of solid content mass). In the same manner, the container was set in a planetary ball mill P-7, mixing was carried out at a temperature of 25° C. and a rotation speed of 100 rpm for 10 minutes to prepare each of the compositions (slurries) S-29 and S-30 for a negative electrode.

The results obtained by measuring the viscosity of each of the prepared compositions according to the above-described measuring method, and the difference between the pKa of the conjugate acid and the pKa of the functional group in the metal element-containing compound are shown in Tables 3-1 to 3-4 (collectively referred to as Table 3).

<Measurement of Average Particle Diameter of Metal Element-Containing Compound>

The average particle diameter of the metal element-containing compound present in the solid state in each of the prepared compositions was measured according to the following method, and the results thereof are shown in Table 1 and Table 3.

Measuring Method—

Each of the prepared compositions was passed through a filter cloth (pore diameter: 10 μm) to remove aggregates such as the inorganic solid electrolyte and then subjected to centrifugation (500 rpm for 30 minutes) with a centrifuge. The separated supernatant (the mixed solution of the metal element-containing compound) was diluted and adjusted with a dispersion medium (the same one as the dispersion medium used in the preparation of each of the compositions) so that the absorbance was 80% to 95% and then subjected to measurement using a laser diffraction/scattering-type particle size distribution analyzer (product name: LA-920, manufactured by HORIBA, Ltd.). As the measurement conditions, the same conditions as those for the average particle diameter of the inorganic solid electrolyte can be applied.

TABLE 3

| | | | | | | Metal-containing compound | | | | | | |
|---|---|---|---|---|---|---|---|---|---|---|---|---|
| | | | | | | | | | Average | | Number | |
| | | Inorganic solid | | | | | Solu- | | particle | pKa of | of | |
| | Viscosity | electrolyte | | Dispersion medium | | | bility | Dispers- | diameter | conjugate | carbon | |
| No. | (cP) | | Content | | Content | | property | ibility | (μm) | acid (C) | atoms | Content |
| S-1 | 4500 | LPS | 22 | BB | 30 | — | — | — | — | — | — | — |
| S-2 | 4100 | LPS | 21 | BB | 30 | — | — | — | — | — | — | — |
| S-3 | 4100 | LPS | 20.95 | BB | 30 | LiTFSI | Soluble | — | 0 | −11 | 0 | 0.05 |
| S-4 | 4200 | LPS | 20.95 | BB | 30 | Stearic acid amide | Solid | Non-dispersed | 20 | 4.75 | 18 | 0.05 |
| S-5 | 3800 | LPS | 20.95 | BB | 30 | Aluminum stearate | Solid | Dispersed | 0.80 | 4.75 | 18 | 0.05 |
| S-6 | 2800 | LPS | 20.95 | BB | 30 | Zinc stearate | Solid | Dispersed | 0.80 | 4.75 | 18 | 0.05 |
| S-7 | 2500 | LPS | 20.95 | BB | 30 | Magnesium stearate | Solid | Dispersed | 0.80 | 4.75 | 18 | 0.05 |
| S-8 | 900 | LPS | 20.95 | BB | 30 | Lithium stearate | Solid | Dispersed | 0.80 | 4.75 | 18 | 0.05 |
| S-9 | 100 | LPS | 20.95 | BB | 30 | Lithium stearate | Solid | Dispersed | 8.00 | 4.75 | 18 | 0.05 |
| S-10 | 2600 | LPS | 20.95 | BB | 30 | Lithium stearate | Solid | Non-dispersed | 30.00 | 4.75 | 18 | 0.05 |
| S-11 | 400 | LPS | 20.95 | BB | 30 | Lithium acetate | Solid | Dispersed | 0.80 | 4.76 | 2 | 0.05 |
| S-12 | 450 | LPS | 20.95 | BB | 30 | Lithium butyrate | Solid | Dispersed | 0.80 | 4.76 | 4 | 0.05 |
| S-13 | 900 | LPS | 20.95 | BB | 30 | Lithium hexanoate | Solid | Dispersed | 0.80 | 4.75 | 6 | 0.05 |
| S-14 | 900 | LPS | 20.95 | BB | 30 | Lithium decanoate | Solid | Dispersed | 0.80 | 5.30 | 12 | 0.05 |
| S-15 | 900 | LPS | 20.95 | BB | 30 | Lithium heneicosylate | Solid | Dispersed | 0.80 | 4.72 | 22 | 0.05 |
| S-16 | 1200 | LPS | 20.95 | BB | 30 | C-11 | Solid | Dispersed | 0.80 | 35 | 3 | 0.05 |
| S-17 | 1300 | LPS | 20.95 | BB | 30 | C-12 | Solid | Dispersed | 0.80 | 12 | 18 | 0.05 |
| S-18 | 900 | LPS | 20.95 | BB | 30 | C-14 | Solid | Dispersed | 0.80 | 2.12 | 12 | 0.05 |
| S-19 | 900 | LPS | 20.95 | BB | 30 | C-15 | Solid | Dispersed | 0.80 | 1.9 | 8 | 0.05 |

| | | Polymer binder solution or dispersion liquid | | | | | | | | | | | |
|---|---|---|---|---|---|---|---|---|---|---|---|---|---|
| | | | | | | Average | | | | | | | |
| | | | | | | particle | Solu- | | | | | | |
| | | Solu- | | | | diameter | bility | pKa | | | Conductive auxiliary | | |
| | | bility | pKa | Solu- | | in layer | after | differ- | Active material | | agent | | |
| No. | | property | (D) | bility | Content | (μm) | extraction | ence | | Content | | Content | Note |
| S-1 | — | — | — | — | — | — | — | — | NMC | 75 | AB | 3 | Comparative |
| | | | | | | | | | | | | | Example |
| S-2 | B-1 | Soluble | 1.92 | 95% | 1 | Unmeasurable | 95% | — | NMC | 75 | AB | 3 | Comparative |
| | | | | | | | | | | | | | Example |
| S-3 | B-1 | Soluble | 1.92 | 95% | 1 | Unmeasurable | 95% | −12.92 | NMC | 75 | AB | 3 | Comparative |
| | | | | | | | | | | | | | Example |
| S-4 | B-1 | Soluble | 1.92 | 95% | 1 | Unmeasurable | 93% | 2.83 | NMC | 75 | AB | 3 | Comparative |
| | | | | | | | | | | | | | Example |
| S-5 | B-1 | Soluble | 1.92 | 95% | 1 | 1150 | 32% | 2.83 | NMC | 75 | AB | 3 | Present |
| | | | | | | | | | | | | | invention |
| S-6 | B-1 | Soluble | 1.92 | 95% | 1 | 900 | 32% | 2.83 | NMC | 75 | AB | 3 | Present |
| | | | | | | | | | | | | | invention |
| S-7 | B-1 | Soluble | 1.92 | 95% | 1 | 500 | 32% | 2.83 | NMC | 75 | AB | 3 | Present |
| | | | | | | | | | | | | | invention |
| S-8 | B-1 | Soluble | 1.92 | 95% | 1 | 300 | 32% | 2.83 | NMC | 75 | AB | 3 | Present |
| | | | | | | | | | | | | | invention |
| S-9 | B-1 | Soluble | 1.92 | 95% | 1 | 600 | 32% | 2.83 | NMC | 75 | AB | 3 | Present |
| | | | | | | | | | | | | | invention |
| S-10 | B-1 | Soluble | 1.92 | 95% | 1 | 1300 | 60% | 2.83 | NMC | 75 | AB | 3 | Present |
| | | | | | | | | | | | | | invention |
| S-11 | B-1 | Soluble | 1.92 | 95% | 1 | 950 | 32% | 2.84 | NMC | 75 | AB | 3 | Present |
| | | | | | | | | | | | | | invention |
| S-12 | B-1 | Soluble | 1.92 | 95% | 1 | 1000 | 32% | 2.84 | NMC | 75 | AB | 3 | Present |
| | | | | | | | | | | | | | invention |
| S-13 | B-1 | Soluble | 1.92 | 95% | 1 | 500 | 32% | 2.83 | NMC | 75 | AB | 3 | Present |
| | | | | | | | | | | | | | invention |
| S-14 | B-1 | Soluble | 1.92 | 95% | 1 | 550 | 32% | 3.38 | NMC | 75 | AB | 3 | Present |
| | | | | | | | | | | | | | invention |
| S-15 | B-1 | Soluble | 1.92 | 95% | 1 | 850 | 32% | 2.8 | NMC | 75 | AB | 3 | Present |
| | | | | | | | | | | | | | invention |
| S-16 | B-1 | Soluble | 1.92 | 95% | 1 | 350 | 32% | 33.08 | NMC | 75 | AB | 3 | Present |
| | | | | | | | | | | | | | invention |
| S-17 | B-1 | Soluble | 1.92 | 95% | 1 | 400 | 32% | 10.08 | NMC | 75 | AB | 3 | Present |
| | | | | | | | | | | | | | invention |
| S-18 | B-1 | Soluble | 1.92 | 95% | 1 | 900 | 32% | 0.2 | NMC | 75 | AB | 3 | Present |
| | | | | | | | | | | | | | invention |
| S-19 | B-1 | Soluble | 1.92 | 95% | 1 | 1500 | 32% | −0.02 | NMC | 75 | AB | 3 | Present |
| | | | | | | | | | | | | | invention |

| | | | | | | Metal-containing compound | | | | | | |
|---|---|---|---|---|---|---|---|---|---|---|---|---|
| | | | | | | | | | Average | pKa of | Number | |
| | Viscos- | Inorganic solid electrolyte | | Dispersion medium | | | Solu- | | particle | conjugate | of | |
| | ity | | Con- | | Con- | | bility | Dispers- | diameter | acid | carbon | Con- |
| No. | (cP) | | tent | | tent | | property | ibility | (μm) | (C) | atoms | tent |
| S-20 | 1000 | LPS | 20.95 | BB | 30 | C-16 | Solid | Dispersed | 4.0 | 1.9 | 8 | 0.05 |
| S-21 | 5100 | LPS | 20.95 | BB | 30 | Lithium stearate | Solid | Dispersed | 0.80 | 4.75 | 18 | 0.05 |
| S-22 | 900 | LPS | 20.95 | BB | 30 | Lithium stearate | Solid | Dispersed | 0.80 | 4.75 | 18 | 0.05 |
| S-23 | 900 | LPS | 20.95 | BB | 30 | Lithium stearate | Solid | Dispersed | 0.80 | 4.75 | 18 | 0.05 |
| S-24 | 900 | LPS | 20.95 | BB | 30 | Lithium stearate | Solid | Dispersed | 0.80 | 4.75 | 18 | 0.05 |
| S-25 | 900 | LPS | 20.95 | BB | 30 | Lithium stearate | Solid | Dispersed | 0.80 | 4.75 | 18 | 0.05 |
| S-26 | 900 | LPS | 20.95 | BB | 30 | Lithium stearate | Solid | Dispersed | 0.80 | 4.75 | 18 | 0.05 |
| S-27 | 900 | LPS | 20.95 | BB | 30 | Lithium stearate | Solid | Dispersed | 0.80 | 4.75 | 18 | 0.05 |
| S-28 | 900 | LPS | 20.95 | BB | 30 | Lithium stearate | Solid | Dispersed | 0.80 | 4.75 | 18 | 0.05 |
| S-29 | 950 | LPS | 42.95 | BB | 50 | Lithium stearate | Solid | Dispersed | 0.80 | 4.75 | 18 | 0.05 |
| S-30 | 4200 | LPS | 47 | BB | 50 | — | — | — | — | — | — | — |
| S-31 | 1500 | LPS | 96.85 | BB | 40 | Lithium stearate | Solid | Dispersed | 0.80 | 4.75 | 18 | 0.15 |
| S-32 | 4700 | LPS | 97 | BB | 40 | — | — | — | — | — | — | — |
| S-33 | 900 | LPS | 20.95 | BB | 30 | Lithium stearate | Solid | Dispersed | 0.80 | 4.75 | 18 | 0.05 |
| S-34 | 900 | LPS | 20.95 | BB | 30 | Lithium stearate | Solid | Dispersed | 0.80 | 4.75 | 18 | 0.05 |
| S-35 | 900 | LPS | 20.95 | BB | 30 | Lithium stearate | Solid | Dispersed | 0.80 | 4.75 | 18 | 0.05 |
| S-36 | 900 | LPS | 20.95 | BB | 30 | Lithium stearate | Solid | Dispersed | 0.80 | 4.75 | 18 | 0.05 |

| | | Polymer binder solution or dispersion liquid | | | | | | | | | | | |
|---|---|---|---|---|---|---|---|---|---|---|---|---|---|
| | | | | | | Average | | | | | | | |
| | | | | | | particle | Solu- | | | | | | |
| | | Solu- | | | | diameter | bility | pKa | | | Conductive auxiliary | | |
| | | bility | pKa | Solu- | | in layer | after | differ- | Active material | | agent | | |
| No. | | property | (D) | bility | Content | (μm) | extraction | ence | | Content | | Content | |
| S-20 | B-1 | Soluble | 1.92 | 95% | 1 | Unmeasurable | 32% | −0.02 | NMC | 75 | AB | 3 | Comparative |
| | | | | | | | | | | | | | Example |
| S-21 | B-2 | Solid | >20 | 0.0% | 1 | 2000 | 0.0% | <−15.3 | NMC | 75 | AB | 3 | Comparative |
| | | | | | | | | | | | | | Example |
| S-22 | B-3 | Soluble | 4.66 | 90% | 1 | 700 | 30% | 0.09 | NMC | 75 | AB | 3 | Present |
| | | | | | | | | | | | | | invention |
| S-23 | B-4 | Soluble | 1.2 | 96% | 1 | 400 | 35% | 3.55 | NMC | 75 | AB | 3 | Present |
| | | | | | | | | | | | | | invention |
| S-24 | B-5 | Soluble | 1.92 | 92% | 1 | 900 | 31% | 2.83 | NMC | 75 | AB | 3 | Present |
| | | | | | | | | | | | | | invention |
| S-25 | B-6 | Soluble | 1.92 | 92% | 1 | 400 | 31% | 2.83 | NMC | 75 | AB | 3 | Present |
| | | | | | | | | | | | | | invention |
| S-26 | B-7 | Soluble | 1.92 | 92% | 1 | 400 | 31% | 2.83 | NMC | 75 | AB | 3 | Present |
| | | | | | | | | | | | | | invention |
| S-27 | B-8 | Soluble | 1.92 | 92% | 1 | 350 | 31% | 2.83 | NMC | 75 | AB | 3 | Present |
| | | | | | | | | | | | | | invention |
| S-28 | B-9 | Soluble | 1.92 | 92% | 1 | 200 | 28% | 2.83 | NMC | 75 | AB | 3 | Present |
| | | | | | | | | | | | | | invention |
| S-29 | B-1 | Soluble | 1.92 | 95% | 1 | 300 | 32% | 2.83 | Si | 52 | AB | 4 | Present |
| | | | | | | | | | | | | | invention |
| S-30 | B-1 | Soluble | 1.92 | 95% | 1 | Unmeasurable | 95% | — | Si | 52 | AB | 4 | Comparative |
| | | | | | | | | | | | | | Example |
| S-31 | B-1 | Soluble | 1.92 | 95% | 3 | 300 | 32% | 2.83 | — | — | — | — | Present |
| | | | | | | | | | | | | | invention |
| S-32 | B-1 | Soluble | 1.92 | 95% | 3 | Unmeasurable | 95% | — | — | — | — | — | Comparative |
| | | | | | | | | | | | | | Example |
| S-33 | B-10 | Soluble | 1.92 | 92% | 1 | 500 | 30% | 2.83 | NMC | 75 | AB | 3 | Present |
| | | | | | | | | | | | | | invention |
| S-34 | B-11 | Soluble | 1.92 | 92% | 1 | 400 | 30% | 2.83 | NMC | 75 | AB | 3 | Present |
| | | | | | | | | | | | | | invention |
| S-35 | B-12 | Soluble | 1.92 | 92% | 1 | 300 | 35% | 2.83 | NMC | 75 | AB | 3 | Present |
| | | | | | | | | | | | | | invention |
| S-36 | B-13 | Soluble | 1.92 | 92% | 1 | 200 | 25% | 2.83 | NMC | 75 | AB | 3 | Present |
| | | | | | | | | | | | | | invention |

<Abbreviations in table>
In the table, “—” in each column indicates that the corresponding component is not included or that the corresponding characteristic is not provided or cannot be measured.
The content of the dispersion medium indicates the content (% by mass) with respect to the total amount of the composition, and the contents of other components indicate the contents (% by mass) with respect to the solid content of the composition.
“pKa (D)” and “pKa difference” in the table respectively indicate the lowest pKa value and the difference with respect to the lowest pKa value in a case where the polymer has a plurality of functional groups (a).
LPS: LPS synthesized in Synthesis Example A
BB: Butyl butyrate
LiTFSI: Lithium bis(trifluoromethanesulfonyl)imide (manufactured by Tokyo Chemical Industry Co., Ltd.)
C-11: The above-described exemplary compound C-11
C-12: The above-described exemplary compound C-12
C-14: The above-described exemplary compound C-14
C-15: The above-described exemplary compound C-15
C-16: The above-described compound C-16
B-1 to B-13: The polymer binders synthesized respectively in Synthesis Examples 1 to 13
NMC: LiNi_{1/3}Co_{1/3}Mn_{1/3}O₂ (manufactured by Sigma-Aldrich Co., LLC)
Si: Silicon (manufactured by Sigma-Aldrich Co., LLC)
AB: Acetylene black (manufactured by Denka Company Limited)

<Evaluation 1: Dispersion Stability Test>

Each of the prepared compositions was placed in a glass test tube having a diameter of 10 mm and a height of 4 cm up to a height of 3.5 cm and allowed to stand at 25° C. for 24 hours. The solid content reduction rate for the upper 20% (in terms of height) of the slurry before and after standing was calculated from the following expression. The ease of sedimentation (precipitation) of the inorganic solid electrolyte and the active material was evaluated as the dispersion stability of the composition by determining where the solid content reduction rate is included in any one of the following evaluation standards. The collected slurry was placed on an aluminum cup and heated at 120° C. for 2 hours to distill off the dispersion medium, and the solid content concentration was calculated.

In this test, the smaller the solid content reduction rate, the better the dispersion stability, and the evaluation standard “F” or higher is the pass level. The results are shown in Table 4.

Solid content reduction rate (%)=[(solid content concentration of upper 20% before standing-solid content concentration of upper 20% after standing)/solid content concentration of upper 20% before standing]×100

Evaluation Standards—

A: Solid content reduction rate <1%

B: 1%≤solid content reduction rate <2%

C: 2%≤solid content reduction rate <3%

D: 3%≤solid content reduction rate <4%

E: 4%≤solid content reduction rate <5%

F: 5%≤solid content reduction rate <6%

G: 6%≤solid content reduction rate

<Evaluation 2: Handleability>

In the same manner as each of the prepared compositions, the same mixing proportion was used except for the dispersion medium, and the amount of the dispersion medium was reduced, whereby a slurry having a solid content concentration of 75% by mass was prepared. A 2 mL poly dropper (manufactured by atect Corporation) was arranged vertically so that 10 mm of the tip thereof was positioned below the slurry interface, and the slurry was aspirated at 25° C. for 10 seconds, and the mass W of the poly dropper containing the aspirated slurry was measured. In a case where the tare weight (the empty weight) of the poly dropper is denoted by W₀, it was determined that the slurry cannot be aspirated by the dropper in a case where the slurry mass W−W₀ is less than 0.1 g. In a case where the slurry could not be aspirated with a dropper, the upper limit solid content concentration at which the slurry can be aspirated with a dropper was estimated while gradually adding the dispersion medium. The handleability (the extent to which an appropriate viscosity suitable for forming a flat constitutional layer having a good surface property can be obtained) of the composition was evaluated by determining where the obtained upper limit solid content concentration is included in any one of the following evaluation standards. 0.30 g of the prepared slurry was placed on an aluminum cup and heated at 120° C. for 2 hours to distill off the dispersion medium, and the solid content concentration was calculated.

In this test, it is indicated that the higher the upper limit solid content concentration is, the better the handleability is, and the evaluation standard “F” or higher is the pass level. The results are shown in Table 4.

Evaluation Standards—

A: 75%≤upper limit solid content concentration

B: 70%≤upper limit solid content concentration <75%

C: 65%≤upper limit solid content concentration <70%

D: 60%≤upper limit solid content concentration <65%

E: 55%≤upper limit solid content concentration <60%

F: 50%≤upper limit solid content concentration <55%

G: Upper limit solid content concentration <50%

<Production of Solid Electrolyte Sheet for all-Solid State Secondary Battery>

Each of the above-described inorganic solid electrolyte-containing compositions S-31 and S-32 was applied onto an aluminum foil having a thickness of 20 μm using a baker type applicator (product name: SA-201, manufactured by Tester Sangyo Co., Ltd.), and heating was carried out at 80° C. for 2 hours to dry (remove the dispersion medium and cause a salt exchange reaction to occur) the inorganic solid electrolyte-containing composition. Then, using a heat press machine, the inorganic solid electrolyte-containing composition dried at a temperature of 120° C. and a pressure of 40 MPa for 10 seconds was heated and pressurized to produce each of the solid electrolyte sheets S-31 and S-32 for an all-solid state secondary battery. The thickness of the solid electrolyte layer was 50 μm.

<Production of Positive Electrode Sheet for all-Solid State Secondary Battery>

Each of the obtained compositions S-1 to S-28 and S-33 to 36 for a positive electrode was applied onto an aluminum foil having a thickness of 20 μm by using a baker type applicator (product name: SA-201), heating was carried out at 80° C. for 1 hour, and then heating was further carried out at 110° C. for 1 hour to dry (remove the dispersion medium and cause a salt exchange reaction to occur) the composition for a positive electrode. Then, using a heat press machine, the dried composition for a positive electrode was pressurized (10 MPa, 1 minute) at 25° C. to produce each of the positive electrode sheets S-1 to S-28 and S-33 to 36 for an all-solid state secondary battery, having a positive electrode active material layer having a film thickness of 100 μm.

<Production of Negative Electrode Sheet for all-Solid State Secondary Battery>

Each of the obtained compositions S-29 and S-30 for a negative electrode was applied onto a copper foil having a thickness of 20 μm by using a baker type applicator (product name: SA-201), heating was carried out at 80° C. for 1 hour, and then heating was further carried out at 110° C. for 1 hour to dry (remove the dispersion medium and cause a salt exchange reaction to occur) the composition for a negative electrode. Then, using a heat press machine, the dried composition for a negative electrode was pressurized (10 MPa, 1 minute) at 25° C. to produce each of the negative electrode sheets S-29 and S-30 for an all-solid state secondary battery, having a negative electrode active material layer having a film thickness of 70

<Evaluation 3: Measurement of Average Particle Diameter of Polymer Binder in Solid Electrolyte Layer or Active Material Layer>

The prepared solid electrolyte sheet for an all-solid state secondary battery, positive electrode sheet for an all-solid state secondary battery, and negative-electrode sheet for an all-solid state secondary battery were pressed at 350 MPa for 30 seconds and then folded and bent at 180° to be cut. A cross section of the solid electrolyte layer or active material layer exposed by cutting was observed using a scanning electron microscope (SEM, model number: JSM-7401F, manufactured by JEOL Ltd.) at a magnification of 10,000 times (an SEM photographic image was captured).

In the SEM photographic image, 10 regions derived from the polymer binder were extracted, the equivalent circle diameters of the respective regions were calculated, and the average value thereof was taken as the average particle diameter of the polymer binder (the polymer binder solidified in the film forming process) in each layer. The results are shown in the column of “Average particle diameter in layer” in Table 3. The regions derived from the polymer binder were specified in the SEM photographic image by the difference in contrast with respect to the solid electrolyte.

By measuring the average particle diameter of the polymer binder (in terms of the SEM photographic image), it can be found that the polymer binder dissolved in each of the compositions is solidified into a particle shape, whereby it is possible to confirm that the polymer binder is partially adsorbed on the surface of the solid particles and does not completely cover the surface.

It is noted that in Nos. S-2 to S-4, S-20, S-30, and S-32, the average particle diameter in the layer could not be measured because the soluble type polymer binder was not solidified into a particle shape (denoted as “Unmeasurable” in Table 3).

<Evaluation 4: Measurement of Solubility of Polymer Binder Extracted from Solid Electrolyte Layer or Active Material Layer>

The polymer binder was extracted as follows from each of the prepared solid electrolyte sheet for an all-solid state secondary battery, positive electrode sheet for an all-solid state secondary battery, and negative-electrode sheet for an all-solid state secondary battery. The solubility of the obtained polymer binder in the dispersion medium used in the preparation of each of the compositions was measured according to the above-described method and is shown in the column of “Solubility after extraction” of Table 3.

In a case where the solubility of the extracted polymer binder is lower than the solubility of the polymer binder used in the preparation of each of the compositions, it is presumed that the polymer binder present in each layer has received a metal element ion from the metal element-containing compound.

Extraction Method

The solid electrolyte layer or active material layer peeled off from each sheet was immersed in butyl butyrate, vibrated for 1 hour with an ultrasonic washer, and then centrifuged (500 rpm, 1 minute) with a centrifuge to precipitate the inorganic solid electrolyte and the active material, thereby obtaining the polymer binder from the supernatant.

<Manufacturing of all-Solid State Secondary Battery>

<Manufacturing of Batteries for Evaluation of Positive Electrode Sheets (Nos. S-1 to S-28 and S-33 to 36) for all-Solid State Secondary Battery>

Each of the produced positive electrode sheets S-1 to S-28 and S-33 to 36 for an all-solid state secondary battery was punched out into a disk shape having a diameter of 10 mm and was placed in a cylinder made of PET having an inner diameter of 10 mm. 30 mg of the LPS synthesized in Synthesis Example A was placed on the positive electrode active material layer side of the cylinder, and a SUS rod having a diameter of 10 mm was inserted from the openings at both ends of the cylinder. The collector side of the positive electrode sheet for an all-solid state secondary battery and the LPS were pressurized by applying a pressure of 350 MPa with a SUS rod. The SUS rod on the LPS side was once removed, and a disk-shaped In sheet having a diameter of 9 mm (thickness: 20 μm) and a disk-shaped Li sheet having a diameter of 9 mm (thickness: 20 μm) were inserted in this order onto the LPS in the cylinder. The removed SUS rod was reinserted into the cylinder and fixed under a pressure of 50 MPa. In this manner, all-solid state secondary batteries for evaluation (half cells) S-1 to S-28 and S-33 to S-36, which have a configuration of an aluminum foil (thickness: 20 μm)−positive electrode active material layer (thickness: 80 μm)−solid electrolyte layer (thickness: 200 μm)−negative electrode active material (counter electrode) layer (In/Li sheet, thickness: 30 μm), were obtained.

<Manufacturing of Batteries for Evaluation of Negative Electrode Sheets (S-29 and S-30) for all-Solid State Secondary Battery>

The produced negative electrode sheets S-29 and S-30 for an all-solid state secondary battery were punched into a disk shape having a diameter of 10 mm and placed in a cylinder made of polyethylene terephthalate (PET) and having an inner diameter of 10 mm. 30 mg of the LPS synthesized in Synthesis Example A was placed on the negative electrode active material layer side of the cylinder, and a stainless steel (SUS) rod having a diameter of 10 mm was inserted from the openings at both ends of the cylinder. The collector side of the negative electrode sheet for an all-solid state secondary battery and the LPS were pressurized by applying a pressure of 350 MPa with a SUS rod. “The SUS rod on the LPS side was once removed, and a disk-shaped indium (In) sheet having a diameter of 9 mm (thickness: 20 μm) and a disk-shaped lithium (Li) sheet having a diameter of 9 mm (thickness: 20 μm) were inserted in this order onto the LPS in the cylinder. The removed SUS rod was reinserted into the cylinder and fixed under a pressure of 50 MPa. In this manner, all-solid state secondary batteries for evaluation (half cells) S-29 and S-30, which have a configuration of a copper foil (thickness: 20 μm)−negative electrode active material layer (thickness: 60 μm)−solid electrolyte layer (thickness: 200 μm)−positive electrode active material (counter electrode) layer (In/Li sheet, thickness: 30 μm), were obtained.

(Manufacturing of Batteries for Evaluation of Solid Electrolyte Sheets (S-31 and S-32) for all-Solid State Secondary Battery)

The positive electrode sheet (S-8) for an all-solid state secondary battery was punched out into a disk shape having a diameter of 10 mm and was placed in a cylinder made of PET having an inner diameter of 10 mm. The solid electrolyte sheets S-31 and S-32 for an all-solid state secondary battery were punched on the positive electrode active material layer side in the cylinder into a disk shape having a diameter of 10 mm and placed in the cylinder, and a 10 mm SUS rod was inserted from the openings at both ends of the cylinder. The collector side of the positive electrode sheet for an all-solid state secondary battery and the aluminum foil side of the solid electrolyte sheet for an all-solid state secondary battery were pressurized by applying a pressure of 350 MPa with a SUS rod. The SUS rod on the side of the solid electrolyte sheet for an all-solid state secondary battery was once removed to gently peel off the aluminum foil of the solid electrolyte sheet for an all-solid state secondary battery, and then a disk-shaped In sheet (thickness: 20 μm) and a diameter of 9 mm and a disk-shaped Li sheet (thickness 20 μm) having a diameter of 9 mm were inserted in this order onto the solid electrolyte layer of the solid electrolyte sheet for an all-solid state secondary battery in the cylinder. The removed SUS rod was reinserted into the cylinder and fixed under a pressure of 50 MPa. In this manner, all-solid state secondary batteries for evaluation (half cells) S-31 and S-32, which have a configuration of an aluminum foil (thickness: 20 μm)−positive electrode active material layer (thickness: 80 μm)−solid electrolyte layer (thickness: 45 μm)−negative electrode active material (counter electrode) layer (In/Li sheet, thickness: 30 μm), were obtained.

<Evaluation 5: Cycle Characteristic Test Under High-Speed Charging and Discharging Conditions>

The discharge capacity retention rate of each of the all-solid state secondary batteries for evaluation manufactured as described above was measured using a charging and discharging evaluation device TOSCAT-3000 (trade name, manufactured by Toyo System Corporation).

Specifically, each of the all-solid state secondary batteries for evaluation was charged in an environment of 25° C. at a current density of 0.1 mA/cm² until the battery voltage reached 3.6 V. Then, the battery was discharged at a current density of 0.1 mA/cm² until the battery voltage reached 2.5 V. One charging operation and one discharging operation were set as one cycle of charging and discharging, and 3 cycles of charging and discharging were repeated under the same conditions to carry out initialization. Then, the charging at a current density of 3.0 mA/cm² until the battery voltage reaches 3.6 V and the discharging at a current density of 3.0 mA/cm² until the battery voltage reaches 2.5 V was set as one cycle, and this high-speed charging and discharging cycle was repeatedly carried out 1,000 cycles. The discharge capacity of each all-solid state secondary battery for evaluation at the first cycle of the high-speed charging and discharging and the discharge capacity at the 1,000th cycle of the high-speed charging and discharging were measured with a charging and discharging evaluation device: TOSCAT-3000 (product name). The discharge capacity retention rate was calculated according to the following expression, and this discharge capacity retention rate was applied to the following evaluation standards to evaluate the cycle characteristics of the all-solid state secondary battery. In this test, an evaluation standard of “F” or higher is the pass level. The results are shown in Table 4.

Discharge capacity retention rate (%)=(discharge capacity at 1,000th cycle/discharge capacity at first cycle)×100

In this test, the higher the evaluation standard is, the better the battery performance (the cycle characteristics) is, and the initial battery performance can be maintained even in a case where a plurality of times of high-speed charging and discharging are repeated (even in a case of the long-term use).

All of the all-solid state secondary batteries for evaluation according to the embodiment of the present invention exhibited the discharge capacity values at the first cycle which are sufficient for functioning as an all-solid state secondary battery. Moreover, the all-solid state secondary battery for evaluation according to the embodiment of the present invention maintained excellent cycle characteristics even in a case where the general charging and discharging cycle was repeatedly carried out under the same conditions as those in the above-described initialization instead of those in the high-speed charging and discharging.

Evaluation Standards—

A: 90%≤discharge capacity retention rate

B: 85%≤discharge capacity retention rate <90%

C: 80%≤discharge capacity retention rate <85%

D: 75%≤discharge capacity retention rate <80%

E: 70%≤discharge capacity retention rate <75%

F: 60%≤discharge capacity retention rate <70%

G: Discharge capacity retention rate <60%

<Evaluation 6: Measurement of Ion Conductivity>

The ion conductivity of each of the manufactured all-solid state secondary batteries for evaluation was measured. Specifically, the alternating-current impedance of each of the all-solid state secondary batteries for evaluation was measured in a constant-temperature tank (25° C.) using a 1255B FREQUENCY RESPONSE ANALYZER (trade name, manufactured by SOLARTRON Analytical) at a voltage magnitude of 5 mV and a frequency of 1 MHz to 1 Hz. From the measurement result, the resistance of the sample for measuring ion conductivity in the layer thickness direction was determined, and the ion conductivity was determined by the calculation according to Expression (1). It indicates that the larger the ion conductivity, the lower the resistance of the all-solid state secondary battery for evaluation.

Ion conductivity σ (mS/cm)=1,000×sample layer thickness (cm)/[resistance(Ω)×sample area (cm²)] Expression (1)

In Expression (1), the sample layer thickness is a value obtained by subtracting the thickness of the collector in each all-solid state secondary battery for evaluation (the total layer thickness of the solid electrolyte layer and the electrode active material layer). The sample area is the area of the disk-shaped sheet having a diameter of 10 mm.

It was determined where the obtained ion conductivity σ was included in any one of the following evaluation standards. In this test, in a case where the evaluation standard is “F” or higher, the ion conductivity σ is the pass level. The results are shown in Table 4.

Evaluation Standards—

A: 1.5≤σ (mS/cm)

B: 1.4≤σ (mS/cm)<1.5

C: 1.3≤σ (mS/cm)<1.4

D: 1.2≤σ (mS/cm)<1.3

E: 1.1≤σ (mS/cm)<1.2

F: 1.0≤σ (mS/cm)<1.1

G: σ (mS/cm)<1.0

TABLE 4

| | | | Dispersion | Ion | Cycle | |
|---|---|---|---|---|---|---|
| No. | Constitutional layer | Handleability | stability | conductivity | characteristics | Note |
| S-1 | Positive electrode | G | G | G | G | Comparative |
| | | | | | | Example |
| S-2 | Positive electrode | F | E | G | E | Comparative |
| | | | | | | Example |
| S-3 | Positive electrode | E | G | G | G | Comparative |
| | | | | | | Example |
| S-4 | Positive electrode | E | G | E | G | Comparative |
| | | | | | | Example |
| S-5 | Positive electrode | C | C | C | C | Present invention |
| S-6 | Positive electrode | C | C | B | B | Present invention |
| S-7 | Positive electrode | B | B | A | B | Present invention |
| S-8 | Positive electrode | A | A | A | A | Present invention |
| S-9 | Positive electrode | A | B | B | B | Present invention |
| S-10 | Positive electrode | D | C | D | D | Present invention |
| S-11 | Positive electrode | E | D | D | D | Present invention |
| S-12 | Positive electrode | D | C | C | C | Present invention |
| S-13 | Positive electrode | B | A | A | A | Present invention |
| S-14 | Positive electrode | A | A | A | A | Present invention |
| S-15 | Positive electrode | B | B | B | C | Present invention |
| S-16 | Positive electrode | D | D | D | C | Present invention |
| S-17 | Positive electrode | D | C | D | C | Present invention |
| S-18 | Positive electrode | C | C | B | C | Present invention |
| S-19 | Positive electrode | E | D | D | D | Present invention |
| S-20 | Positive electrode | E | G | G | G | Comparative |
| | | | | | | Example |
| S-21 | Positive electrode | G | G | G | G | Comparative |
| | | | | | | Example |
| S-22 | Positive electrode | A | A | A | B | Present invention |
| S-23 | Positive electrode | A | A | A | A | Present invention |
| S-24 | Positive electrode | A | A | A | A | Present invention |
| S-25 | Positive electrode | A | A | A | A | Present invention |
| S-26 | Positive electrode | A | A | A | A | Present invention |
| S-27 | Positive electrode | A | A | A | A | Present invention |
| S-28 | Positive electrode | A | A | A | A | Present invention |
| S-33 | Positive electrode | A | A | A | A | Present invention |
| S-34 | Positive electrode | A | A | A | A | Present invention |
| S-35 | Positive electrode | A | A | A | A | Present invention |
| S-36 | Positive electrode | A | A | A | A | Present invention |
| S-29 | Negative electrode | B | A | A | A | Present invention |
| S-30 | Negative electrode | F | G | G | E | Comparative |
| | | | | | | Example |
| S-31 | Solid electrolyte | B | A | A | A | Present invention |
| | layer | | | | | |
| S-32 | Solid electrolyte | F | G | G | E | Comparative |
| | layer | | | | | Example |

### Example 2

In Example 2, the polymer binder B-1 consisting of the polymer B-1 synthesized in Synthesis Example 1 and lithium stearate as a metal element-containing compound were used to check the temperature condition or concentration condition, the change in the solubility of the polymer binder B-1, as well as the effect on the resistance in a case where the layer was formed.

Specifically, butyl butyrate as a dispersion medium, the polymer binder B-1, and lithium stearate were mixed to prepare a mixture in which the content of polymer binder B-1 was set to 10.0% by mass and the content of lithium stearate was set to 0.5% by mass. In the obtained mixture, the polymer binder B-1 was dissolved, and lithium stearate was dispersed (average particle diameter: 0.80 μm). As a result of measuring the solubility of the polymer binder B-1 contained in the obtained mixture, in butyl butyrate, according to the above-described method, the solubility thereof was 80% by mass.

The obtained mixture was heated and furthermore concentrated so that the concentration and the temperature shown in the column of “Treatment condition” of Table 5 were obtained, thereby obtaining treated mixtures E-1 to E-9.

The polymer binder was recovered from each of the treated mixtures E-1 to E-9 according to the following method, and the solubility in butyl butyrate, which is the dispersion medium used in the preparation of the mixture, was measured according to the above-described method. The results are shown in Table 5.

Recover Method for Polymer Binder from Treated Mixture—

The treated mixture was vacuum dried in a vacuum specimen dryer (product name: HD-15D, manufactured by ISHII LABORATORY WORKS Co., Ltd.) at room temperature for 20 hours to recover the polymer binder.

Next, each of the treated mixtures E-1 to E-9 was mixed with the inorganic solid electrolyte, butyl butyrate, the positive electrode active material, and the conductive auxiliary agent so that the composition thereof was the same as that of the composition S-8 for a positive electrode, prepared in Example 1 (the total content of the polymer binder and lithium stearate was 1.05% by mass, where the ratio therebetween is the polymer binder:lithium stearate=100:5), thereby preparing each of compositions E-1 to E-9 for a positive electrode.

Using each of the compositions E-1 to E-9 for a positive electrode, each positive electrode sheet for an all-solid state secondary battery was produced in the same manner as in Example 1, and then each battery for evaluation of a positive electrode sheet for an all-solid state secondary battery was manufactured.

Regarding the manufactured batteries E-1 to E-9 for evaluation of a positive electrode sheet for an all-solid state secondary battery, the ion conductivity σ was measured in the same manner as in <Evaluation 6: Measurement of ion conductivity> of Example 1 described above, thereby evaluating the resistance. The results are shown in Table 5.

TABLE 5

| | | | | | | | Solubility | | |
|---|---|---|---|---|---|---|---|---|---|
| | Metal-containing compound | | Polymer binder | | Treatment condition | | Before | After | |
| | | Ratio | | Ratio | Concentration | Temperature | treatment | treatment | Ion |
| No. | | (% by mass) | | (% by mass) | (% by mass) | (° C.) | (% by mass) | (% by mass) | conductivity |
| E-1 | Lithium stearate | 4.76 | B-1 | 95.24 | 10.5 | 30 | 80 | 80 | E |
| E-2 | Lithium stearate | 4.76 | B-1 | 95.24 | 10.5 | 50 | 80 | 80 | E |
| E-3 | Lithium stearate | 4.76 | B-1 | 95.24 | 10.5 | 70 | 80 | 80 | D |
| E-4 | Lithium stearate | 4.76 | B-1 | 95.24 | 10.5 | 80 | 80 | 20 | A |
| E-5 | Lithium stearate | 4.76 | B-1 | 95.24 | 10.5 | 100 | 80 | 17 | A |
| E-6 | Lithium stearate | 4.76 | B-1 | 95.24 | 21.0 | 50 | 80 | 80 | E |
| E-7 | Lithium stearate | 4.76 | B-1 | 95.24 | 31.5 | 50 | 80 | 60 | C |
| E-8 | Lithium stearate | 4.76 | B-1 | 95.24 | 52.5 | 50 | 80 | 55 | B |
| E-9 | Lithium stearate | 4.76 | B-1 | 95.24 | 73.5 | 50 | 80 | 52 | B |

The following facts can be seen from the results of Table 1 to Table 5.

In all of the inorganic solid electrolyte-containing compositions shown in Comparative Examples S-1, S-3, S-4, S-20, S-30, and S-32, which do not contain the metal element-containing compound defined in the present invention, the dispersion stability and the handleability cannot be achieved at the same time, and the dispersion characteristics are inferior. It can be seen that the all-solid state secondary batteries for evaluation using these compositions are inferior in at least one of the cycle characteristics or the ion conductivity. In addition, the inorganic solid electrolyte-containing composition shown in Comparative Example S-2, which does not contain the metal element-containing compound defined in the present invention, is inferior in ion conductivity. Further, the inorganic solid electrolyte-containing composition shown in Comparative Example S-21, which contains a particle-shaped binder that is not dissolved in the dispersion medium but does not contain a polymer binder that is dissolved in the dispersion medium, is inferior in dispersion stability and handleability even in a case of containing the metal element-containing compound defined in the present invention. In the all-solid state secondary battery for evaluation using this composition S-21, both the cycle characteristics and the ion conductivity are not sufficient.

On the other hand, all of the inorganic solid electrolyte-containing compositions according to the embodiment of the present invention shown in S-5 to S-19, S-22 to S-29, S-31, and S-33 to S-36, which contain the polymer binder and the metal element-containing compound in the dispersed state (the solubility property) defined in the present invention have both the dispersion stability and the handleability at a high level. It can be seen that by using these inorganic solid electrolyte-containing compositions in the formation of the constitutional layer of the all-solid state secondary battery, it is possible to realize high ion conductivity in the obtained all-solid state secondary battery in addition to the excellent cycle characteristics.

Regarding the reason for the above, it can be seen that, as shown in Example 2 (Table 5), in a case where the composition after the application is heated to a drying temperature of 80° C. or higher or concentrated to a concentration of 30% by mass or more in the process of forming a film of the inorganic solid electrolyte-containing composition, the polymer binder in the composition after treatment has a decreased solubility as compared with the polymer binder in the dissolved state before the treatment. It is presumed that this decrease in solubility is due to the fact that the polymer binder in the dissolved state has received a lithium metal ion from the metal element-containing compound. Further, it can be seen that the larger the decrease in solubility, the larger the ion conductivity of the battery for evaluation and the lower the resistance thereof. This is presumed to be because the polymer binder is easily solidified into a particle shape.

### EXPLANATION OF REFERENCES

1: negative electrode collector

2: negative electrode active material layer

3: solid electrolyte layer

4: positive electrode active material layer

5: positive electrode collector

6: operation portion

10: all-solid state secondary battery

What is claimed is:

1. An inorganic solid electrolyte-containing composition for an all-solid state secondary battery, comprising:
an inorganic solid electrolyte having an ion conductivity of a metal belonging to Group 1 or Group 2 in the periodic table;
a polymer binder;
a metal element-containing compound; and
a dispersion medium,
wherein the metal element-containing compound is a compound that is capable of supplying, as an ion, a metal element constituting a molecule to a polymer that forms the polymer binder, and
the polymer binder is dissolved in the dispersion medium, where the metal element-containing compound is present in a solid state.

2. The inorganic solid electrolyte-containing composition according to claim 1,
wherein the metal element-containing compound is dispersed in the dispersion medium.

3. The inorganic solid electrolyte-containing composition according to claim 1,
wherein the metal element-containing compound has an average particle diameter of 0.1 to 5 μm.

4. The inorganic solid electrolyte-containing composition according to claim 1,
wherein the metal element-containing compound is an organic metal salt.

5. The inorganic solid electrolyte-containing composition according to claim 1,
wherein the metal element-containing compound has an anion of which a conjugate acid has a negative common logarithm [pKa] of an acid dissociation constant of −2 to 20.

6. The inorganic solid electrolyte-containing composition according to claim 1,
wherein the metal element-containing compound has an anion derived from an organic compound containing 6 to 21 carbon atoms.

7. The inorganic solid electrolyte-containing composition according to claim 1,
wherein a metal element constituting the metal element-containing compound includes a metal element belonging to Group 1 or Group 2 in the periodic table.

8. The inorganic solid electrolyte-containing composition according to claim 1,
wherein a metal element constituting the metal element-containing compound includes a lithium element.

9. The inorganic solid electrolyte-containing composition according to claim 1,
wherein the polymer that forms the polymer binder has, in a main chain, at least one bond selected from a urethane bond, a urea bond, an amide bond, an imide bond, or an ester bond, or a polymerized chain of carbon-carbon double bond.

10. The inorganic solid electrolyte-containing composition according to claim 1,
wherein the polymer that forms the polymer binder contains a constitutional component having a functional group selected from the following Group (A) of functional groups,
<Group (A) of functional groups>
a hydroxy group, an amino group, a carboxy group, a sulfo group, a phosphate group, a phosphonate group, a sulfanyl group, a heterocyclic group, and a carboxylic acid anhydride group.

11. The inorganic solid electrolyte-containing composition according to claim 10,
wherein a pKa of a conjugate acid from which an anion contained in the metal element-containing compound is derived is larger than a pKa of the functional group.

12. The inorganic solid electrolyte-containing composition according to claim 10,
wherein a difference between the pKa of the conjugate acid from which the anion contained in the metal element-containing compound is derived and the pKa of the functional group [(the pKa of the conjugate acid)−(the pKa of the functional group)] is 2 or more.

13. The inorganic solid electrolyte-containing composition according to claim 1,
wherein in a case where the inorganic solid electrolyte-containing composition is heated to 80° C. or higher, a solubility of the polymer binder in the dispersion medium after heating is lower than a solubility of the polymer binder in the dispersion medium before heating.

14. The inorganic solid electrolyte-containing composition according to claim 1,
wherein in a case where the inorganic solid electrolyte-containing composition is concentrated so that a total concentration of the polymer binder and the metal element-containing compound in the inorganic solid electrolyte-containing composition is 30% by mass or more, a solubility of the polymer binder in the dispersion medium after concentration is lower than a solubility of the polymer binder in the dispersion medium before concentration.

15. The inorganic solid electrolyte-containing composition according to claim 1,
wherein in a case where a film of the inorganic solid electrolyte-containing composition is formed to form a layer, a solubility of the polymer binder present in the layer in the dispersion medium contained in the inorganic solid electrolyte-containing composition, is lower than a solubility of the polymer binder contained in the inorganic solid electrolyte-containing composition in the dispersion medium.

16. The inorganic solid electrolyte-containing composition according to claim 1, further comprising an active material.

17. The inorganic solid electrolyte-containing composition according to claim 1, further comprising a conductive auxiliary agent.

18. The inorganic solid electrolyte-containing composition according to claim 1,
wherein the inorganic solid electrolyte is a sulfide-based inorganic solid electrolyte.

19. The inorganic solid electrolyte-containing composition according to claim 1,
wherein a viscosity at a temperature of 23° C. and a shear rate of 10/s is 300 to 4,000 cP.

20. A sheet for an all-solid state secondary battery, comprising a layer composed of the inorganic solid electrolyte-containing composition according to claim 1.

21. The sheet for an all-solid state secondary battery according to claim 20,
wherein the polymer binder is present in the layer as particles having an average particle diameter of 10 to 800 nm.

22. The sheet for an all-solid state secondary battery according to claim 20,
wherein a solubility of the polymer binder present in the layer in the dispersion medium contained in the inorganic solid electrolyte-containing composition, is lower than a solubility of the polymer binder contained in the inorganic solid electrolyte-containing composition in the dispersion medium.

23. An all-solid state secondary battery comprising, in the following order:
a positive electrode active material layer;
a solid electrolyte layer; and
a negative electrode active material layer,
wherein at least one layer of the positive electrode active material layer, the solid electrolyte layer, or the negative electrode active material layer is composed of the sheet for an all-solid state secondary battery according to claim 20.

24. A manufacturing method for a sheet for an all-solid state secondary battery, the manufacturing method comprising forming a film of the inorganic solid electrolyte-containing composition according to claim 1.

25. The manufacturing method for a sheet for an all-solid state secondary battery according to claim 24,
wherein the film is formed while the polymer binder contained in the inorganic solid electrolyte-containing composition is solidified into a particle shape.

26. The manufacturing method for a sheet for an all-solid state secondary battery according to claim 24,
wherein the film of the inorganic solid electrolyte-containing composition is formed while a solubility of the polymer binder contained in the inorganic solid electrolyte-containing composition in a dispersion medium, is reduced.

27. The manufacturing method for a sheet for an all-solid state secondary battery according to claim 24,
wherein the inorganic solid electrolyte-containing composition is heated to 80° C. or higher to form the film.

28. A manufacturing method for an all-solid state secondary battery, the manufacturing method comprising manufacturing an all-solid state secondary battery through the manufacturing method according to claim 24.
